(19) United States
(12) Patent Application Publication
(10) Pub. No.: US 2009/0081501 A1
(43) Pub. Date: Mar. 26, 2009

(54) ON-DEMAND HYDROGEN GAS GENERATION DEVICE

(75) Inventors: Viet Vu, Joplin, MO (US); Zhihong Jin, Peewaukee, WI (US); Juergen Scherer, Karlsdorf (DE); Joseph L. Passaniti, Madison, WI (US); Gregory J. Davidson, Oregon, WI (US); Craig Rom, Cross Plains, WI (US); Mario DeStephen, Madison, WI (US); Jon Luecke, Denver, CO (US); Erik Mortensen, Waunakee, WI (US); Jamie L. Ostroha, Edgerton, WI (US); Karthik Ramaswami, Middleton, WI (US); Tony Rubsam, Madison, WI (US); William C. Bushong, Madison, WI (US)

Correspondence Address: Christopher M. Goff (27860);ARMSTRONG TEASDALE LLP, ONE METROPOLITAN SQUARE, SUITE 2600, ST. LOUIS, MO, 63102, US

(73) Assignee: ROVCAL, INC., Madison, WI (US)

(21) Appl. No.: 12/177,285

(22) Filed: Jul. 22, 2008

Related U.S. Application Data
(60) Provisional application No. 60/951,627, filed on Jul. 24, 2007.

(51) Int. Cl. H01M 8/18; H01M 8/04

(52) U.S. Cl. 429/21

(57) ABSTRACT

The present disclosure generally relates to an on-demand hydrogen gas generation device, suitable for use in a fuel cell, which utilizes water electrolysis, and more particularly galvanic cell corrosion, and/or a chemical hydride reaction, to produce hydrogen gas. The present disclosure additionally relates to such a device that comprises a switching mechanism that has an electrical current passing therethrough and that repeatedly and reversibly moves between a first position and a second position when exposed to pressure differential resulting from hydrogen gas generation, in order to (1) alter the rate at which hydrogen gas is generated, such that hydrogen gas is generated on an as-needed basis for a fuel cell connected thereto, and/or (2) ensure a substantially constant flow of hydrogen gas is released therefrom. The present disclosure additionally or alternatively relates to such an on-demand hydrogen gas generation device that comprises a gas management system designed to maximize the release or evolution of hydrogen gas, and in particular dry hydrogen gas, therefrom once it has been formed, thus maximizing hydrogen gas output. The present disclosure is still further directed to a fuel cell comprising such an on-demand hydrogen gas generation device, and in particular a fuel cell designed for small-scale applications.

### CROSS REFERENCE TO RELATED APPLICATIONS

This application claims priority from U.S. Provisional Patent Application 60/951,627 filed on Jul. 24, 2007, the entire contents of which is incorporated herein by reference.

### FIELD OF THE DISCLOSURE

The present disclosure generally relates to an on-demand hydrogen gas generation device, suitable for use with a fuel cell, which utilizes electrolysis, and more particularly galvanic corrosion of one or more metals or metal alloys, and/or a chemical hydride reaction, to produce hydrogen gas. The present disclosure additionally relates to such a device that comprises a switching mechanism that has an electrical current passing therethrough, and that rapidly and repeatedly (or reversibly) moves between a first position and a second position when exposed to a pressure differential resulting from hydrogen gas generation, in order to alter the rate at which hydrogen gas is generated, such that hydrogen gas is generated on an as-needed basis for a fuel cell in communication therewith. The present disclosure additionally or alternatively relates to such an on-demand hydrogen gas generation device that comprises a gas management system designed to maximize or optimize the generation or release of hydrogen gas, and in particular to minimize the loss of electrolyte from the gas generation device and thereby release substantially dry hydrogen gas, therefrom once it has been formed, thus maximizing hydrogen gas output. The present disclosure is still further directed to a fuel cell comprising such an on-demand hydrogen gas generation device, and in particular a fuel cell designed for small-scale applications.

### BACKGROUND OF THE INVENTION

Attempts to generate and utilize hydrogen gas as an energy source have been extensively pursued for a number of years, at least in part because hydrogen gas is considered by many to be the fuel of the future due to its potentially abundant supply, and the often non-polluting by-products (e.g., water) resulting from its consumption in a fuel cell. Fuel cells utilizing hydrogen as fuel also operate at significantly higher efficiencies than fuel cells utilizing other fossil fuels such as methanol. Hydrogen is therefore considered by many to be the ideal fuel. The generation and storage of hydrogen however, has significant challenges, in that it must be economically viable and safe to store and transport, in order to make it a useful alternative to traditional fuels. The desire to utilize hydrogen as an energy source extends not only to large-scale applications (e.g., automobiles, homes, commercial buildings, etc.), but also to smaller-scale applications, such as consumer electronics (e.g., cell phones, personal digital assistants, laptop computers, etc.). Although both uses have challenges associated with them, small-scale applications (e.g., applications requiring 30 watts of power or less) are unique, due particularly to (1) size restrictions (i.e., limitations on the maximum weight and/or dimensions of the device), (2) weight limitations for portable applications, and (3) safety, particularly for hand-held portable devices. These size and weight restrictions increase the need to maximize both energy output of the fuel cell and the fuel supply in order to avoid having the user replace the hydrogen source too often. Pressure limitations are also relevant to size restrictions, given that fuel cell anodes are generally porous electrodes in intimate contact with relatively thin polymeric membranes and the pressure of the hydrogen in the fuel cell has to be relatively low (e.g., less than 30 psig) in order to avoid rupture of the thin polymeric membranes. If the hydrogen source is operating at a pressure too great for the fuel cell where the hydrogen is consumed, a pressure regulator(s) may be needed to reduce the hydrogen gas pressure before it enters the fuel cell. Additionally, thicker/bulkier components such as a portable pressure tank, and high pressure plumbing leading to the fuel cell, may be required to contain hydrogen that is much above atmospheric pressure. These components take up space that could otherwise be used for the fuel cell, and more particularly the hydrogen fuel itself. Furthermore, stored high pressure hydrogen is potentially unsafe (particularly for air transportation), while a hydrogen generator that only produces hydrogen when the fuel cell is in operation minimizes the amount of stored hydrogen, making it intrinsically safer.

The size and weight restrictions for portable applications tend to limit the design options to “passive” systems (both fuel cell and fuel generator), which are systems that do not require pumps, flow meters, pressure regulators, etc. that are generally acceptable in stationary applications. In addition, small-scale, portable consumer applications are unique in that the demand for energy is typically not continuous; that is, such applications may experience long periods of “down time” where they are shut off or are in “sleep mode” (i.e., on but not actively being used), and therefore are not consuming much hydrogen. A hydrogen generator capable of producing hydrogen on demand is ideally suited for these applications such that it only depletes the fuel supply when the fuel cell is in use. It is therefore recognized that a fuel cell hydrogen source viable for small-scale portable applications ideally is small and portable, and desirably has a passive mode of operation supplying low pressure (i.e., less than 30 psig) hydrogen “on-demand” (where at any given time the amount of stored hydrogen is minimized).

Hydrogen gas may be supplied to the fuel cell in a number of ways. For example, the fuel cell may be designed to simply possess a holding vessel or tank, which may be directly charged or pressurized with hydrogen (in liquid or gas form) from an external source. Such an approach may not be preferred in some applications or uses, however, because it requires a large and heavy or bulky external hydrogen source to be available for recharging the fuel cell. Additionally, the carrying around or transport of a device which includes a container of pressurized hydrogen gas creates undesirable safety concerns.

Another alternative may be a fuel cell that is fed by a hydrogen gas generator that uses methanol as the hydrogen gas source. More specifically, the generator may possess a small vessel or tank of methanol that is catalytically reformed as needed to produce hydrogen gas. However, such an approach may also not be preferred in some applications or uses for a number of reasons, including the fact that it requires the user to carry or transport a device that includes a container of a flammable liquid.

In view of the various safety and/or convenience concerns surrounding the use of fuel cells in small-scale applications, hydrogen production by (1) the direct electrolysis of water using electrical energy, (2) the electrolysis of water, or more generally an aqueous solution, in a galvanic corrosion cell, and/or (3) the reaction of water, or more generally an aqueous solution, with a solid hydrogen source, such as a hydride salt, may be desirable alternatives (provide one or more of these can be achieved in a compact, safe system). The direct electrolysis of water using electrical energy generally requires expensive catalysts as well as a source of electrical energy. For a truly portable system that is disconnected from the electrical grid, electrolysis of water may also be achieved by utilizing the spontaneous galvanic corrosion reaction of a reactive metal in combination with a hydrogen generator catalyst where the water is reduced to hydrogen. In one particular arrangement, an anode, made of, for example, a metal such as zinc, and a positive electrode, made of for example a non-consumable metal such as iron, are immersed in some aqueous electrolytic solution and connected by an external circuit of some kind. As further illustrated by the equations presented below, when the circuit is closed, the anode material is oxidized and electrons flow through the circuit to the positive electrode, which acts as the hydrogen generator catalyst and therefore is not consumed, where water is reduced to produce hydrogen gas and hydroxide ions:

(anode reaction) M→M⁺²+2e⁻

(positive electrode reaction) 2H₂O+2e⁻→2OH⁻+H₂ (gas)

(overall reaction) M+nH₂O→M[OH]ₙ+n/₂H₂ (gas).

Similarly, the generation of hydrogen by means of a chemical reaction with a solid hydrogen source may also be achieved using a number of different techniques and reagents. For example, in one approach, water or an aqueous solution can be reacted with sodium borohydride resulting in the production of hydrogen gas and sodium borate in accordance with the following reaction:

NaBH₄+2H₂O→NaBO₂+4H₂ (gas).

Such an approach may, under certain circumstances, be desirable over water electrolysis due, for example, to the increased yield or output of hydrogen gas and the increased volumetric and gravimetric energy density that may be achieved.

In addition to the above-noted challenges, it is desirable for fuel cells, and particularly small-scale fuel cell applications, to maximize their “energy density,” or their energy output per unit of volume of the fuel cell. A number of factors are to be considered in this context, including for example: (1) selection of the means by which the hydrogen gas is to be generated in order to maximize hydrogen generation; (2) once generated, maximizing hydrogen gas evolution or output from the source thereof and to the fuel cell itself, and/or (3) limiting the number of fuel cell and hydrogen gas generator components, in order to maximize energy density (that is, it is desirable for the fuel cell and hydrogen gas generator to occupy as little space as possible, in order to maximize space for the fuel from which the hydrogen is to be generated). Accordingly, as previously indicated, it is desirable for the hydrogen gas generator to be passive; that is, it is desirable for the hydrogen gas generator to generate and transport hydrogen gas to the fuel cell without the need of commonly used pressure regulators, pumps, fans, etc. In addition, desirably the hydrogen gas generator is an “on-demand” generator; that is, it generates hydrogen gas on an as-needed basis, thus eliminating unnecessary consumption of the fuel from which the hydrogen gas is generated (and thus more frequent re-fuelings), and/or the need for a tank to hold the hydrogen gas for later consumption. Furthermore, in addition to proper selection of the means by which hydrogen gas is generated (i.e., selection of a source which provides maximum hydrogen generation per unit volume), a challenge exists to efficiently maximize the transport or evolution of the hydrogen gas, once generated, out of the generator and into the fuel cell for consumption, in order to maximize energy output. Generation of hydrogen gas from a liquid or solid/liquid system would normally result in entrainment and “carry-over” of some liquid with the gas, depending on the rate of gas generation. In most cases, the liquid is a corrosive acidic or alkaline fluid. Since the hydrogen generator device is in communication with the fuel cell and the plumbing leading up to the fuel cell, this carry-over of corrosive liquid is highly undesirable. Additionally, any loss of liquid from the generator device results in less available liquid for hydrogen generation, which is also highly undesirable. Finally, in small-scale, and/or low-pressure fuel cell devices, steps are desirably taken to ensure the hydrogen gas that is generated and transported out of the hydrogen gas generator has relatively low moisture content. This is because the fuel cell anode reaction itself generates water that must be ejected passively out of the fuel cell through the membrane and ultimately out through the porous cathode. Any additional incoming moisture with the fuel (e.g. hydrogen gas) only increases the burden on the system, which can become a significant problem with small systems used in portable consumer devices.

### SUMMARY OF THE DISCLOSURE

Briefly, therefore, the present disclosure is directed to an on-demand hydrogen gas generation device that comprises: (a) a cell comprising a means for generating an average flow of hydrogen gas of at least about 0.1 cubic centimeter/minute/cubic centimeter of fuel volume for a period of time of at least about 1 hour; and, (b) a switching mechanism in communication with the cell comprising the hydrogen gas generation means, the switching mechanism regulating the generation of hydrogen gas therein, the switching mechanism comprising a moveable member that is operable to repeatedly and reversibly move between a first position and a second position in response to a pressure differential created by said cell of less than 30 psig, wherein (1) in the first position an electrical current passes through the switching mechanism which enables the generation of hydrogen gas from said cell, and (2) in the second position resistance in the switching mechanism to the electrical current passing therethrough increases to reduce the rate of hydrogen gas generation from said cell.

The present disclosure is further directed to such an on-demand hydrogen gas generation device, wherein said means for hydrogen gas generation comprises galvanic cell corrosion, or is achieved thereby.

The present disclosure is additionally or alternatively directed to such an on-demand hydrogen gas generation device, wherein said means for hydrogen gas generation comprises, or additionally comprises, a chemical hydride reaction, or is achieved thereby. In particular, the present disclosure is directed to such an on-demand hydrogen gas generation device that utilizes both galvanic cell corrosion and a chemical hydride reaction to generate hydrogen, wherein hydrogen generated by galvanic cell corrosion exerts pneumatic pressure on an aqueous solution (e.g., acidic aqueous solution) to force the solution into contact with a chemical hydride reagent, the resulting reaction between the aqueous solution and the chemical hydride resulting in the formation of hydrogen gas.

The present disclosure is still further directed to an on-demand hydrogen gas generation device comprising: (a) a first chamber comprising a gas-generating electrochemical cell in communication with a switching mechanism for regulating the generation of gas within the gas-generating electrochemical cell, the switching mechanism being operable in a range of from about 1 to about 30 psig; (b) a second chamber containing an aqueous solution; (c) a third chamber containing a chemical hydride; and (d) a conduit for allowing the aqueous solution contained in the second chamber to flow into the third chamber.

The present disclosure is still further directed to an on-demand hydrogen gas generation device comprising: (a) a gas-generating cell comprising a galvanic cell that contains a zinc chloride electrolyte in communication with a switching mechanism for regulating the generation of gas from the gas-generating cell, the switching mechanism being operable in a range of from about 1 to about 30 psig; (b) a first chamber containing an aqueous solution having a pH of less than about 7; (c) a second chamber containing a complex borohydride; and (d) a conduit for allowing the aqueous solution contained in the first chamber to flow into the second chamber.

The present disclosure is still further directed to a method of producing a stream of hydrogen gas from a chemical hydride (e.g., a complex chemical hydride). The method comprises: (a) activating a gas-generating electrochemical cell to produce a stream of gas sufficient to force an aqueous solution through a conduit connecting a first chamber and a second chamber, the first chamber including the gas-generating electrochemical cell and the aqueous solution; (b) forcing the aqueous solution through the conduit and into the second chamber, the second chamber including a chemical hydride; and, (c) reacting the aqueous solution and the chemical hydride to form a stream of hydrogen.

The present disclosure is still further directed to an on-demand hydrogen gas generation device comprising: (a) a switching mechanism for regulating the generation of hydrogen gas within the on-demand hydrogen gas generation device, the switching mechanism being operable in a range of from about 1 to about 30 psig; and (b) a gas management system for transporting hydrogen gas out of the on-demand hydrogen gas generation device, the gas management system comprising an anode, an electrolyte, a gas management electrode comprising a conductive substrate and a catalyst and having a first face and a second face, a gas impermeable and liquid permeable hydrophilic layer, a gas permeable and liquid impermeable hydrophobic layer and a gas exit region, wherein the anode surrounds the gas impermeable and liquid permeable hydrophilic layer, and further wherein the gas impermeable and liquid permeable hydrophilic layer is disposed between the anode and the first face of the gas management electrode, the gas permeable and liquid impermeable hydrophobic layer is disposed on the second face of the gas management electrode and the gas exit region is interior of the gas permeable and liquid impermeable hydrophobic layer.

The present disclosure is still further directed to an on-demand hydrogen gas generation device comprising: (a) a switching mechanism for regulating the generation of hydrogen gas within the on-demand hydrogen gas generation device, the switching mechanism being operable in a range of from about 1 to about 30 psig; and (b) a circular gas management system for transporting hydrogen gas out of the on-demand hydrogen gas generation device, the gas management system comprising an anode, an electrolyte, a gas management electrode comprising a conductive substrate and a catalyst and having a first face and a second face, a gas impermeable and liquid permeable hydrophilic layer, a gas permeable and liquid impermeable hydrophobic layer, wherein the gas impermeable and liquid permeable layer surrounds the anode, the gas management electrode surrounds the gas impermeable and liquid permeable hydrophobic layer, and wherein the gas permeable and liquid impermeable layer surrounds the gas management electrode.

The present disclosure is still further directed to an on-demand hydrogen gas generation device comprising: (a) a switching mechanism for regulating the generation of hydrogen gas within the on-demand hydrogen gas generation device, the switching mechanism being operable in a range of from about 1 to about 30 psig; and (b) a gas management system for transporting hydrogen gas out of the on-demand hydrogen gas generation device, the gas management system comprising an anode, an electrolyte, a gas management electrode comprising a conductive substrate and a catalyst and having a first face and a second face, wherein the first face comprises a gas impermeable and liquid permeable hydrophilic layer and the second face comprises a gas permeable and liquid impermeable hydrophobic layer, and a gas exit region, wherein the first face is adjacent the anode and wherein the gas exit region is positioned interior of the gas permeable and liquid impermeable layer.

The present disclosure is still further directed to an on-demand hydrogen gas generation device comprising: (a) a cell comprising a means for generating an average flow of hydrogen gas of at least about 0.1 cubic centimeter/minute/cubic centimeter of fuel volume for a period of time of at least about 1 hour; (b) a switching mechanism in communication with the cell comprising the hydrogen gas generation means for regulating the generation of hydrogen gas therein, the switching mechanism comprising a moveable member that is operable to repeatedly move between a first position and a second position in response to a pressure differential created by said cell of less than 30 psig, wherein (1) in the first position an electrical current passes through the switching mechanism which enables the generation of hydrogen gas from said cell, and (2) in the second position resistance in the switching mechanism to the electrical current passing therethrough increases to reduce the rate of hydrogen gas generation from said cell; and, (c) a gas management system for transporting hydrogen gas out of the cell comprising the means for generating hydrogen gas. In particular, the gas management system comprises an anode, an electrolyte, a gas management electrode comprising a conductive substrate and a catalyst and having a first face and a second face, a gas impermeable and liquid permeable hydrophilic layer, a gas permeable and liquid impermeable hydrophobic layer and a gas exit region, wherein (1) the anode and the gas management electrode are in serial, electrical communication with and through the switching mechanism, (2) the anode surrounds the gas impermeable and liquid permeable hydrophilic layer, and (3) the gas impermeable and liquid permeable hydrophilic layer is disposed between the anode and the first face of the gas management electrode, the gas permeable and liquid impermeable hydrophobic layer is disposed on the second face of the gas management electrode and the gas exit region is interior of the gas permeable and liquid impermeable hydrophobic layer.

### BRIEF DESCRIPTION OF THE DRAWINGS

FIG. 1A is a cross-sectional, schematic view of one embodiment of the on-demand hydrogen gas generation device of the present disclosure, generally illustrating a switching mechanism therein.

FIG. 1B is an expanded, cross-sectional view of the hydrogen gas generation means from FIG. 1A.

FIG. 1C is an expanded, cross-sectional view of the positive electrode assembly (also referred to herein as a “gas management electrode”) generally illustrated in FIG. 1B.

FIG. 2A is a more detailed, cross-sectional, schematic view of the switching mechanism generally illustrated in FIG. 1A, wherein said switch is in the closed position.

FIG. 2B is a more detailed, cross-sectional, schematic view of the switching mechanism generally illustrated in FIG. 1A, wherein said switch is substantially open (as compared to FIG. 2A).

FIG. 3A is a cross-sectional, schematic view of an alternative embodiment of the switching mechanism of the present disclosure, wherein said switch is in the closed position.

FIG. 3B is a cross-sectional, schematic view of an alternative embodiment of the switching mechanism of the present disclosure, wherein said switch is in the substantially open position (as compared to FIG. 3A).

FIG. 4 is a cross-sectional, schematic view of an alternative embodiment of the on-demand hydrogen gas generation device of the present disclosure, and in particular as illustrated in FIG. 1A, wherein the alternative switching embodiment illustrated in FIGS. 3A and 3B is incorporated therein (the switching mechanism of 3A and 3B being inserted into the negative end of the can of 1A, replacing the switching mechanism and end cap illustrated therein).

FIG. 5A is a schematic view of another alternative embodiment of the on-demand hydrogen gas generation device of the present disclosure, the device having dimensions similar to a conventional prismatic electrochemical cell.

FIG. 5B is a cross-sectional, schematic view of the prismatic, on-demand hydrogen gas generation device of FIG. 5A, the cross-sectional view being along line X therein.

FIG. 5C is an expanded, cross-sectional view of the prismatic, on-demand hydrogen gas generation device of FIG. 5B.

FIG. 6 is a cross-sectional, schematic view of an alternative embodiment of the switching mechanism of the present disclosure.

FIGS. 7 and 8 are cross-sectional, schematic illustrations of on-demand hydrogen gas generators utilizing chemical hydrides.

FIG. 9 is an exploded, cross-sectional schematic view of a gas management system of the present disclosure.

FIGS. 10, 11 and 12 are cross-sectional, schematic illustrations of alternative embodiments of the gas management system of the present disclosure.

FIG. 13 is a graph which illustrates the results of measurements taken comparing the voltage versus the current response for the unplated nickel foam with the averaged results of 10 nickel plated, nickel foam samples.

FIG. 14A is a cross-sectional, schematic view of an alternative embodiment of the on-demand hydrogen gas generation device of the present disclosure having a pouch cell or prismatic cell design.

FIG. 14B is an expanded, cross-sectional view of a portion of the embodiment illustrated in FIG. 14A.

FIG. 15 is a graph which illustrates the hydrogen performance of the hydrogen generation devices prepared and detailed in Example 2.

FIG. 16 is a graph which illustrates the comparison of the theoretical (calculated) hydrogen gas generation rate versus the measured hydrogen gas generation rate of a device detailed in Example 2.

It is to be noted that corresponding reference characters indicate corresponding parts throughout the several views of the drawings.

It is to be further noted that the design or configuration of the components presented in these figures are not scale, and/or are intended for purposes of illustration only. Accordingly, the design or configuration of the components may be other than herein described without departing from the intended scope of the present disclosure. These figures should therefore not be viewed in a limiting sense.

### DETAILED DESCRIPTION OF THE DISCLOSURE

In accordance with the present disclosure, an on-demand hydrogen gas generation device, particularly well-suited for use in small-scale fuel cell applications, has been developed. As further detailed herein below, the on-demand hydrogen gas generation device advantageously utilizes water electrolysis and, more particularly, galvanic cell corrosion, a chemical hydride reaction, or both, to produce the hydrogen gas for fuel cell consumption. As a result, many of the safety concerns associated with the use of flammable fuels for the generator (e.g., methanol), or the need to carry or transport a tank of hydrogen gas, are eliminated.

Also as further detailed herein below, the on-demand hydrogen gas generation device desirably generates and releases a flow of hydrogen gas on a substantially as-needed basis by the fuel cell, and desirably at a substantially constant pressure. These features are achieved by means of a switching mechanism that repeatedly or reversibly moves between a first position and a second position in response to particular low pressure conditions, and more specifically in response to a pressure differential of less than 30 psig (pounds per square inch gauge), in order to (1) alter or regulate the hydrogen gas generation reaction, such that hydrogen gas is generated on a substantially as-needed basis for the fuel cell connected thereto, and/or (2) ensure that a substantially constant flow of hydrogen gas is generated and released from the hydrogen gas generation device.

As still further detailed herein below, the present disclosure additionally relates to such an on-demand hydrogen gas generation device that comprises a gas management system that is designed to maximize the release or evolution of hydrogen gas, and in particular dry hydrogen gas, from the device once it has been formed, thus maximizing hydrogen gas output therefrom.

In one or more of the above-noted embodiments, the on-demand hydrogen gas generation device is orientation independent. Additionally, or alternatively, in one or more of the above-noted embodiments, the on-demand hydrogen gas generator device is passive.

In this regard it is to be noted that, as used herein, the following terms or phrases, or variations thereof, generally have the following meanings: “small-scale” fuel cell applications generally refers to fuel cells that produce, or have an output of, less than about 30 watts of power; “on-demand” or “substantially as-needed basis” generally refers to a hydrogen gas generation device that produces or generates hydrogen gas when needed by the fuel cell of which it is a part (or to which it is in communication with), such as for example when the device receiving power from the fuel cell is turned on or in the active mode, and therefore does not simply produce or generate hydrogen once activated until all of the hydrogen-generating fuel is consumed, thus optionally eliminating or limiting the need for (i) a tank to hold the hydrogen that is generated (for later consumption or use), and/or (ii) the need for the ability to safely vent hydrogen gas when the device is not in use; a switching mechanism operable under “low pressure conditions” generally refers to a switch that moves when exposed to a pressure differential of less than 30 pounds per square inch gauge (psig); “substantially constant flow” of hydrogen gas generally refers to a hydrogen gas generator that, when active (i.e., when the reaction that generates the hydrogen gas is occurring), is capable of releasing a flow of hydrogen gas at a particular target pressure (e.g., about 5 psi, about 10, psi, about 15 psi, about 20 psi, or even about 25 psi) that varies over a period of time (e.g., at least about 1 hour) by less than about 25% (e.g., less than about 10%, less than about 8%, less than about 6%, less than about 4%, or even less than about 2%), until substantially all of the fuel from which the hydrogen gas is generated is consumed or gone; “orientation independent” means that the on-demand hydrogen gas generation device does not have to be maintained in a particular position or orientation (e.g., in an upright position) in order to be operational (that is, the device is operational regardless of its orientation); “passive” means the on-demand hydrogen gas generation device generates and transports hydrogen gas to the fuel cell without the need of commonly used pressure regulators, pumps, fans, etc.; and, “high energy density” generally refers to an on-demand hydrogen gas generation device that is capable of generating an average flow of hydrogen gas of at least about 0.1 cubic centimeter/minute/cubic centimeter of fuel volume for a defined period of time (e.g., at least about 1 hour).

Additionally, a switch mechanism that moves “rapidly” generally refers to a switch movement from the first position to the second position, and conversely from the second position to the first position, that occurs in a time period that is at least fast enough to enable control of the hydrogen pressure within the variation percentage described above. This time period may be optimized for the specific hydrogen generation application. For example, for low fuel flow applications, this time period may be minutes, but for most applications it would be less than 1 minute (e.g., less than about 1 minute, less than about 30 seconds, less than about 1 second, less than about 100 milliseconds, or even less than about 10 milliseconds).

### I. Hydrogen Gas Generation/Hydrogen Gas Generation Device

The present disclosure is generally directed to an on-demand hydrogen gas generation device that, in particular, comprises a cell containing or comprising a means for generating a flow of hydrogen gas of at an average rate of at least about 0.1 cubic centimeter/minute/fuel volume of the cell, and in various embodiments may generate a flow of hydrogen gas at an average rate of at least about 0.2, at least about 0.4, at least about 0.6, at least about 0.8, at least about 1 cubic centimeters/minute/fuel volume of the cell, or more, for a defined period of time (e.g., at least about 30 minutes, at least about 60 minutes, at least about 90 minutes, at least about 120 minutes, or more). As further detailed herein below, hydrogen generation may advantageously utilize electrolysis, and more particularly galvanic cell corrosion, a chemical hydride reaction, or both, to produce the hydrogen gas. In one particular embodiment, the means for generating hydrogen is coupled to or in communication with a pressure responsive switching mechanism to regulate the generation or formation of hydrogen gas therein.

In this regard it is to be noted that, as used herein, “fuel volume” in the phrase “cubic centimeter/minute/fuel volume” refers to the total volume of fuel used to generate hydrogen gas for consumption by a fuel cell. For example, when hydrogen gas is produced by galvanic cell corrosion, this phrase generally refers to the anode fuel (i.e., the total of the volume of the anode of the device, including active material, plus the total volume of the electrolyte, plus the total volume of any other additive in the anode) in the anode compartment (e.g., the space defined by a separator when present) at the time of assembling the anode. In contrast, when a chemical hydride is used to produce the hydrogen gas, this phrase generally refers to the combined volume of the aqueous solution and the chemical hydride reagents, prior to the initiation of the hydrogen gas-generating reaction.

With respect to suitable designs of the hydrogen gas generation means, or more generally suitable designs for the cell comprising the hydrogen gas generation means, it is to be noted that, in general (and as further detailed elsewhere herein), the design is desirably one that maximizes or optimizes the rate of hydrogen gas evolution, at least in part because the accumulation of hydrogen gas in the pores of the positive electrode material may result in substantial polarization. Additionally, when a galvanic cell corrosion reaction is employed for hydrogen gas generation, it is desirable for the cell to be designed in a way that accounts for the reduction in electrolyte volume during operation (the electrolyte being consumed in the reaction). Furthermore, when a galvanic cell corrosion reaction is employed, it is to be noted that at high rates of hydrogen gas evolution a portion of the electrolyte may be carried away by the hydrogen gas stream. It is therefore desirable to design the cell in a way that minimizes this loss of electrolyte, such as for example by including a membrane in the cell that is permeable to hydrogen but impermeable to water and/or the electrolyte (as further detailed elsewhere herein). Ideally, it is desirable to design a gas management system wherein there is increasing hydrophobicity in the direction away from the reaction zone and toward the gas exit from the electrode system.

In one particular embodiment, the on-demand hydrogen gas generation device comprises a hydrogen gas generation means that is in the form of a known alkaline cell “bobbin” design, wherein the cell is generally cylindrical in shape and a cylindrical surface separates the anode from the positive electrode therein. However, because it is desirable to minimize positive electrode volume and maximize anode volume, in order to maximize “fuel volume” (as further detailed elsewhere herein), the positive electrode used in accordance with the present disclosure in such a cell design is generally much thinner than the positive electrode used in a conventional alkaline cell design (or more generally a cell utilizing galvanic cell corrosion), while the anode may be much thicker. A thicker anode is not necessarily desirable, however, because this may compromise discharge efficiency. Accordingly, as further detailed elsewhere herein, in order to have a cell that possess a high discharge rate, as well as a highly efficient discharge, a design that maximizes the interfacial surface area between the anode and the cathode is desirable. Since the anode gel is highly flexible or pliable, and since the positive electrode is also a flexible material (due, for example, to the use of high surface area fiber, particles, cloth, etc. therein), cell designs that possess high discharge rate and efficiency include, for example, those wherein the anode and positive electrode are placed in a separator bag, and then (i) wound (into a “jelly-roll” like shape), (ii) folded into a “Z”-like shape, or (iii) folded into a “S”-like shape, and then inserted into a cell cavity. Additionally, electrolyte may be added to the cavity after insertion of this separator bag. Other approaches to maximize hydrogen generation rates and fuel consumption efficiency include thin prismatic cell designs (see, e.g., the prismatic cell designs illustrated and described in the working examples).

A. Switching Mechanism

In accordance with one or more of the various embodiments of the present disclosure, a pressure-responsive switching mechanism is employed in combination with a means for generating hydrogen gas in order to regulate hydrogen gas production (i.e., to provide hydrogen gas “on-demand”). More particularly, the switch mechanism is in electrical and physical communication with the hydrogen gas generation means; that is, the switching mechanism is in electrical series within a galvanic cell circuit, from which the hydrogen gas is generated. The switching mechanism is desirably activated (i.e., in a closed position) at the time of hydrogen gas generation device manufacture, and is in a serial electrical relationship with an external circuit (e.g., as described further elsewhere herein). At the time of assembly, the external circuit is in an “open” position and is desirably activated (or closed) at the time of use, as described elsewhere, thereby allowing the galvanic corrosion reaction to commence and current to flow in the external circuit through the switching mechanism. When the external circuit is activated, the switching mechanism repeatedly and reversibly moves from a first (e.g., closed, or substantially closed) position to a second (e.g., partially or fully open position) in response to a pressure differential that is created as a result of one side of the switching mechanism being exposed to atmospheric pressure (this side, for example, being sealed or vented to the atmosphere), while the other side is exposed to a pressure in excess of atmospheric pressure resulting from hydrogen gas generation. Once this pressure differential exceeds some predetermined threshold, the switching mechanism moves (e.g., downstream, away from the hydrogen gas source) in response thereto from a first position to a second position. This movement results in an increase in the resistance within the switching mechanism to the electrical current passing therethrough, the same electrical current that controls the hydrogen gas generation reaction rate. As a result, the rate of hydrogen gas generation decreases as the resistance of the switching mechanism to the electrical current increases. Once the resistance is sufficiently high (e.g., the switching mechanism becomes fully opened), the flow of electrical current, and thus hydrogen gas generation, will stop. However, as the pressure differential decreases (as a result of, for example, dissipation of hydrogen gas by venting to a fuel cell where it is consumed), the switching mechanism will move to or toward (e.g., upstream, toward the hydrogen gas source) its original position (i.e., from the second position to or toward the first position). Resistance will therefore decrease and the flow of electrical current, and thus hydrogen gas generation, will increase or begin once again.

The switching mechanism, in one or more embodiments (as further detailed elsewhere herein), is constructed of or comprises one or more components (e.g., a moveable (e.g., flexible) member and one or more electrically conductive members, which may be stand-alone or individual parts of the switching mechanism or may be integrated with or part of the moveable member) that, in combination, form electrical contact points for the flow of an electrical current therethrough. Additionally, the switching mechanism may optionally comprise one or more springs that contact the moveable member, to add further elastic strength to the switching mechanism (e.g., to ensure the switching mechanism responds to the desired pressure differential). When present, the springs may be comprised or made of essentially the same types of materials as the moveable member (the spring and moveable member in one or more embodiments having essentially the same composition, while in alternative embodiments having different compositions).

The switching mechanism, and more particularly one or more components thereof (e.g., a moveable member, a first conductive contact, a second conductive contact, a spring, etc.), may be constructed of materials that enable an electrical current to flow therethrough, and/or that is sufficiently moveable or flexible so as to be moved or flexed from one position to another as the noted pressure differential increases or decreases. For example, the moveable member may be made of, or comprise, essentially any material that will undergo a sufficient elastic deformation (e.g., moves or flexes a sufficient distance) in response to the load created by the pressure differential, and more particularly will sufficiently deform in response to a predetermined pressure differential while remaining within the elastic range of the material (so as, for example, to return to its initial form, or substantially its initial form, once the pressure differential is removed or substantially decreased). Additionally, in one or more embodiments, the material desirably (i) provides sufficient force (e.g., spring force) so as to maintain electrical contacts within the switching mechanism when there is essentially no pressure differential (i.e., the pressure on both sides of the switching mechanism is substantially the same) and/or when the pressure differential is less than the predetermined value, but that (ii) sufficiently deforms or deflects to allow the contacts to open or separate when the pressure differential reaches a pre-determined value. Finally, the components and materials of the switching mechanism are also desirably selected to avoid excessive heating, as a result of the electrical current flowing therethrough.

In view of the foregoing, the moveable member, and optionally one or more of the other switching mechanism components (such as the spring, when present), may be fabricated from various known metals, plastics (e.g., conductive plastics), elastomers (e.g., conductive elastomers), etc., that are sufficiently elastic or flexible between the temperatures of about −30° C. and about 85° C. or more. For example, in one exemplary embodiment, the moveable member and/or spring is selected from a plastic material, which may or may not contain standard additives or fillers, that has a heat deflection temperature of at least about 85° C. at about 264 psi, and/or from a moldable, castable or extrudable plastic. Exemplary plastic materials suitable for use in the present disclosure include polypropylene, polyethylene and nylon, as well as elastomers such as EPDM, neoprene, nitrile, viton, natural rubber, and silicon. In an alternative embodiment, the moveable member and/or spring is selected from a metal or metal alloy such as steel, stainless steel, nickel, cooper or aluminum, the metals optionally having a metal plating, coating or surface treatment thereon. Additionally, depending on the locations of these materials within the on-demand hydrogen generation device, it is to be noted that they may be exposed to the various chemicals used in or resulting from the hydrogen gas generation reaction (e.g., located on the hydrogen gas generation side of the switch, rather than the atmospheric side thereof), and therefore are desirably selected to possess suitable chemical compatibility (e.g., stability) therewith. Furthermore, various known plating materials and methods may be used to enhance conductivity of, for example, various contact surfaces or to prevent corrosion.

In this regard it is to be noted that the moveable member, the first conductive contact and/or the second conductive contact may optionally have a resistive coating on a surface thereof (the coating being comprised of a material generally known in the art, and applied to the particular surface using means generally known in the art). Such a coating may be used, for example, to design a switch that can change resistance in controlled increments over short distances. Such designs may be used to reduce variability in the hydrogen pressure level maintained by the switch. Such designs may also be used to aid in the overall design of thin or low profile switching mechanisms.

The components of the switching mechanism, including for example the moveable member and the spring (when present) may be fabricated (e.g., cut, cast, molded, extruded, rolled, stamped, punched or created) using essentially any mechanical process known in the art. Additionally, the form or dimensions of the component are generally dictated, at least in part, by the overall dimensions of the on-demand hydrogen gas generation device and/or the hydrogen gas output pressure requirements of the fuel cell with which it is to be used. For example, as further illustrated elsewhere herein, the moveable member may be in the form of a square, rectangular or circular sheet, disk or washer (i.e., having a centrally located hole therein). The thickness may also be used, in combination with the composition thereof, to affect the pressure differential that causes the moveable member to move or flex. For example, in one or more embodiments of the present disclosure, the moveable member may have a fixed thickness ranging from between about 0.01 mm and about 2.5 cm, about 0.025 mm and about 1.5 cm, about 0.1 mm and about 1 cm, or about 0.25 mm and about 0.5 cm.

It is to be noted that the various embodiments of the switching mechanism, and more generally the on-demand hydrogen gas generation device, illustrated herein are exemplary and therefore should not be viewed in a limiting sense. For example, the switching mechanism may comprise one or more electrical contact points or poles. Furthermore, these contacts may be on the atmospheric side or the hydrogen gas side of the switching mechanism. More specifically, although the various embodiments illustrated herein provide for the electrical contact in the switching mechanism to be on the atmospheric side of the switch, it may also be on the hydrogen gas side of the switching mechanism. However, it is typically desirable for this contact to be on the atmospheric side, at least in part because this acts to isolate the contact from possible chemical attack and/or to isolate the switch function from the hydrogen gas atmosphere.

It is to be further noted that, as detailed elsewhere herein, the on-demand hydrogen gas generation device may comprise a switching mechanism that is integrated with the hydrogen gas generation means, or it may be a stand-alone or low-profile switch that is part of a hydrogen gas passageway that is linked to one or more hydrogen gas generation means. Additionally, or alternatively, multiple switching mechanisms may be used in the on-demand hydrogen gas generation device, for example in series to provide redundancy for safety purposes. The on-demand hydrogen gas generation device may also be constructed such that the hydrogen gas outlet vent (which leads to the fuel cell to which the device is connected) is independent of the switch, or alternatively the outlet vent may be integrated with the switch.

It is to be still further noted that the switching mechanism of the on-demand hydrogen gas generation device may be a first switching mechanism that is in electrical communication with a second switching mechanism (e.g., a switching mechanism of a hydrogen gas consuming device, such as a fuel cell). Generation of hydrogen gas by the on-demand hydrogen gas generation device (and more particularly the hydrogen gas generation means thereof) is initiated by allowing an electrical current to pass through the second switching mechanism and to the first switching mechanism. In this way, the on-demand hydrogen gas generation device may be activated, to initiate hydrogen gas generation, by electrically shorting the device through an external circuit (of, for example, the fuel cell) that comprises the second switching mechanism. In such an embodiment, the first conductive element or the second conductive element of the first switching mechanism may be a part of the second switching mechanism and therefore may be manufactured and shipped in an inactive state where it contains substantially little or no hydrogen.

Finally, it is to be noted that the resistance of the hydrogen generation device series circuit (including the generator cell, the first switching mechanism, the second switching mechanism (if included), and all electrical interconnections) generally dictates the current flow through the generator, since current is substantially proportional to hydrogen generation, and hence controls the rate of hydrogen generation. The sum of these resistances is therefore carefully evaluated during the design of the generator and adjusted to generate the desired current. In some cases, additional resistance may be added to the external portion of the series circuit in the form of a fixed resistance to reduce the current and thus the rate of hydrogen gas generation. (For example, a fixed resistance of about 0.3 ohms was added to the external series circuits to control the rate of hydrogen generation during testing of some the various designs discussed as examples elsewhere herein. The external resistance was, in those instances, applied using typical battery test equipment.) Optionally, the current flow through the hydrogen generation device series circuit may be initiated using external circuitry (e.g., a second switching mechanism). In such an embodiment, the first conductive element or the second conductive element of the first switching mechanism may be a part of the second switching mechanism. Additionally, the second switching mechanism may be incorporated in the gas outlet interface between the hydrogen generating device and the fuel cell.

In some situations the switch may be located in the fuel cell housing or the interface plumbing area rather than in the hydrogen generator itself. This is particularly true if the generator is a low cost, disposable device, in which case the relatively expensive switch is desirably located in a portion of the system that is non-disposable.

B. Galvanic Cell Corrosion with Switching Mechanism

In one embodiment of the present disclosure, hydrogen gas is formed in the on-demand hydrogen gas generation device by the electrolysis of water, or more generally by a standard galvanic cell corrosion reaction. In one particular arrangement, the device comprises a cell that comprises a means for generating a flow of hydrogen gas, and more particularly comprises an anode (or anode material) and a positive electrode (or cathode) material, which are in fluid communication with each other (and optionally separated by an ionically conductive and electronically insulating separation material). The positive electrode is in contact with an aqueous electrolytic solution within the cell, and furthermore is electrically connected (i.e., in an electrical series relationship) to the anode by a circuit that passes through a switching mechanism that is in electrical, as well as physical or mechanical, communication with the cell. The switching mechanism comprises a moveable (e.g., flexible) member that is operable to repeatedly or reversibly move between a first and second position in response to a pressure differential created by the hydrogen gas generation means (or more generally the cell comprising the hydrogen gas generation means) of less than 30 psig (e.g., less than about 25 psig, less than about 20 psig, less than about 15 psig, or even less than about 10 psig) and typically greater than about 1 psig (e.g., greater than about 2 psig, greater than about 3 psig, greater than about 4 psig, greater than about 5 psig or more), the pressure differential, for example, being in the range of from about 1 psig to 30 psig, or from about 2 psig to about 20 psig, or from about 3 psig to about 10 psig. In one or more embodiments, the moveable member may be operable to move downstream (or away from the high pressure side of the pressure differential) when the pressure differential exceeds a predetermined value of less than 30 psig (e.g., less than about 25 psig, less than about 20 psig, less than about 15 psig, less than about 10 psig, less than about 5 psig, or less) and to move upstream (or toward the high pressure side) when the pressure differential falls below this same predetermined value.

Once the generator is activated (as detailed elsewhere herein), in the first position of the switching mechanism, the circuit between the anode and positive electrode is essentially fully closed, thus allowing an electrical current to pass through the switching mechanism while experiencing as little resistance as possible therein, thus enabling the maximum rate of reaction at the positive electrode, and therefore hydrogen production, to occur. In the second position, the moveable member acts to at least partially open the circuit that connects the anode and positive electrode, thus increasing the resistance in the switching mechanism to the electrical current passing therethrough. As a result, the rate of reaction at the positive electrode, and thus hydrogen production, is decreased. If the pressure differential is sufficiently high, the moveable member will be moved or displaced far enough from the first position to effectively fully open the circuit that connects the anode and positive electrode; as a result, the resistance to the electrical current will be sufficiently great such that the reaction at the positive electrode is effectively stopped, thus stopping hydrogen gas production as well.

Generally speaking, the rate of hydrogen gas formation or evolution in such a cell (i.e., a cell comprising a reactive metal anode and a catalytic positive electrode for hydrogen gas formation) is proportional to the current flowing between the anode and positive electrode, which in turn is a function of the sum of the internal and external resistance in the electrical circuit which connects the anode and positive electrode. For example, experience to-date suggests that in an AA sized cell a continuous current of about 1.5 Amps needs to be sustained to reach a rate of about 10 cc of hydrogen gas generation per minute. Design of the cell desirably provides a high rate capability that is able to sustain the high hydrogen gas generation rate. This generally means: (i) the anode is designed or selected to provide a high discharge efficiency at a high continuous current, the cell having an optimum molar ratio of water to, for example, zinc (or, more generally, an optimum (water)/(anode active) molar ratio); (ii) the positive electrode has low hydrogen gas over-voltage and a high surface area; (iii) the electrolyte is selected to provide high ionic conductivity; (iv) a large anode-positive electrode interfacial area is present, the (interfacial area)/(anode volume) or (interfacial area)/(zinc volume) ratio is optimized; and, (v) the separator is selected such that a high-rate discharge can be sustained, utilizing its property of high water transport rate. The interfacial area is defined as the geometric area of the positive electrode (or cathode) that is directly against the anode surface. Additionally, and as further detailed elsewhere herein, desirably the hydrogen gas generation device is designed to provide proper gas transport therein, in order for example to maximize output and minimize the accumulation of hydrogen gas in the pores of the positive electrode (which may lead for example to substantial polarization); that is, the hydrogen gas generation device desirably includes a gas management system, as further detailed elsewhere herein. Finally, it is desirable to minimize positive electrode volume, in order to maximize the volume of “fuel,” and more specifically in this embodiment the anode fuel (e.g., the volume of the anode active material, such as zinc, plus the total volume of the electrolyte, such as water) in the cell, which will be consumed during operation of the cell, in order to form or generate hydrogen gas.

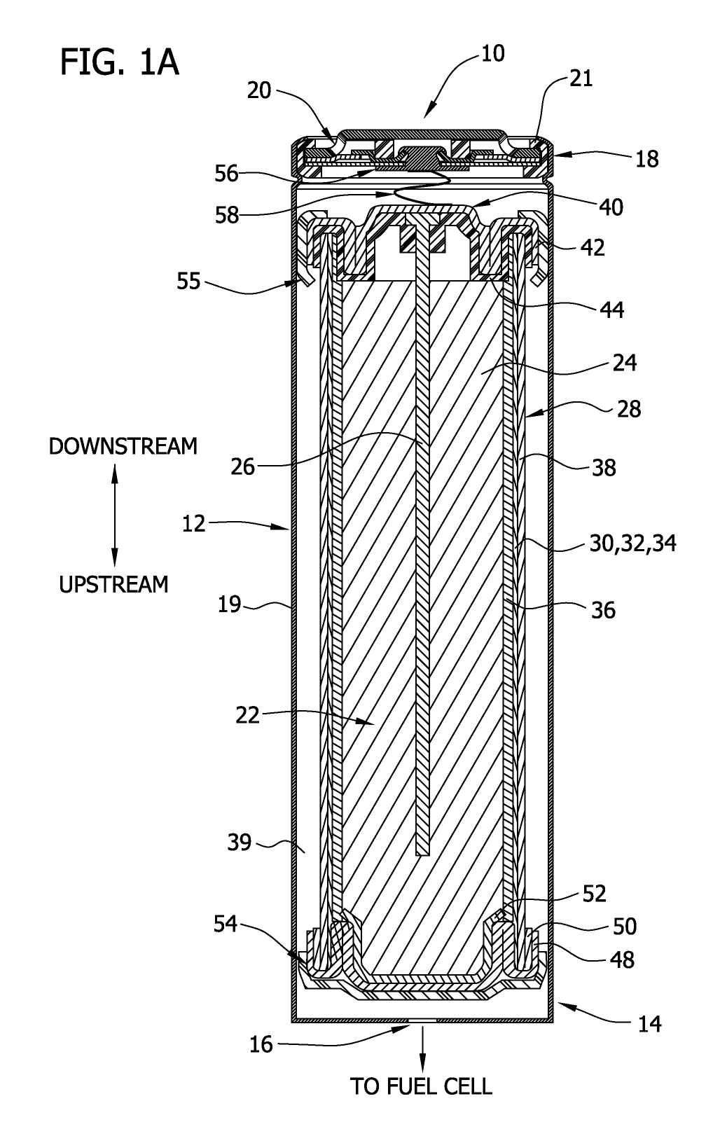

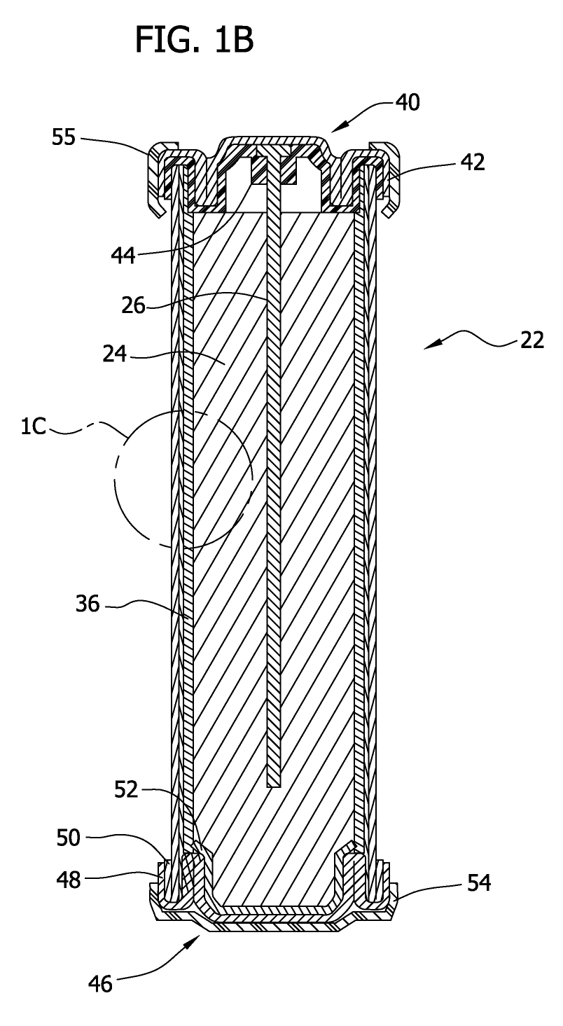

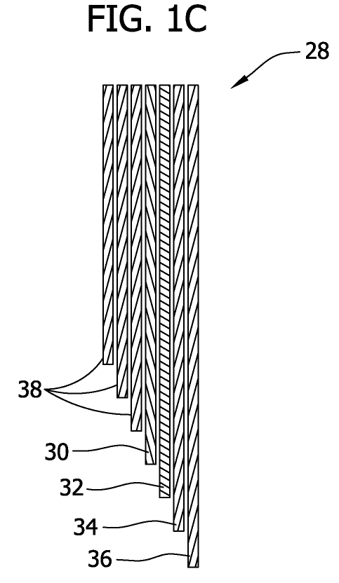

Referring now to FIGS. 1A through 1C, one exemplary embodiment of an on-demand hydrogen gas generation device 10 is provided in accordance with the present disclosure. In particular, the device 10, has an axially extending positive outer shell or can 12, a first or positive end (indicated generally at 14) that has one or more holes 16 therein to allow the venting of hydrogen gas from inside the can (which is connected by a passageway or conduit of some kind (not illustrated) to the hydrogen gas-consuming device or fuel cell (also not illustrated)), and a second or negative end (indicated generally at 18) that is generally opposite and disposed generally axially downstream of the positive, vented end 14, and a cylindrical sidewall 19 between the positive and negative ends 14 and 18. The negative end 18 of the can 12 is closed by means of a first negative end cap, 20, the first negative end cap and the negative can end being adapted in size and shape such that the first negative end cap and the negative can end are sealingly connected (by, for example, crimping the negative end of the can over the end cap and a flexible seal or gasket 21, which may or may not be integrated with a switching mechanism as further detailed elsewhere herein) during assembly, by means generally known in the art.

Within the volume or space defined by the inside of the can 12 is a means for generating hydrogen (or a hydrogen gas generation means), indicated generally at 22, that comprises an anode 24 and a negative current collector 26 in contact therewith, and a cylindrical positive electrode or electrode assembly 28 (which in one or more embodiments may be referred to elsewhere herein as a gas management electrode), which substantially surrounds the anode and negative current collector. In general, and as detailed elsewhere herein, the anode comprises or is selected from a material with low thermodynamic nobility, such as for example zinc, magnesium, aluminum, titanium, and combinations thereof. The amount of anode active agent or material generally included in the anode is less than about 80% by weight of the total weight of the anode components. The total weight of the anode components includes the weight of each component making up the anode such as, for example, anode active agent, gelling agent, surfactant, alloying agent, electrolyte, etc. Desirably, the amount of anode active agent is from about 60% by weight to about 75% by weight, and more desirably from about 67% by weight to about 71% by weight. The anode active agent, such as zinc, can be present in the anode in the form of particles, fines, or dust, for example. Also, combinations of these forms may be utilized.

Conventional zinc powders contain particles having a wide distribution of particle sizes ranging from a few microns to about 1000 microns, with most of the particle size distribution (PSD) ranging between about 25 microns and about 500 microns. Therefore, in order to achieve proper discharge of such conventional zinc powders, a potassium hydroxide (KOH) concentration above about 34% is conventionally used and necessary. While such concentrations of electrolyte are still applicable and effective, in a hydrogen gas generating device which involves consumption of the water from the electrolyte, it is desirable to use more dilute electrolyte at assembly, since the electrolyte will become more concentrated as the water is consumed during hydrogen generation. Zinc powders with conventional PSD are sensitive to low electrolyte concentrations and can passivate easily. Therefore, use of the narrower PSDs disclosed herein allows use of more dilute electrolytes without premature passivation. A potassium hydroxide concentration of less than about 35% (for example between about 20% and about 35% potassium hydroxide concentration) may be desirable in various embodiments.

With respect to the anode material, it is to be noted that physical modifications thereof can also improve service life, either alone or in combination with chemical modifications noted elsewhere herein (or by means generally known in the art). For example, in cells having a low concentration of hydroxide ions, the hydrogen-generating reaction therein may be improved by reducing diffusion resistance for the hydroxide ions. This can be accomplished, for example, by adjusting the particle size distribution to provide in the anode a narrow distribution of similar zinc particle sizes, thereby enhancing porosity (diffusion paths) for the hydroxide ion transport. In addition to improving diffusion properties, controlling the particle size distribution also provide the porosity sites for the precipitation of, for example, ZnO, thereby delaying anode passivation. A narrow particle size distribution (as described, for example in U.S. Patent Application Publication No. 2005/0079415, the entire contents of which are incorporated for all consistent and relevant purposes) allows the use of electrolyte concentrations significantly lower than in conventional alkaline cells. This approach is effective for use in the anodes of different types of cells, including for example zinc manganese dioxide and zinc-air alkaline cells, and can be used alone or in combination with other improvements disclosed herein (or generally known in the art). Similar advantages have been observed when used in a zinc/Ni hydrogen generator cell as detailed in this disclosure. One exemplary anode material (e.g., zinc) particle size distribution that may be suitable for one or more embodiments of the present disclosure is one in which at least about 70% of the particles have a standard mesh-sieved particle size within about a 100 micron size range and in which the mode of the distribution is between about 100 and about 300 microns. More particularly, particle size distributions meeting the above-noted tests and having a mode at about 100 microns, or at about 150 microns, or at about 200 microns, each plus or minus about 10%, may be advantageously used in the present disclosure. It may be particularly desirably that about 70% of the particles be distributed in a size distribution range even more narrow than about 100 microns (e.g., about 80 microns, about 60 microns, about 40 microns, or less).

In some embodiments of the present disclosure, the anode of the on-demand hydrogen gas generation device may be prone to various undesirable corrosion reactions when stored at or above room temperature prior to use. It is to be noted that hydrogen generation in the anode compartment is highly undesirable, particularly during storage and transportation prior to use. Even during use, the hydrogen generation is desirably confined to that occurring on the cathode surface. The type of electrolyte in the anode (e.g., an alkaline solution such as KOH) may corrode the zinc (or other anode active agent) upon contact, forming oxidized zinc products that decrease the availability of active zinc while simultaneously also generating unwanted hydrogen gas in the anode compartment. The rate of corrosion generally increases as the storage temperature rises and can lead to a dramatic decrease in anode active agent capacity. Gas generated in such reactions can increase pressure in the anode, cause electrolyte leakage and disrupt the device integrity. The rate at which the unwanted gas is generated at the anode active surface accelerates when the anode active material is partially discharged or consumed, thereby decreasing the resistance of the anode to electrolyte corrosion. The corrosion reactions that lead to gas evolution involve cathodic and anodic sites on the anode active surface. Such sites can include surface and bulk metal impurities, surface lattice features, grain boundary features, lattice defects, point defects, and inclusions.

To minimize undesirable corrosion and anode gassing during storage, it is typical to employ corrosion-resistant zinc alloys and to reduce the extent of impurities in the anode. A suitable zinc powder (or other anode active) can be alloyed with one or more of indium, bismuth, calcium, aluminum, lead, phosphorous, etc. A particularly suitable alloying agent for minimizing gassing is bismuth. Typically, alloy powders can include from about 0.01% to about 0.5% by weight alloy agent alone, or in combination with, from about 0.005% to about 0.2% by weight of a second alloying agent, such as lithium, calcium, aluminum, and the like.

To further minimize undesirable corrosion and anode gassing during storage as described above, it is typical to add organic surfactants and inorganic corrosion-inhibiting agents to the anode. Surfactants act at the anode-electrolyte interface by forming a film that protects the anode active surface from the electrolyte during storage. The inhibitive efficiency of surfactants to increase the corrosion resistance of the anode active depends on their chemical structure, concentration, and their stability in the electrolyte. Among the surfactants known to be effective at controlling gassing are organic phosphate esters such as the ethylene oxide-adduct type disclosed by Rossler et al. (in U.S. Pat. No. 4,195,120). Additionally, in U.S. Pat. No. 4,777,100, Chalilpoyil et al. disclosed an anode containing single crystal zinc particles with a surface-active heteropolar ethylene oxide additive including organic phosphate esters. Specifically, commercially available surfactants such as Rhodafac RM-510, Rhodafac RA-600, Witconate 1840X, and Mafo 13 MOD1 are suitable surfactants for use in the present disclosure, as described in for example U.S. Pat. Nos. 6,872,489 and 7,226,696 (the entire contents of which are incorporated herein by reference for all relevant and consistent purposes).

The anode as described herein will generally include a gelling agent to help suspend the anode active material throughout the electrolyte to allow for the anode active to more fully react. Essentially any gelling agent known in the art, which is suitably or sufficiently compatible with the other components in the anode, may be used in accordance with the present disclosure. Examples of suitable gelling agents include polyacrylic acids, grafted starch materials, salts of polyacrylic acids, polyacrylates, carboxymethylcellulose, or combinations thereof. Examples of suitable polyacrylic acids include Carbopol 940 and 934 (available from Noveon) and Polygen 4P (available from 3V). An example of a grafted starch material is Waterlock A221 (available from Grain Processing Corporation). An example of a salt of a polyacrylic acid is Alcosorb G1 (available from Ciba Specialties).

In this regard it is to be noted that, in order to optimize or maximize the rate capability and/or discharge efficiency, the anode is desirably designed to sustain a high discharge current without passivation. As a result, the anode is desirably optimized for continuous discharge with high discharge currents, or for intermittent discharge with longer continuous discharge periods than about one hour (which is typical for an alkaline cell). Factors that influence the discharge performance or behavior include, but are not limited to, the surface area of the anode active material (e.g., zinc surface area), the particle size thereof, the particle size distribution thereof, the loading thereof, the electrolyte concentration, and/or the nature and amount of the surfactant and/or gelling agent present therein. (See, e.g., U.S. Pat. No. 7,226,696, the entire contents of which are incorporated herein by reference for all relevant and consistent purposes.) Additionally, as previously noted, the anode is also desirably designed to contain the maximum amount of anode active material (e.g., zinc) possible because, generally speaking, this is fuel and therefore it directly affects how much hydrogen is produced.

The proper choice of zinc powder PSD enables the use of lower electrolyte concentrations without the premature passivation that would otherwise occur with conventional zinc PSDs. In particular, passivation generally occurs in electrochemical cells when the anodic reaction produces zinc oxide, which covers the remaining zinc in the anode, thereby preventing the KOH from accessing and reacting with the remaining zinc. It is well known that conventional MnO2 alkaline cell anodes having conventional PSD prematurely passivate when lower electrolyte concentrations are used. Conventional anode particle sizes are distributed between 45-500 microns, thus within a broad range of 455 microns, rather than a narrow range of 100 to 150 microns that is envisaged by the present inventors.

Alternatively, the zinc PSDs disclosed herein desirably can be distributed within a narrow window of 200 microns and, alternatively, 150 microns, meaning that between and including 90% and 95%, and up to 100%, of the particle sizes, by weight, are within the 150, or 200, micron window, and in particular are tight distributions substantially centered around 100 □m, 175 □m, and 250 □m, and 300 □m (meaning that between and including about 90% and about 95%, and up to about 100% of the zinc particles have particle sizes centered around the specified sizes). One skilled in the art will recognize that mesh sizes corresponding to these particle sizes can be identified using ASTM Designation: B214-99.

In addition to the anode active material (and an alloying agent, if present), the anode additionally includes an electrolyte therein, which provides water for the galvanic corrosion reaction and which facilitates ionic transfer between the anode and the positive electrode. With respect to the electrolyte, it is to be noted that essentially any electrolyte known to be suitable for use in a galvanic cell corrosion reaction may be used in accordance with the present disclosure. Typically, however, the electrolyte is desirably selected from those materials that possess high ionic conductivity, in order to provide the desired rate capability. Additionally, the composition of the electrolyte is desirably selected in view of the recognition that a substantial amount of water is consumed during the hydrogen gas-generating reaction at the positive electrode. As a result, the initial volume of the electrolyte, like the anode active material, is desirably maximized within the on-demand hydrogen gas generation device (because of the water consumption, as well as because some of the electrolyte may potentially be carried away with the hydrogen gas stream at high rates of gas evolution). Common electrolytes suitable for use in the present disclosure therefore include, for example, solutions comprising hydroxide, chloride or acetate ions. Typically, the electrolyte is a potassium hydroxide or sodium hydroxide solution. However, in some cases, the electrolyte may contain dissolved salts, oxides or hydroxides of bismuth, tin, indium, mercury, lead, cadmium, or thallium. Additionally, the electrolyte may include a dissolved cation or anion of the metal anode (e.g., an aluminum oxide, sodium aluminate, potassium aluminate, a zinc oxide, a zinc hydroxide, or calcium salts). In some embodiments, the electrolyte may additionally contain a corrosion inhibitor such as a quaternary ammonium salt, or a non-ionic, anionic, or cationic surfactant.

When potassium hydroxide is utilized as the electrolyte, the concentration of potassium hydroxide may typically be from about 15% by weight to about 45% by weight, and desirably from about 20% by weight to about 35% by weight. Generally, when zinc is the anode active agent, the electrolyte may include a small amount of zinc oxide to retard open circuit corrosion and stabilize the zinc surface and reduce gassing. The amount of zinc oxide may be from about 0.1% by weight of the anode to about 2% by weight of the anode. The stoichiometric water/zinc molar ratio is about 2. However, depending on the hydrogen generation rates needed and the cell design used, it has been found that the water to zinc molar ratio may typically range from about 1.4 to about 2.5, and desirably from about 1.6 to about 2. One skilled in the art will therefore recognize that similar ratios can be determined for other fuel materials such as, for example, aluminum, magnesium, etc.

The Interfacial Area/Zinc Volume ratio has a strong influence on the rate of generation of hydrogen gas and on fuel (zinc) utilization efficiency. The cell design and electrode design generally dictate this ratio, since a higher ratio generally means that the zinc (anode) layer is thinner. A thinner anode layer is generally capable of higher rate discharge and also higher efficiency of utilization. The ratio can typically range from about 5 to about 60, and desirably from about 10 to about 50. The choice of the appropriate ratio to use also depends upon other factors, such as for example the hydrogen capacity (i.e., the total amount of hydrogen needed from a certain volume of generator), which is dictated by the amount of zinc. For a fixed volume of generator, too high an interfacial area-to-zinc volume ratio will result in an inadequate amount of zinc in the generator to supply the needed hydrogen gas capacity. Generally, a higher ratio implies a lower hydrogen capacity in a fixed volume. For low rates of gas generation, a low ratio is adequate, providing high hydrogen capacity.

Referring again to FIG. 1C, and as further detailed elsewhere herein, the positive electrode or electrode assembly 28 may comprise a number of different layers of material. In general, the positive electrode assembly comprises (i) a conductive substrate 30 and (ii) a catalyst or catalyst layer 32 (which may also be referred to generally as the positive electrode material) disposed thereon or therein, and optionally also functions as a significant component of the current collector, (iii) a gas impermeable and liquid permeable hydrophilic layer, 34, which is disposed adjacent the catalyst layer 32, between it and the anode (as further detailed elsewhere herein), (iv) an optional separator 36, disposed between the anode and the gas impermeable and liquid permeable hydrophilic layer 34, and (v) one or more layers (e.g., 2, 3 or more) or wraps of a gas permeable and liquid impermeable hydrophobic layer or material 38, also disposed adjacent the catalyst and present on the outer surface thereof (as further detailed elsewhere herein). The conductive substrate, catalyst layer, gas impermeable and liquid permeable hydrophilic layer, and gas permeable and liquid impermeable hydrophobic layer (and optionally the separator) may be collectively referred to herein as the “gas management electrode” or “gas management positive electrode” (as further detailed elsewhere herein).

In this regard it is to be noted that, as used herein, the term “impermeable” means substantially impermeable; that is, the term “impermeable” does not mean 100% impermeable in all situations or conditions. Instead, it is recognized that although there may be some pressure and/or temperature parameters wherein the material becomes permeable to some extent, at standard operating conditions for the device described herein, the material described as “impermeable” is substantially impermeable to either gas or liquid as described.

In this regard it is to be further noted that the catalyst, or positive electrode active material, is generally a catalytic redox material that is inert and non-consumable; that is, the positive electrode material is present, in general, simply to provide the electrons and does not otherwise participate in the overall hydrogen-gas producing reaction or process. Accordingly, generally any known material suitable for use as a positive electrode material in a galvanic cell may be employed in accordance with the present disclosure. However, the positive electrode material is desirably selected from materials having as low a hydrogen over-voltage as possible, and additionally is in a form with optimized surface area, in order to provide a sufficient, and desirably an optimum, rate capability. The stability of the positive electrode toward corrosion or oxidation, under open circuit conditions, may also be a consideration (under closed circuit conditions positive electrode corrosion generally does not occur because of cathodic protection) when selecting a suitable positive electrode material. As previously noted, however, the overall volume of the positive electrode material is desirably as low as possible, in order to provide the maximum amount of space or volume possible within the on-demand hydrogen generation device for the fuel. Furthermore, it is desirable to limit the amount of reducible metal oxides present in the positive electrode material, given that these will reduce the amount of hydrogen that can be generated due to the resultant need for a reduction of the oxides present prior to hydrogen evolution. From a practical standpoint however, as detailed in the examples section, some deliberate and controlled oxidation or stabilization of the catalyst material may be necessary in order to allow for processing of highly reactive or oxygen sensitive catalysts, such as Raney nickel. Finally, the migration of even small amounts of impurity metals (such as, for example, iron or nickel, both of which are often candidates for use in low-cost positive electrodes) to the anode can significantly increase the self-discharge rate of the anode material (e.g., zinc anode) and cause undesirable gassing in the anode compartment which could lead to leakage of electrolyte or other undesirable consequences including rupture in extreme cases. Accordingly, when such metals are used, precautions are desirably taken to substantially limit, or prevent, such migration. When properly selected, an added benefit of the gas impermeable liquid permeable hydrophilic layer (also referred to as the thin film separator) is its ability to substantially reduce the migration of anode fouling species into the anode compartment. Films comprising polyvinyl alcohol (PVOH) and copolymers of PVOH have been previously disclosed (see, e.g., U.S. Patent Application Publication No. US 2006/0257728A1 filed Feb. 15, 2006, which is incorporated herein by reference) to possess such properties. A particularly suitable thin film has as small a cross-sectional thickness as is practical, while retaining manufacturing processibility (e.g., flexibility, mechanical stability, integrity at processing temperatures, integrity within the cell, and the like), adequate electrolyte absorption, as well as the other advantageous properties noted herein. Suitable films typically have a single layer, dry thickness (i.e., a thickness prior to being contacted with an electrolyte and after being equilibrated/stored for about 24 to about 48 hours, in an environment where the relative humidity ranges from about 49%, +/−about 6%, and the temperature is about 21° C., +/−about 1° C.) of typically less than about 250 microns, less than about 200 microns, less than about 150 microns, or even less than about 125 microns, the thickness ranging for example from about 5 microns to about 125 microns, from about 10 microns to about 100 microns, or from about 25 microns to about 75 microns. In this regard it is to be noted that, depending on the difference between the pH value of the bulk electrolyte and the pH value of the electrolyte retained in the separator, the thickness of a film separator may be selectively optimized, in one embodiment for example, to effectively limit the migration of anode-fouling soluble species.

As noted elsewhere herein, the thin film separator may, in one specific embodiment, optionally be formed on the surface of the anode or cathode, thereby forming a conformal separator thereon (see, e.g., U.S. Patent Application Publication Nos. 2003/00446086 and 2004/0229116, the entire contents of which are incorporated herein by reference.). Alternatively, however, in one particularly desirable embodiment the separator may be laminated to the positive electrode surface using a variety of means familiar to one skilled in the art, including heat, pressure, adhesives, and combinations thereof. A good interface between the gas impermeable and liquid permeable layer and the cathode ensures good and transport of liquid and ions, and also minimizes areas for accumulation of hydrogen gas bubbles (on the positive electrode side) between the catalyst layer and the gas impermeable layer.

The thin film may have an average pore size optimized for a particular application or use. Typically, however, the average pore size is less than about 0.5 microns (such as, for example, when a multilayer separator structure, or multiple wraps of a single layer separator, is used), less than about 0.1 microns, less than about 0.075 microns, less than about 0.05 microns, less than about 0.01 microns, or even less than about 0.001 microns (e.g., about 0.0005 microns, or about 0.0001 microns), the average pore size range being within the range of, for example, about 0.001 microns and about 0.5 microns, or about 0.01 microns and about 0.1 microns. Alternatively, however, the average pore size may be within the range of, for example, about 0.0001 to about 0.0005 microns.

In this regard it is to be noted that, as expressed herein, the average pore size is for a dry film, being determined at an ambient relative humidity of about 30% to about 80%, and at a temperature of about 20 to about 30° C. It is also to be noted that, in order to effectively limit migration of dissolved ionic species, the films or membranes must have extremely small “pores,” the size of which cannot easily be measured directly using conventional methods. Instead, the pore sizes noted herein are estimates, based on the physical and/or mathematical models that incorporate the dimensions of the migrating ions or molecules, the mechanism of transport and the rate of transport, etc. This is known and understood by one skilled in the art of ultrafiltration, reverse osmosis, etc.

The composition of the thin film separator may vary, depending upon for example the particular properties that are desired for the film (e.g., ionic resistance, water transport, etc., as further detailed elsewhere herein), and/or the particular conditions to which the film is to be subjected (e.g., process or manufacturing conditions, and/or use conditions). In one particular embodiment, however, the film is a PVA film, which may or may not be modified in some way (e.g., copolymerized, and/or partially or fully cross-linked, the degree of cross-linking therein being, for example, at least about 10%, about 25%, about 50%, about 75% or more, based on the total number of potential cross-linking sites therein). Furthermore, the cross-linking may be performed such that only one or other surface is cross-linked, leaving the interior portion substantially un-cross-linked.

In general, the number of layers of the thin separator film used in the electrochemical cell may be optimized for a given application and/or to achieve a desired performance within the cell. In addition, to preventing generated gas from being transported to the anode compartment, it is also believed that the thin film separator detailed herein acts to improve shorting resistance, given that a film with small pore size provides excellent internal shorting resistance. Rapid, preferential water transport through the films described herein is a key factor in providing superior high rate performance as described elsewhere. Accordingly, in at least some embodiments, the separator will be as thin as possible, in order to maximize the rate of discharge (i.e., achieve as high a current as possible).

It is to be noted that rapid water transport, or osmotic transport, may act to enable or provide a high discharge rate. Accordingly, the thin film separator may have a water osmosis rate as detailed elsewhere herein (e.g., a rate of at least about 1×10⁻⁶ moles-cm/cm²/hr, at least about 1×10⁻⁵ moles-cm/cm²/hr, at least about 5×10⁻⁵ moles-cm/cm²/hr, or more.)

It is to be further noted that in the presence of electrolyte, the thickness of the thin film separator may increase, or it may swell, by greater than about 0% and less than about 100%, less than about 75%, less than about 50%, or less than about 25%, as compared to the initial or dry thickness of the thin film separator. For example, in one particular embodiment, the thickness of thin film separator, upon contact with an electrolyte, swells or increases by about 0.1% to about 15%, by about 0.2% to about 10%, by about 0.5% to about 5%, or by about 1% and less than about 2%. Additionally, or alternatively, it is also to be noted that the length and width dimensions (also defined as machine direction and transverse direction, with respect to the orientation during manufacture of the film) of the film also change with absorption of electrolyte. The length and width dimensions, for example, may increase by less than about 15%, less than by about 10%, less than by about 5%, or less than about 2% each.

The thin film separator materials suitable for this application desirably also minimize the transport of anode fouling soluble species that may be present in the catalyst material. Such anode fouling species can cause highly undesirable gassing in the anode compartment. Such impurities include, for example ions of metals such as molybdenum, antimony, iron, etc. that are often found in various amounts in typical Raney Nickel catalysts. The separator is thus associated with an “Exclusion Value” that refers to a percentage of soluble species that is prevented from migrating from the cathode through the separator to the anode. “Substantially all” is intended to indicate that the separator has an Exclusion Value of at least about 50%; alternatively at least about 60%; alternatively at least about 70%, alternatively at least about 80%, alternatively at least about 85%; alternatively at least about 90%; alternatively at least about 95%; alternatively at least about 97%; and finally alternatively at least about 99%, per the test method developed and described herein.

It will be appreciated, however, that to the extent the anode active material of a cell tolerates the soluble species, the cell can tolerate some migration through the separator of anode-fouling soluble species. Generally, therefore, a suitable separator effectively limits the migration of anode-fouling soluble species if the separator passes less of the species than the anode active material can tolerate without becoming fouled. Substantially lower amounts of the soluble species are desired, however.

A suitable hydrophilic gas impermeable and liquid permeable thin film separator material also desirably transports water preferentially over hydroxide ions, and hydroxide ions over soluble species. This is an indication of “osmotic” transport. When such materials are used as separators in electrochemical cells, this property of the films can be advantageously leveraged to benefit the discharge behavior of a cell by accelerating the rebalancing of the OH— and H2O concentrations in the electrolyte as the cell discharges.

An osmotic transport test (such as disclosed in U.S. Patent Application Publication No. 2005/0257728, the entire contents of which are incorporated herein by reference for all relevant and consistent purposes) may be used to measure water and KOH transport through films and membranes. The test is performed using a glass fixture. The film in question is placed between Side A and Side B and sealed with an “O” ring such that fluid communication between the two sides occurs only through the film. The tubes in this case are graduated in steps of 0.1 ml, such that the volume changes on each side may be monitored. After assembling the fixture, 14 ml of 45% KOH is placed in side A and 14 ml of 4.5% KOH solution in side B. Prior to assembly, the separators are equilibrated with 29% KOH for 12 hrs so as to minimize “wet-up” time.

The liquid level on the side containing 45% KOH rises, while the level on the other side falls. This is because osmotic transport causes the water to be transported through the film at a faster rate than the OH⁻ ions. The preferential water transport to the side containing 45% KOH causes the liquid level to increase. The rate of volume change is monitored, and after 4 hours the solutions on both sides were sampled to analytically determine KOH concentration. The volume change on the 45% KOH side can be measured as a function of time for various films evaluated. The rate of water transport can then be calculated. The exposed cross-sectional surface area of the separators in this test is 1.4 cm². Determination of the concentration of liquid on each side provides an estimate of the average molar rate of transport through the film. The calculations are based on the total moles of water transported in a 4 hour period in the Osmotic Transport Test. Based on this calculation method, the moles of water or OH⁻ ions transported in a 4 hour period can be estimated to determine the rate. The flux of the species transported depends upon the cross-sectional area of the film, as well as on the thickness of the material. The thicker the film, the less the transport. Similarly, the larger the cross-sectional surface area, the more the flux. In order to incorporate both these parameters, the transport rate here is reported as moles-cm/hr/cm², or simply moles/hr/cm.

Preferential water transport is believed to minimize concentration gradients between the anode and cathode, and this property is particularly suitable for a hydrogen generator as described herein due to significant consumption of water in the reaction. The reason for this is that rapid water transport will help reduce concentration polarization and maintain a higher cell operating voltage. While not being limited to specific discharge rates, this property is particularly beneficial during high rate discharges where concentration polarization tends to play a bigger role.

In accordance with one aspect of this disclosure, therefore, the electrochemical cell comprises film separators, the film having a water osmosis rate greater than at least about 1×10⁻⁶ moles/cm/hr as determined using the Osmotic Transport Test described herein. Further, the films possess the ability to transport water at a rate greater than at least about 1×10⁻⁵ moles/cm/hr, and at least about 5×10⁻⁵ moles/cm/hr.

The ionic resistance of the hydrophilic thin film separator is an important characteristic that influences the discharge current and gas generation rate. Generally, the lower the resistance, the better the performance; however, this is desirably balanced against the need to provide adequate protection against internal shorting. The ionic resistance of a separator material is a function of the material characteristics according to the following equation:

R=ρ(l/A)

wherein “R” is the resistance in ohms; “ρ” is the resistivity of the material with units of ohm-cm (derived from (ohm*cm²/cm); “l” is the thickness of the material with units of cm; and, “A”=cross-sectional area of the material perpendicular to the axis of flow, cm².

The resistivity of a material is a fundamental characteristic of the material. The resistance “R” of a film in a particular electrolyte can be directly measured in a special fixture where a fixed gap is provided between two identical, planar, solid graphite electrodes. The exposed cross-sectional area for all measurements is fixed at 1 cm2, hence the measured resistance is only a function of the material, its thickness, and the electrolyte being used. The gap between the electrodes is initially filled with a known electrolyte (e.g. 32% KOH in water) and the resistance of the electrolyte alone (background) is first measured across the gap by an AC impedance technique using a Solartron Model SI 1255 Frequency Response Analyzer known to one skilled in the art. A single high frequency (10 kHz), 10 mV sinusoidal signal is applied to determine the ohmic resistance of the gap between the two electrodes. The temperature is maintained at 22° C.+3° C. This initial measurement provides the background resistance between the two electrodes. Next, the separator material in question (e.g. PVA film) is placed in the holder and positioned directly between the two electrodes. The entire apparatus is filled with electrolyte above the level of the film and electrodes, air bubbles are removed, and the film is allowed to soak for at least 24 hours prior to measurement, so as to eliminate/minimize the effect of differences in the rate of absorption of electrolyte by different films. It is also possible to pre-soak the sample film in the electrolyte prior to fixture assembly. With the separator in place, the impedance measurement is again performed to determine the resistance between the two electrodes to provide a second resistance measurement. The difference between the second and the first measurement provides a measure of the resistance of the separator material. This is believed to be representative of the separator resistance in an actual battery after it has equilibrated with the electrolyte in the system. The method is used to screen various potential separator films and film combinations, with or without a non-woven material backing.

Table A below shows the resistivity of various materials evaluated in such a fixture using 32-0 KOH electrolyte. The non-woven, being extremely open and porous, has very low resistivity, but in a practical battery, a minimum of 3, desirably 4 wraps of the material are necessary. To determine the actual resistance of a particular separator material in a battery, one would need to know the thickness and the total surface area.

TABLE A

| | Resistivity |
|---|---|
| Material | (ohm-cm) |
| Viskase Cellophane | 23.6* |
| M2000 PVA film | 37.7 |
| M1000 PVA film | 38.9 |
| M 1030 PVA film | 23.3 |

Suitably, the hydrophilic separator materials used in the present disclosure have an ionic resistivity of less than about 100 ohm-cm. More suitably, the separator materials have an ionic resistivity of less than about 50 ohm-cm, even more suitably, less than about 40 ohm-cm, even more suitably, less than about 25 ohm-cm, even more suitably, less than about 10 ohm-cm, and even more suitably less than about 5 ohm-cm.

The catalyst is ideally in a finely divided form and very well distributed throughout the support, to ensure rapid and effective reaction to ensure high operating voltage. Inexpensive, highly active, well-distributed fine particle catalysts and processes for making them are therefore important. The choice of materials must take into account its ability to withstand a corrosive environment that would be encountered in an electrochemical cell. In view of the foregoing, the catalytic positive electrode material is desirably selected from a material having a BET surface area of at least about 0.1 m²/g, about 1 m²/g, about 10 m²/g, about 100 m²/g, about 250 m²/g, or even about 500 m²/g, the surface area for example ranging from about 0.1 to about 500 m²/g, from about 1 to about 250 m²/g, or from about 10 to about 100 m²/g. Other suitable surface area ranges, for various embodiments, include for example: from about 0.1 to about 0.5 m²/g, from about 0.5 to about 1 m²/g, from about 1 to about 10 m²/g, from about 10 to about 50 m²/g, from about 50 to about 100 m²/g, or from about 100 to about 500 m²/g.

Suitable materials include, for example, metals or Raney metals of Group VIII of the Periodic Table. Typically, however, metals such as nickel (e.g., nickel foam, nickel mesh, Raney nickel particles, nickel powder, etc.), platinum, platinum black, palladium, or other metals such as silver, copper, iron, cobalt, molybdenum and molybdenum compounds (e.g., molybdenum sulfide, MoS2), as well as various combinations thereof (e.g., nickel-cobalt, iron-nickel, etc.), can be used. Materials such as carbon in various forms can also be used as effective catalysts. The quantity of catalyst in the catalyst layer (catalyst+support+binder and any other additives) can range from about 0.1% to about 90% by weight depending on the activity of the catalyst and the cost. For example, platinum or platinum black would typically fall near the lower end of the range whereas less expensive catalysts such as Raney Nickel could be closer to the upper range, depending on activity. In the examples described herein, the de-activated Raney Nickel catalyst composition was about 75%.

The positive electrode active material may be in a number of different forms, including for example a powder or high surface area particle (e.g., nickel particle) that are dispersed or deposited (e.g., mixed, blended, coated, sprayed, sputtered, etc., using means generally known in the art) on a support of some kind. Suitable supports include, for example, high surface area carbon or ceramic particles, including for example carbon black (e.g., Vulcan XC72, Shawinigan Black, Black Pearls 2000, Ketjen Black, etc.) and activated carbon (e.g., PWA grade carbon from Calgon Corp.). Exemplary catalyst/support combinations include, for example, Raney nickel powder blended with PWA carbon, nickel plated on a nickel foam or screen support, and nickel particles on a carbon support (as further detailed in the Examples provided below). The quantity of catalyst support in the catalyst layer (catalyst layer mass=mass of catalyst+support+binder and any other additives) may range from about 98% to about 20% by weight, depending upon the catalyst being used. It is to be noted that if the catalyst/support combination has the adequate electronic conductivity and structural stability or strength then no additional current collector may be necessary. The catalyst/support combination could then be directly coated or laminated on to the gas impermeable but liquid permeable hydrophilic layer. Conversely, the gas impermeable but liquid permeable hydrophilic layer may be cast from a solution or suspension on to the catalyst/support combination.

In one particular embodiment, Raney nickel is used as the positive electrode material. In this regard however it is to be noted that Raney nickel is typically very reactive in air (e.g., it may spontaneous burn), and therefore is typically commercially available as a fine powder in water. However, such material may be rendered suitable for use in accordance with the present disclosure by first de-activating the material temporarily (by forming a protective oxide layer thereon, by means of controlled activation of the surface thereof, using means generally known in the art, such as those disclosed by M. A. Al-Saleh et al., Novel Methods of Stabilization of Raney Nickel Catalysts for Fuel Cell Electrodes, Journal of Power Sources, 72 (1998), pp. 159-64), in order to allow the material to be processed in air as a dry powder. In use, once hydrogen generation begins, the hydrogen is initially consumed to reduce a protective oxide on the surface of the powder, which keeps it from otherwise oxidizing in contact with air. Accordingly, when such a material is used in the on-demand hydrogen generation device of the present disclosure, it is to be noted that the activity of the positive electrode, and therefore hydrogen gas production, may generally improves with time (e.g., for the first several minutes upon initial use).

As noted above, the positive electrode assembly includes a conductive substrate, which may also be referred to in the art as a current collector. The conductive substrate generally includes thereon or therein a positive electrode, or catalyst, material for interacting with the anode active agent and electrolyte to produce hydrogen in the on-demand hydrogen gas generation device upon activation. The conductive substrate may be in the form of a metal screen, an expanded metal, a metal foam, carbon cloth, carbon paper, or a non-woven mat material. In order to minimize inactive materials (hence maximize energy density), it may be beneficial to choose a conductive substrate material that is also a good catalyst for hydrogen generation, thereby becoming a dual-purpose component. The conductive substrate may, for example, be a nickel or iron screen, a nickel or iron metal foam. The substrate may also comprise a carbon material such as carbon cloth or fabric. The conductive substrate may also provide integrity and strength to the gas management electrode and, in some embodiments, may act as a catalyst to facilitate the production of hydrogen (as detailed elsewhere herein).

It has been determined that the physical structure of the catalyst layer is an important determinant of the effectiveness of the gas management electrode. As such, in addition to the electrochemical activity and distribution of the catalyst itself, the porosity and hydrophobicity of the structure are important variables. In a desired embodiment, the catalyst layer contains a mixture of a catalyst support, one or more hydrogen generation catalysts, and a polymeric binder/water-proofing agent like polytetrafluorethylene (PTFE).

The hydrogen generation reaction within the electrode structure involves a three-dimensional solid/liquid/gas interface requiring diffusion of liquid to the catalyst surface/site, electrochemical reaction at the surface with generation of the gas and transport of the gaseous product away from the reaction site. At high gas generation rates (high current densities), mass transport becomes dominant, where transport of electrolyte to the reaction zone and gas transport away from the sites are critical for sustained gas generation and supply. Poor mass transport, which can be caused by low porosity or excessive hydrophobicity (too high a PTFE binder content) can significantly increase polarization and the electrode will no longer sustain the current, resulting in a significant drop in hydrogen generation rates. Due to the need for a good gas/liquid/solid interface for sustained gas generation, it is important to have a good three-dimensional hydrophobic/hydrophilic balance within the electrode. Hydrophilicity is required to bring the water based electrolyte to the reaction site and to wet the catalyst surface. Hydrophobicity is required to facilitate efficient separation and transport of the generated gas from the liquid with minimal foaming and entrainment of liquid. Hence a porous, partially hydrophobic structure is important for effective hydrogen generation and transport, particularly at high current densities. Hydrophobicity may be obtained partly from the inherent property of the catalyst support (e.g. carbon which may have organic surface groups present), and partly from hydrophobic additives such as PTFE (which also serves as a binder to keep particles together), which must be well distributed in the structure. This can be achieved by adjusting the quantity of PTFE and by adjusting the processing conditions to provide good distribution and fibrillation of the PTFE to develop a porous, 3-dimensional partially hydrophobic structure as is well known to one skilled in the art, particularly in the development of air cathodes. The hydrophobic binder content can range from about 0.5% (of the total weight of the catalyst+support+binder) to about 20% by weight. Since effective transport of generated gas from the reaction zone is an important property of the structure, it may be beneficial in some embodiments to have a catalyst layer that has increasing hydrophobicity in the direction away from the reaction zone and in the direction of the gas exit. One means to achieve this type of increasing hydrophobicity is to laminate multiple layers together, with each successive layer having increasing hydrophobic additive content. In such cases, depending on the layer in question, the hydrophobic binder content can vary from about 0.5% to about 20% in the layer closest to the reaction zone and from about 50% to about 100% in the layer farthest from the reaction layer.

The entire electrode structure must also have high electronic conductivity to ensure effective collection of the current, without which the ohmic resistance of the electrode will be too high, resulting in an undesirable voltage drop. The catalyst layer can be adhered or laminated to the current collector using a variety of methods known in the art such as pressure, adhesives, heat, or combinations thereof. To effectively separate the gas from the liquid a gas permeable, liquid impermeable hydrophobic layer may be laminated or adhered to one surface of the catalyst layer using similar means. The thickness of the catalyst layer excluding the current collecting substrate can range from about 0.01 mm to about 2 mm, from about 0.1 mm to about 1 mm, from about 0.2 mm to about 0.5 mm. The current collector thickness may range from about 0.02 mm to about 1 mm, or from about 0.05 mm to about 0.5 mm, or desirably from about 0.1 mm to about 0.25 mm.

In addition to the catalyst, the positive electrode assembly may include thereon one or more additive agents to improve the functionality and efficiency of the positive electrode. For example, the positive electrode assembly may include thereon carbon black, graphite, polyteterfluoroethylene, and mixtures thereof.

Porosity of the various gas permeable layers is important, as discussed elsewhere. One measure of permeability of a material is through the use of a Gurley Air permeability instrument (as disclosed for example in US Patent Application Publication No. 2006/0257728 A1, the entire of contents of which is incorporated herein by reference for all relevant and consistent purpose). Air permeability can be measured in Gurley seconds, as appreciated by one having ordinary skill in the art. Because the Gurley test measures the length of time necessary to pass a predetermined volume of air through a material, a longer time measurement is an indication of low air permeability. One skilled in the art will recognize that hydrogen permeability of the same material is expected to be higher, due to the smaller size of the hydrogen molecule. The lower the Gurley Number, the higher the permeability. The Air Permeability of the combination of catalyst layer, current collector and gas permeable (liquid impermeable) hydrophobic layers, of less than about 500 Gurley seconds, desirably less than about 200 seconds, most desirably less than about 100 seconds has been found suitable for use in the Gas Management electrode. Table B lists the Gurley Seconds (SG) for the various layers used to produce the Raney Nickel Gas Management electrode used in some of the examples discussed elsewhere. The Gurley measurement was taken using Model No. 4150N, commercially available from Gurley Precision Instruments (located in Troy, N.Y.), at a pressure drop of 12.2 inches of water to displace 10 cc air through a 0.1 sq. inch area.

TABLE B

| | Air | |
|---|---|---|
| | Permeability | |
| Component | (SG), sec | Description |
| Catalyst Layer w/ | 16 ± 1 | 75% Ni (Raney), 5% PTFE, w/ C |
| Current Collector | | painted screen |
| Single PTFE Layer | 2 ± 1 | Grade 600A, Plastomer |
| Catalyst Layer | 47 ± 3 | Laminator rolls set to 0.027″ Gap |
| laminated with | | |
| 2 layers of PTFE | | |

It is to be noted that optionally a conventional porous separator material may be disposed between the anode and the positive electrode or electrode assembly. This separator may be utilized to hold electrolyte and enhance the transport of water and ions between the anode and cathode and assist in the preventing inadvertent shorting of the device by particles of anode coming into contact with the positive electrode (or cathode) surface. Generally, this separator may be a hydrophilic separator made from a non-woven material such that it is both gas and liquid permeable. It is desirable that this separator is capable of swelling and stretching in order to accommodate changes in the device during hydrogen generation.

Referring again to FIGS. 1A and 1B, one end of the hydrogen gas generation means 22, generally denoted 40, is closed (i.e., sealed) by a second negative end cap 42 and a negative grommet seal 44. More specifically, this end (i.e., the negative end 40) of the hydrogen gas generation means is closed by sealingly connecting the second end cap 42 and grommet 44 to one end 40 of the cylindrical electrode assembly (by, for example, crimping the second end cap over the grommet and end of the positive electrode assembly). Similarly, the end generally opposite and disposed axially upstream of the negative end (i.e., the positive end) of the hydrogen gas generation means 22, generally denoted 46, is closed (i.e., sealed) by a positive end cap 48 and a positive grommet seal 50, this end being closed by sealingly connecting the positive end cap and grommet to the end of the positive electrode assembly (by, for example, crimping the positive end cap over the grommet and end of the positive electrode assembly). Additionally, present between the positive grommet and the anode is a bottom separator cup 52, which acts to prevent contact between anode particles and the positive electrode end-cap which can result in an electrical short circuit of the cell.

The hydrogen gas generation means, 22, present within the can 12 is held in place therein, at least in part by means of a positive connection tab 54, which is present between the positive end cap 48 of the hydrogen gas generation means and the positive, or vented, end 14 of the can 12 and portion of the sidewall 19 of the can proximate thereto. Additionally, the positive connective tab 54 acts to electrically connect the positive electrode (or more generally the positive electrode assembly 28) to the positive outer can 12. The connective tab 54 generally conforms to the shape and dimensions of the positive end cap 48 of the hydrogen gas generation means 22, as well as the positive end 14 and the portion of the sidewall 19 of the can 12 that is proximate thereto, in order to form a physical and electrical contact therebetween (i.e., between the positive end cap 48 and the positive end 14 and sidewall 19 of can 12). Accordingly, the connective tab 54 is prepared from a material that is (i) sufficiently conductive, in order to create a sufficient electrical contact between the can 12 and the positive end cap 48 of the hydrogen gas generation means 22, thus allowing a low resistance circuit to be completed between the anode 24 and positive electrode assembly 28 of the hydrogen gas generation means (as further detailed elsewhere herein), and (ii) sufficiently flexible or elastic, in order to conform to the positive end cap 48 of the hydrogen gas generation means, as well as the positive end 14 of the can 12 and the portion of sidewall 19 proximate thereto. The connective tab 54 is desirably a strip of conductor (e.g., a strip of nickel 200 which is about 0.125 inch wide by 0.007 inch thick) and is either physically offset from the vent hole or sufficiently perforated to allow gas, particularly hydrogen gas to pass therethrough and out of the hydrogen gas vent 16 (for consumption by a fuel cell connected thereto). This positive tab connection 54 does not necessarily cover the entire circumference of the positive end. Exemplary materials suitable for use for the connective tab 54 include, for example, a nickel foam, copper, brass, plated steel (plated for example with copper, tin, silver, nickel), or a nickel 200 strip (e.g., a 0.125 inch wide by 0.007 inch thick strip of nickel 200, such as for example when the hydrogen gas generation means is configured to have dimensions similar to a AAA cell and/or the on-demand hydrogen gas generation device is configured to have dimensions similar to a AA cell).

Additionally, the hydrogen gas generation means 22 is held in place within the can 12 by means of an insulating wrap 55, which is present between the second negative end cap 42 (of the hydrogen gas generation means 22), and the portion of the sidewall 19 of the can proximate the negative end 18 thereof. More particularly, the insulating wrap 55 generally conforms to the shape and dimensions of the second negative end cap 42 of the hydrogen gas generation means 22, as well as the portion of the sidewall 19 of the can 12 that is proximate the negative end thereof, in order to form an insulated, physical contact therebetween (i.e., an insulated physical contact between the second negative end cap 42 and the portion of the sidewall 19 near the negative end of the can 12). Accordingly, the insulating wrap 55 is prepared from a material that is (i) sufficiently insulating, in order to create a physical but nonconductive contact between the sidewall 19 of the can 12 and the second negative end cap 42 of the hydrogen gas generation means 22, and (ii) sufficiently flexible or elastic, in order to conform to the second negative end cap 42, as well as the negative end 18 of the can 12 and the portion of sidewall 19 proximate thereto. Additionally, the insulating wrap 55 is sufficiently porous or prepared from a material that is sufficiently gas permeable, and more particularly permeable to hydrogen, or is configured to allow hydrogen gas, formed by the hydrogen gas generation means, to pass therethrough and exert pressure on a pressure responsive switching mechanism (which may also be referred to herein as a hydrogen gas generation control), generally indicated at 56, which is further detailed elsewhere herein.

Alternatively, the hydrogen gas generation means 22 is insulated from the can 12 by means of an insulating wrap 55, which is present between the second negative end cap 42 (of the hydrogen gas generation means 22), and the portion of the sidewall 19 of the can proximate the negative end 18 thereof. More particularly, the insulating wrap 55 generally conforms to the shape and dimensions of the second negative end cap 42 of the hydrogen gas generation means 22, and is spaced from the portion of the sidewall 19 of the can 12 that is proximate the negative end thereof, in order to form an insulated, loose physical contact therebetween (i.e., an insulated physical contact between the second negative end cap 42 and the portion of the sidewall 19 near the negative end of the can 12 that is loose enough to allow hydrogen gas to pass therethrough). Accordingly, the insulating wrap 55 is prepared from a material that is (i) sufficiently insulating, in order to create a nonconductive contact between the sidewall 19 of the can 12 and the second negative end cap 42 of the hydrogen gas generation means 22, and (ii) sufficiently flexible or elastic, in order to conform to the second negative end cap 42. Additionally, the insulating wrap 55 is configured to allow hydrogen gas, formed by the hydrogen gas generation means, to pass therethrough and exert pressure on a pressure responsive switching mechanism (which may also be referred to herein as a hydrogen gas generation control), generally indicated at 56, which is further detailed elsewhere herein. Exemplary materials suitable for use for the insulating wrap 55 therefore include, for example, adhesive-backed PVC shrink film, shrink tubing, electrical tape, etc.

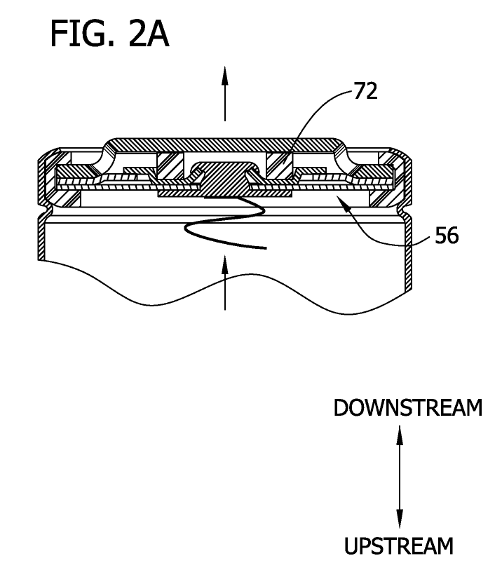

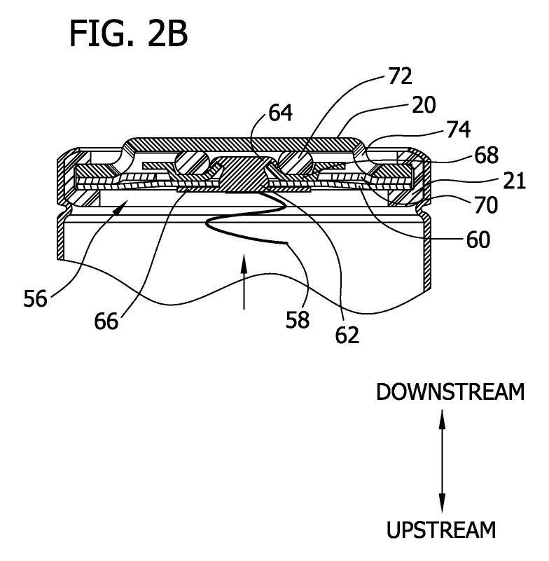

Referring now to FIGS. 2A and 2B, and again to FIG. 1A, the pressure responsive switching mechanism, generally indicated at 56, is present within the can 12 and is physically or mechanically, as well as electrically, connected to both the second negative end cap 42 of the hydrogen gas generation means 22 (by means of for example an electrically conductive connection tab 58) and the first negative end cap 20 of the can. The pressure responsive switching mechanism 56 is adapted in size and shape such that it fits securely in the negative end 18 of can 12, and is sealingly connected thereto as well as to the first negative end cap 20 (by, for example, crimping the negative end of the can over the end cap, the switching mechanism and a flexible, electrically insulating seal or gasket 21, which may or may not be integrated with the switching mechanism itself) during assembly, by means generally known in the art. More particularly, the switching mechanism comprises a moveable (e.g., flexible) member or diaphragm 60, which extends inward (e.g., radially inward) from the can 12, or more particularly the gasket 21. The moveable member has an opening (e.g., centrally located opening, the moveable member having a circular washer-like design in the illustrated embodiment) that has a conductive connector 62 therein that is spool-like or rivet-like in shape. The movable member 60 in this particular embodiment is electrically non-conductive (an additional electrical insulation component may therefore be required to enable use of a conductive movable member in this embodiment). The connector has a pair of oppositely disposed radially extending outer flanges 64 and 66, the flange which faces the second negative end cap 42 being mechanically and electrically connected thereto by means of the connective tab 58. The connector 62 is sized to fit securely in the opening of the moveable member 60, such that the connector moves in concert with the moveable member.

The switching mechanism 56 additionally comprises a first conductive contact 68, which is annular in shape and which also has an opening (e.g., centrally located opening, which like the moveable member gives the first conductive contact a washer-like design, and in the illustrated embodiment may be a metal washer, for example). The upper surface of the first conductive contact 68 is in mechanical and electrical contact with the upper flange 64 of the connector 62, while the lower surface is in mechanical (and optionally electrical) contact with the upper surface of the moveable member. In the illustrated embodiment, the first conductive contact 68 surrounds the upper flange 64 of the connector 62 and is annular in shape, the contact extending outwardly from the connector 68 toward the sidewall 19 of the can 12, and/or the first negative end cap 20. Additionally, the first conductive contact is sized and shaped, and/or positioned within the switching mechanism, so as to move in concert with the moveable member and/or the conductive connector 62.

The switching mechanism 56 additionally comprises a second conductive contact 70, which in the illustrated embodiment is also annular in shape and which also has an opening (e.g., centrally located opening, which like the moveable member gives and the first conductive contact gives the second conductive contact a washer-like design, and in the illustrated embodiment may be a metal washer, for example). The second conductive contact 70 surrounds the upper flange 64 of the connector 62, but is not in direct contact therewith. Rather, the upper surface of the second conductive contact 70 is in mechanical and electrical contact with the lower surface of the first negative end cap 20, and in removable electrical and mechanical contact with the lower surface of the first conductive contact 68 (as further detailed elsewhere herein). Additionally, the second conductive contact is sized and shaped, and/or positioned within the switching mechanism, so as to be immovable (or have a fixed position) relative to the first conductive contact and/or the moveable member.

Finally, the switching mechanism 56 may optionally comprise a spring or springs 72 that act, in concert with the flexible member 60, to determine the pressure differential at which the switching mechanism operates (i.e., move downstream, to fully or partially open the switching mechanism, or upstream, to fully or partially close the switching mechanism, as further detailed elsewhere herein). In the illustrated embodiment, an annular spring 72, which surrounds the upper flange 64 of the connector 58, is in contact with upper surface of the first conductive element and the lower surface of the first negative end cap 20.

The switching mechanism 56 of the on-demand hydrogen gas generation device of the present disclosure may be initially constructed to be in a substantially closed position. As a result, an electrical and physical contact is present between the first negative end cap 20 and the second negative end cap 42, and thus the anode 24, of the hydrogen gas generation means 22, through the switching mechanism. However, there is essentially no hydrogen gas generation by the hydrogen gas generation means 22 until an electrical circuit is completed between the cylindrical positive electrode assembly 28 and the anode 24 of the hydrogen gas generation means, by means of an external circuit (not shown) which links or connects the first negative end cap 20 with the positive end 14 of the can 12, thereby allowing current to flow through the galvanic cell (between the anode 24 and the positive electrode assembly 28), in order to initiate the galvanic cell corrosion reaction there. Once the external circuit has been closed (by, for example, inserting the on-demand hydrogen gas generation device into a fuel cell, which contains a means for completing the external circuit between the negative end cap 20 and the positive end 14 of can 12), hydrogen gas will begin to form in, and be evolved from, the hydrogen gas generation means 22. More specifically, with respect to FIG. 1A, it is to be noted that hydrogen gas formed at the positive electrode 32 passes through the gas permeable membrane 38 into a space 39, which is present between the positive electrode assembly 28 and the can 12. As this space is filled, a pressure differential is eventually created proximate the switching mechanism 56, while at the opposite end of the device hydrogen gas is allowed to exit space 39 for consumption by a fuel cell (not shown).

As further illustrated in FIGS. 2A and 2B, in operation or use, the switching mechanism 56 responds to a pressure differential that results from, in the illustrated embodiment, the pressure on the side of the switching mechanism facing the hydrogen gas generation means 22 increasing (as a result of hydrogen gas generation) relative to the pressure on the opposite side of thereof (i.e., the side of the switching mechanism facing the first end cap 20), which is essentially designed to remain at about atmospheric pressure (due, for example, to the vent hole 74 present in the first negative end cap). More particularly, as further detailed elsewhere herein, when this pressure differential is below a predetermined value, the moveable member 60 is essentially at rest; that is, there is insufficient force being applied thereto by the pressure on the hydrogen gas generation means side thereof, relative to the opposite side thereof, and therefore it has essentially not moved (e.g., flexed) downstream from its initial (i.e., fully closed) position. However, as the hydrogen gas generation means continues to form or evolve hydrogen gas, pressure on one side (i.e., the upstream side) of the switching mechanism, and more particularly the moveable member 60 thereof, increases and therefore the pressure differential increases, as well. Once this pressure differential is sufficiently high (i.e., reaches a predetermined threshold value of less than 30 psig), the moveable member deforms and moves downstream, thus moving from a first (e.g., closed) position to a second (e.g., partially or fully open) position.

As the switching mechanism opens, or more particularly the moveable member deforms or moves downstream, the spring 72 (when present) is compressed, and the connector 58 and the first conductive contact 68 are also moved downstream in concert with the moveable member. This movement acts to increase the resistance in the switching mechanism to the electrical current passing therethrough, by means of lessening the physical and electrical contact between the first conductive contact 68 and the second conductive contact 70. As a result, the rate at which hydrogen gas is formed and evolved from the hydrogen gas generation means decreases, which in turn decreases the rate at which the pressure differential is increasing. If the pressure differential becomes sufficiently high, the physical and electrical contact between the first and second conductive contacts is essentially eliminated, thus halting the flow of electrical current therethrough (i.e., the resistance is sufficiently high to stop the flow of electrical current therethrough). The switching mechanism is therefore effectively in the fully open position, thus halting the flow of electrical current therethrough and the formation or evolution of hydrogen gas associated therewith.

Although the rate of hydrogen gas formation is decreased, or stopped, hydrogen gas will continue to be consumed as long as the fuel cell, to which the on-demand hydrogen gas generation device is attached or connected, is active or in operation. As a result, the pressure differential will naturally decrease over time. Once the pressure differential is sufficiently low, the switching mechanism, and more particularly the moveable member, will move upstream (due to the natural flexibility of the moveable member alone, or in combination the natural flexibility of the spring 72 which is in contact with, and exerting upstream or downward pressure on the first conductive element 68, or more generally the moveable member 60) and re-establish, or more fully establish, contact between the first and second conductive contacts. Hydrogen gas formation will then begin once again, or the rate of hydrogen gas formation will increase. This downstream and upstream movement of the moveable member will continue as long as (i) the on-demand hydrogen gas generation device remains activated (i.e., in use), and (ii) there is fuel for consumption in the reaction that forms the hydrogen gas. As a result, the hydrogen gas generation device of the present disclosure, and more particularly the switching mechanism thereof, is designed to be operable to provide an on-demand flow of hydrogen gas that is substantially constant when the device is activated. Stated another way, the switching mechanism, and more particularly the moveable member thereof, is designed to repeated or reversibly move downstream or upstream as the pressure differential increases above or decreases below, respectively, a predetermined value. As a result, as detailed elsewhere herein, the on-demand hydrogen gas generation device may produce or emit a flow of hydrogen gas at an average rate of at least about 0.1 cubic centimeters/minute/cubic centimeters of fuel volume, or more for a period of time of, for example, at least about 1 hour (and which may optionally remain substantially constant for this period of time).

It is to be noted that the repeated or reversible movement of the switching mechanism, or more particularly the moveable member, will continue in response to the pressure differential resulting from hydrogen gas generation until, for example, (i) the fuel, from which the hydrogen gas is formed, is essentially completely consumed, and/or (ii) the switching mechanism becomes fully opened, thus essentially stopping all flow of electrical current therethrough, and remains in this position (e.g., the on-demand hydrogen gas generation device is turned off, or deactivated, in some way).

It is to be further noted that the design or configuration of the can which contains the hydrogen gas generation means, the hydrogen gas generation means, the switching mechanism, and any or all of the various components thereof, may be other than herein described without departing from the intended scope of the present disclosure. Accordingly, it is to be still further noted that the various embodiments provided in the figures presented herein are for purposes of illustration, and therefore should not be viewed in a limiting sense. For example, the moveable member may be constructed (by means generally known in the art) to itself serve as or comprise the means through which an electrical current passes between the anode and positive electrode, and thus serve as or comprise the means by which the anode and positive electrode of the hydrogen gas generation means are placed in removable electrical contact (i.e., the moveable member may be constructed, using means generally known in the art, to comprise, or serve as, the first conductive contact or the second conductive contact of the switching mechanism).

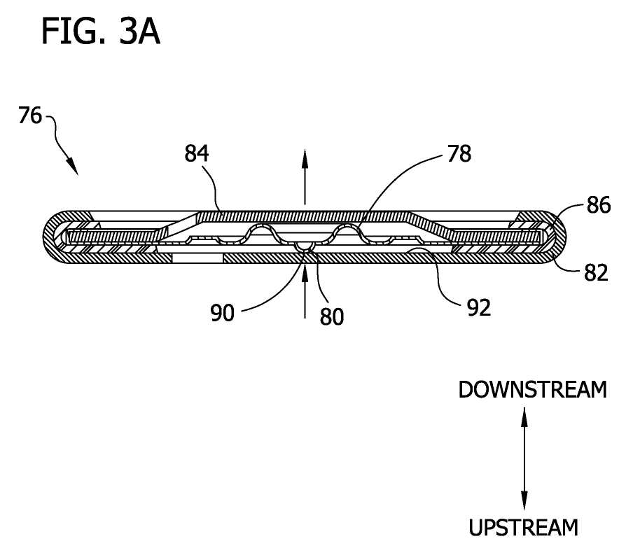

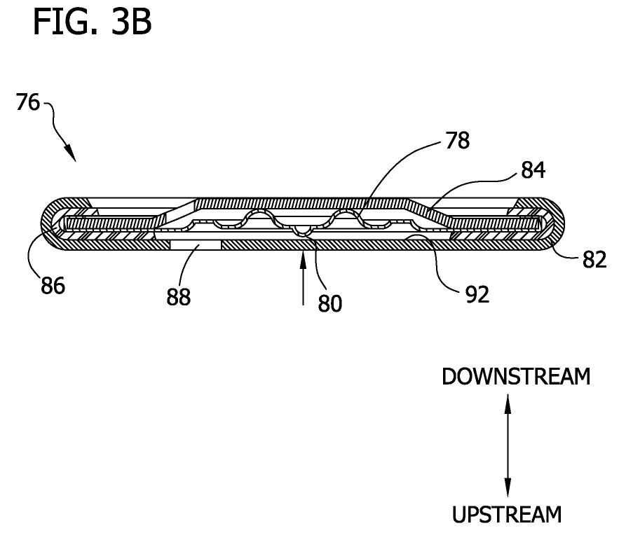

Referring now to FIGS. 3A and 3B, an alternative embodiment, and more particularly a low profile (e.g., low thickness) or stand-alone embodiment, of the switching mechanism (generally indicated at 76) of the present disclosure is provided, the switching mechanism for example being constructed to have dimensions (e.g., thickness) similar to or smaller than that of a button cell (e.g., a cell having, for example, a diameter of about 8 mm and a thickness of about 1.5 mm). In this embodiment, the moveable member 78 comprises a conductive material or a conductive coating (as detailed elsewhere herein), and therefore the electrical current may pass through the switching mechanism by means of the flexible member, rather than by the first and second conductive contacts (as illustrated in FIGS. 2A and 2B). In this particular embodiment, the moveable member 78 further comprises a point or nub 80 that is in removable mechanical and electrical contact with a metal outer can 82, which in turn is in electrical contact with the anode (not shown) of the hydrogen gas generation means through a connector (not shown); that is, the connector is in physical and electrical contact with both the anode and the outer can 82. As previously noted, the outer can 82 in the illustrated embodiment is button-like in shape, the open end thereof being closed by means of a negative end cap 84. The negative end cap is sized and shaped such that it and the end of the can are sealingly connected (by, for example, crimping the end of the can over the end cap, a flexible electrically insulating seal or gasket 86, and optionally the ends of the moveable member 60, by means generally known in the art).

The switching mechanism illustrated in FIGS. 3A and 3B is in communication with the hydrogen gas generation means, and operates in a manner similar to the switching mechanism detailed elsewhere herein. More specifically, the upstream side of the moveable member 78 is in communication with the hydrogen gas generation means by one or more vents 88, which are sealingly connected to said means. In operation, hydrogen gas, once formed, enters through vent 88 and exerts increasing pressure on the switching mechanism, or more specifically the moveable member thereof, a pressure differential being created as a result of the fact that the pressure on the opposite side of the moveable member is at about atmospheric pressure (a vent (not shown) in the end cap being optional for this purpose, as detailed in other embodiments illustrated elsewhere herein). Eventually, the pressure reaches a predetermined threshold (as detailed elsewhere herein), causing the moveable member to move or flex downstream and ultimately separate or break the contact interface 90 that exists between the point or nub 80 of the moveable member and the surface 92 of the can 82 facing the nub. This separation acts to increase the resistance to the electrical current passing through the switching mechanism, or more specifically the moveable member, which in turn acts to slow or stop the hydrogen gas formation. Once the pressure differential falls below this predetermined value, the moveable member moves or flexes upstream, eventually resulting in the re-establishment of the contact interface.

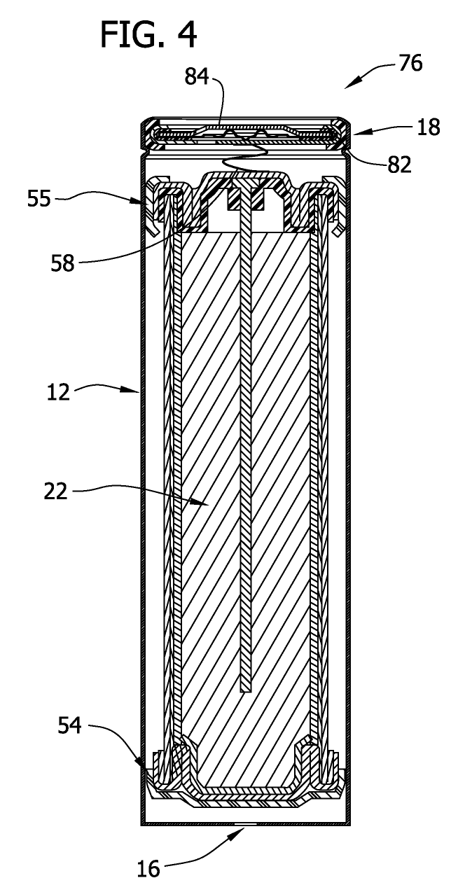

It is to be noted that the switching mechanism may be placed in communication with the hydrogen gas generation means using essentially any means generally known in the art. For example, as illustrated in FIG. 4, in one particular embodiment the entire switching mechanism 76 of FIGS. 3A and 3B may be used to replace the end cap 20 and switching mechanism 56 in the on-demand hydrogen gas generation device illustrated in FIG. 1A. More specifically, as illustrated in FIG. 4, the stand-alone switching mechanism illustrated in FIGS. 3A and 3B may be used with the hydrogen gas generation device illustrated in FIG. 1A, the switching mechanism 76 and/or can 12 being sized and shaped such that the switching mechanism is essentially inserted into the negative end 18 of the can and then the two are sealingly connected (by, for example, crimping the negative end 18 of the can 12 over the switching mechanism 76, a flexible electrically insulating seal or gasket (not shown) being optionally present therebetween, by means generally known in the art). In this embodiment, the electrically conductive connection tab 58 is physically and electrically connected to the side of the switching mechanism can 82 facing it.

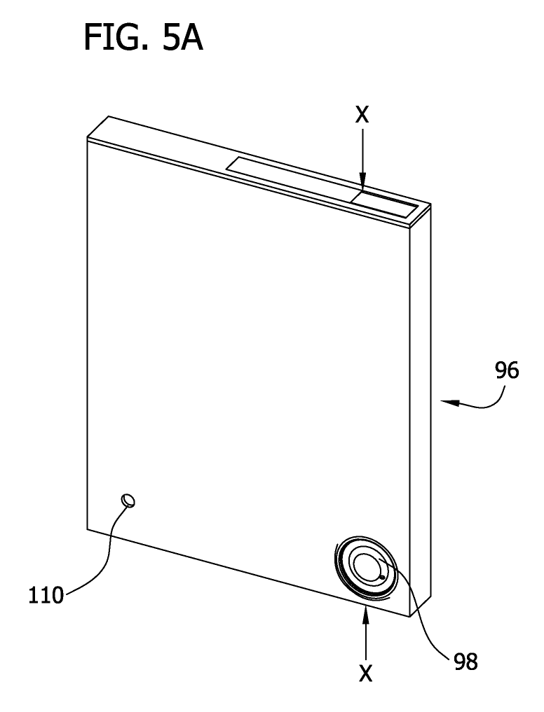

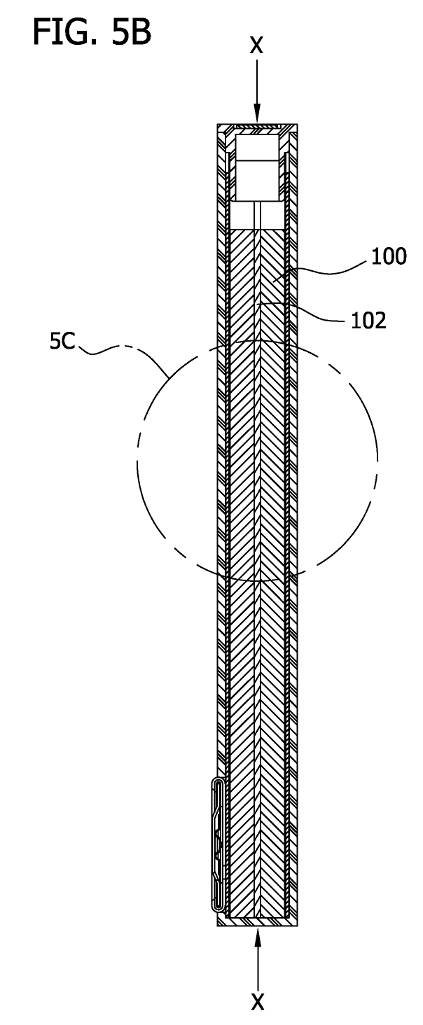

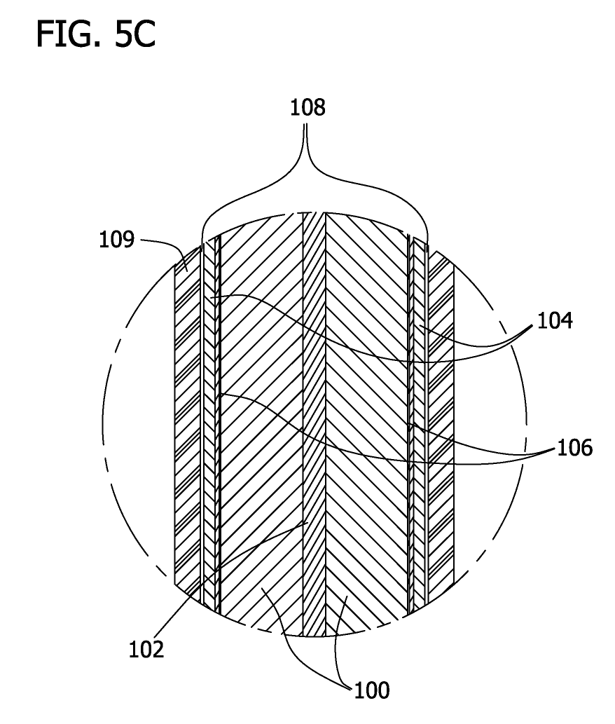

Yet another alternative embodiment of the on-demand hydrogen gas generation device is illustrated in FIGS. 5A, 5B and 5C. In this embodiment, the device, generally indicated at 96 has dimensions similar to those of a standard prismatic electrochemical cell, used for example in a cellular telephone. In this embodiment, the switching mechanism, generally indicated at 98, is constructed in a manner consistent with the embodiments detailed elsewhere herein, and in particular is constructed like the low-profile or stand-alone switching mechanism detailed above, with the exception that in this particular embodiment a connector (not shown) electrically connects the switching mechanism, or more particularly the moveable member thereof (in the case of the stand-alone or low-profile switching mechanism), to the positive electrode rather than the anode. As illustrated in greater detail in FIGS. 5B and 5C, the device comprises a hydrogen gas generation means, which in turn comprises an anode 100, an anode current collector 102 in physical and electrical contact therewith, a positive electrode 104 (or more generally a positive electrode assembly, as detailed elsewhere herein and referred to as a gas management electrode), and an optional separator 106 disposed between the anode and positive electrode. Additionally, the hydrogen gas generation means, or more generally the on-demand hydrogen gas generation device, comprises a space (e.g., a channel, passageway or chamber) 108, present between the positive electrode and the outer can 109 to which the hydrogen gas migrates or evolves after being formed at the positive electrode. This space is in sealing communication with the switching mechanism, the hydrogen gas present therein exerting pressure on the moveable member thereof as a pressure differential is created. As previously noted, when this pressure differential is sufficiently high to exceed a predetermined value, the moveable member moves downstream (in conformance with the direction of the pressure differential), resulting in the disruption in the flow of electrical current through the switching mechanism (and potentially completing stopping the flow of current, if the pressure differential becomes sufficiently great) and the slowing of the rate of hydrogen gas generation (if not essentially stopping hydrogen gas generation). As this pressure differential decreases (such as by the escape of the hydrogen gas that has been formed through a hydrogen gas vent or exit port, 110, which is in sealing communication with the fuel cell (not shown) by a passageway or conduit (not shown)), the moveable member moves upstream toward its original position, resulting in the reestablishment (or further establishment) of the flow of electrical current through the switching mechanism.

In this regard it is to be noted that, as indicated by the embodiment illustrated in FIGS. 5A through 5C, the switching mechanism may be in physical and electrical contact with either the anode or the positive electrode through, for example, a connective member. Accordingly, the switching mechanism may operate to disrupt the flow of electrical current between the anode and the positive electrode in either way, and therefore the illustrations provided herein which show the switching mechanism in physical and electrical communication with one particular electrode should not be viewed in a limiting sense.

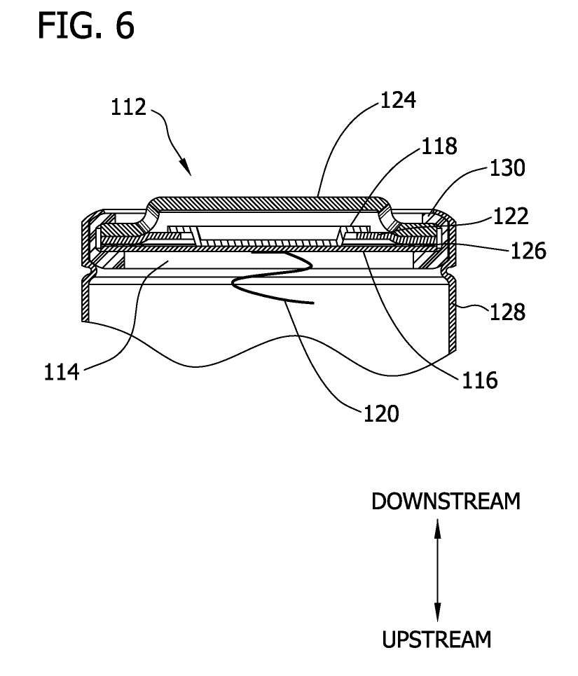

Yet another alternative embodiment of the on-demand hydrogen gas generation device is illustrated in FIG. 6. In this embodiment, the device, generally indicated at 112, comprises a switching mechanism, generally indicated at 114. The switching mechanism comprises a moveable member, 116, that is metal and that is in physical and electrical contact with the hydrogen gas generation means (either the anode or positive electrode thereof, not shown) through a conductive tab 120 (which is in physical and electrical contact with the hydrogen gas generation means). The switching mechanism further comprises a first conductive contact 118, which is in physical and electrical contact with the moveable member 116. The first conductive contact 118 is in removable physical and electrical contact with a second conductive contact 122. One side (i.e., the downstream side) of the second conductive contact 122 is in physical and electrical contact with the first negative end cap 124, while the other side (i.e., the upstream side) thereof is in physical contact with an insulator 126 (e.g., a plastic insulator) that physically and electrically isolates the second conductive contact from the moveable member 116. The switching mechanism (i.e., the moveable member, the first and second conductive contacts, and the insulator), as well as the end cap, are sized and shaped such that they, and the end of the outer can 128 are sealingly connected (by, for example, crimping the end of the can over the end cap, the moveable member, the insulator and the second conductive contact, as well as a flexible electrically insulating seal or gasket 130, by means generally known in the art).

It is to be noted that the devices detailed herein above, as well as the devices detailed elsewhere herein, may be directionally independent. Therefore, it is to be understood that upper and lower surfaces, the terms “downstream” and “upstream”, etc., are provided for purposes of illustration only.

It is to be further noted that the various gaskets, seals, insulating material, etc. present in the on-demand hydrogen gas generation device of the present disclosure may be made from essentially any material that possesses the desired properties (e.g., chemical stability, flexibility or elasticity, insulating or non-conductive properties, etc.).

C. Chemical Hydride

As noted and discussed above, galvanic corrosion is one chemical reaction method that can be utilized in the on-demand hydrogen gas generation device to produce hydrogen gas. In an alternative embodiment of the present disclosure, hydrogen gas can be produced in the on-demand hydrogen gas generation device by reacting water, or more generally an aqueous solution, and a chemical hydride (e.g., a complex chemical hydride). Utilizing a chemical hydride may be advantageous in certain embodiments where the production of hydrogen is required over an extended period of time as the chemical hydride has a high energy and hydrogen density as compared to water, which is the hydrogen source in galvanic corrosion. The mixing of water, or an aqueous solution, and the complex chemical hydride sodium borohydride results in the production of hydrogen according to the following reaction:

NaBH₄+4H₂O--->NaB(OH)₄+4H₂ (gas).

As such, each mole of sodium borohydride produces 4 moles of hydrogen. This is an efficient method of producing a large volume of hydrogen from a compact energy source. As would be recognized by one skilled in the art based on the disclosure herein, to control the hydrogen generation, the chemical hydride and water (or an aqueous solution) are kept separate and only mixed together on-demand and only in the predetermined amounts.

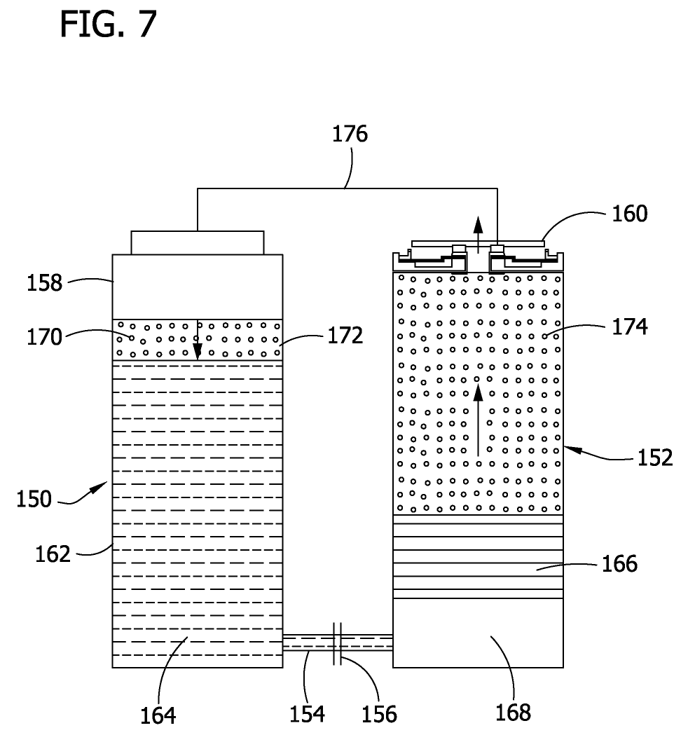

One embodiment for producing hydrogen utilizing a chemical hydride in the on-demand hydrogen gas generation device is illustrated in FIG. 7. FIG. 7 illustrates a first container 150 and a second container 152 that are connected via conduit 154 having check valve 156 to allow for the flow of a liquid in one direction only from container 150 into container 152. The first container 150 includes a gas-generating electrochemical cell 158 in electrical communication via wire 176 with a switching mechanism 160 and a first chamber 162 including an aqueous solution 164. The second container includes the switching mechanism 160, a chemical hydride 166 and reaction zone 168. A gas 170 is produced in gaseous production area 172 by the gas-generating electrochemical cell 158 and hydrogen gas 174 is produced in the reaction zone 168 by the mixing of the complex chemical hydride 166 and aqueous solution 164.

When the electrical circuit is closed and the switching mechanism 160 is in electrical communication with the gas-generating electrochemical cell 158, the latter produces a gas 170, such as hydrogen, that pressurizes the first chamber 162 which contains the aqueous solution 164. The pressurization forces the aqueous solution 164 through the conduit 154 and check valve 156 and into the reaction zone 168 where the aqueous solution 164 can react with the chemical hydride 166. Upon this reaction occurring, hydrogen gas 174 is formed and can exit the second container 152 through the switching mechanism 160. So long as the pressure in the second container 152 remains below a specified value, the switching mechanism 160 maintains the electrical connection with the gas-generating electrochemical cell 158 so that further gas 170 is produced which continues to force aqueous solution 164 through check valve 156 into reaction zone 168. In that way, hydrogen is production by reaction of the aqueous solution 164 with the complex chemical hydride 166 is maintained. Once the pressure in the second container 152 reaches a specified value, the switch closes and no further gas 170 is produced as the electrical communication between the switching mechanism 160 and the gas-generating electrochemical cell 158 is interrupted. This reduces the pressure in the first chamber 162. Consequently, aqueous solution 164 is no longer forced through check valve 156 into reaction zone 168. In that way, hydrogen production by reaction of the aqueous solution 164 with the complex chemical hydride 166 in reaction zone 168 ceases (one the aqueous solution already present has reacted).

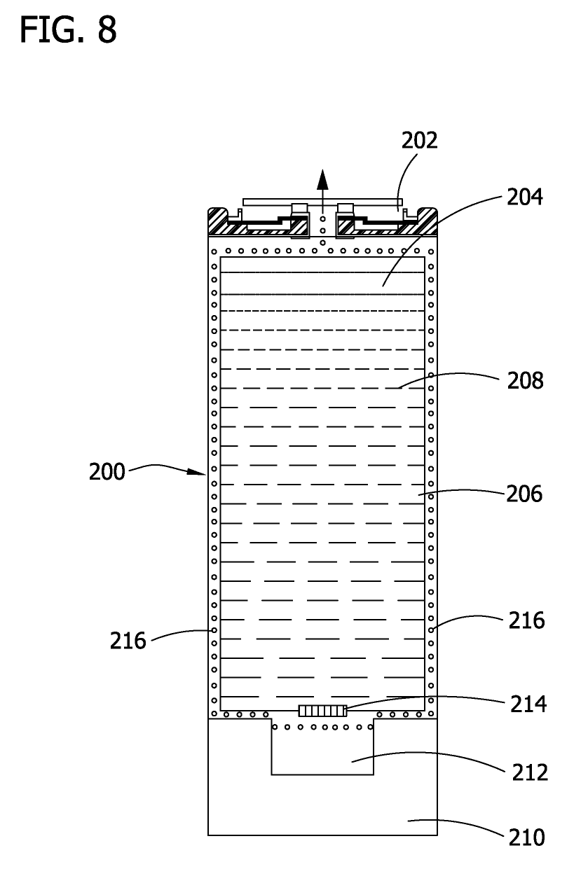

In an alternative embodiment of the present disclosure, a chemical hydride can be utilized to produce hydrogen and all of the required components and chambers can be incorporated into a single unit. Referring now to FIG. 8, there is illustrated a single unit on-demand hydrogen gas generation device 200 including a switching mechanism 202 in electrical communication with gas-generating electrochemical cell 204. Device 200 further includes a first chamber 206 that contains aqueous solution 208 and check valve 214, a chemical hydride 210, and reaction zone 212.

When the electrical circuit is closed and the switching mechanism 202 is in electrical communication with the gas-generating electrochemical cell 204, the gas-generating electrochemical cell 204 produces a gas (not shown), such as hydrogen, that creates pressure against the aqueous solution 208. The pressurization forces the aqueous solution 208 through the check valve 214 and into the reaction zone 212 where the aqueous solution 208 can react with the chemical hydride 210. Upon this reaction occurring, hydrogen gas 216 is formed and can exit the switching mechanism 202. So long as electrical connection between the gas-generating electrochemical cell 204 and the switching mechanism 202 is maintained, further gas is produced which continues to force aqueous solution 208 through check valve 214 into the reaction zone 212. In that way, hydrogen 216 production by reaction of the aqueous solution 208 with the complex chemical hydride 210 is maintained. Once the electrical communication between the switching mechanism 202 and the gas-generating electrochemical cell 204 is interrupted, gas production is stopped. This reduces the pressure in chamber 206. Consequently, aqueous solution 208 is no longer forced through check valve 214 into reaction zone 212. In that way, hydrogen production by reaction of the aqueous solution 208 with the complex chemical hydride 210 in reaction zone 212 ceases (once the aqueous solution already present has reacted).

The gas-generating electrochemical cell is utilized to produce a gas upon-demand (that is, when the gas-generating electrochemical cell is in electrical communication with the switching mechanism and the switch is closed allowing for electrical contact between the gas-generating electrochemical cell and the switching mechanism) to force an aqueous solution from one area of the on-demand hydrogen gas generation device to a second area of the on-demand hydrogen gas generation device where a chemical hydride is located. This gas-generating electrochemical cell can be any type of electrochemical cell that is capable of producing a gas upon-demand. For example, the gas-generating electrochemical cell (e.g., a zinc chloride or nickel-zinc cell) may utilize galvanic corrosion to produce a hydrogen gas to create pressure to force the movement of the aqueous solution. Several cell types capable of producing a gas may be utilized in accordance with the present disclosure. As an example, the gas-generating electrochemical cell may be a galvanic cell capable of producing hydrogen gas to force the movement of the aqueous solution where the electrolyte in the galvanic cell and the aqueous solution forced into the hydride gas-generating chamber comprises zinc chloride. The gas generating electrochemical cell may be self contained or it may be integrated with the first chamber and optionally utilize the aqueous solution as its electrolyte.

The gas-generating electrochemical cell may optionally include a gas management system as described herein to facilitate the movement or transport of gas from the gas-generating electrochemical cell to improve the efficiency of the pressurization required to pump the aqueous solution such that it can be brought in to contact with the chemical hydride.

The aqueous solution utilized to react with the chemical hydride can be at a neutral pH, acidic pH, or at a basic pH. In most embodiments, it is generally desirable to utilize an aqueous solution having a pH of less than 7, and more desirably less than about 5. By utilizing an aqueous solution having an acidic pH, any passivation present on the surface of the chemical hydride may be disrupted by the acid in the aqueous solution to allow for a more complete reaction of the chemical hydride with the aqueous solution.

Additionally, the aqueous solution utilized to react with the chemical hydride may be characterized by the water to chemical hydride (e.g., complex chemical hydride) molar ratio. In most embodiments, it is generally desirable to utilize an aqueous solution with a low water to chemical hydride ratio, and more desirably close to the stoichiometric molar ratio. By utilizing an aqueous solution with a low water to chemical hydride ratio, higher energy and hydrogen density as compared to an aqueous with a high water to complex chemical hydride can be achieved. For example, in order to achieve a high energy and hydrogen density with a zinc chloride electrolyte, in most embodiments it is desirable to use a water to chemical hydride molar ratio of less than about 20:1 (e.g., less than about 15:1, less than about 10:1 or even less than about 5:1). Utilizing an aqueous solution with a low pH (e.g., less than about 6, about 5 or even about 4), allows high hydrogen yields to be obtained at low water to chemical hydride ratios. Consequently, it may be desirable to use a water to chemical hydride ratio of less than about 10:1, for example, with an aqueous solution having a low pH.

As noted above, a chemical hydride is utilized to react with an aqueous solution to produce hydrogen for use in a fuel cell application. In general, many chemical hydrides known in the art are satisfactory for use in the on-demand hydrogen gas generation device. Some specific examples of suitable chemical hydrides include Al(BH₄)₃, LiBH₄, LiAlH₂(BH₄)₂, Mg(BH₄)₂, Ti(BH₄)₃, Fe(BH₄)₃, Ca(BH₄)₂, NaBH₄, KBH₄, LiAlH₄, Mg(AlH₄)₂, Ti(AlH₄)₄, Zr(BH₄)₃, Mg(AlH₄)₂, NaAlH₄, LiH, CaH₂, H₃BNH₃ and combinations thereof. In one particular embodiment, however, the chemical hydride is a complex chemical hydride (such as, for example, a hydride selected from Al(BH₄)₃, LiBH₄, LiAlH₂(BH₄)₂, Mg(BH₄)₂, Ti(BH₄)₃, Fe(BH₄)₃, Ca(BH₄)₂, NaBH₄, KBH₄, LiAlH₄, Mg(AlH₄)₂, Ti(AlH₄)₄, Zr(BH₄)₃, Mg(AlH₄)₂, NaAlH₄, H₃BNH₃ and combinations thereof). The chemical hydride can be present in the on-demand hydrogen gas generation device as a solid, slurry, or stabilized solution (e.g., in combination with a stabilized hydrate of an appropriate metal borate). It is generally desirable to have the chemical hydride present as solid or slurry.

The on-demand hydrogen gas generation device utilizing a chemical hydride hydrogen source may be a compact device that is capable of providing a large stream of hydrogen gas upon activation over a prolonged period of time. In some embodiments of the present disclosure, the on-demand hydrogen gas generation device utilizing a chemical hydride is capable of providing an average of at least about 0.1 cubic centimeters/minute/cubic centimeter of fuel volume. In some embodiments of the present disclosure, the on-demand hydrogen gas generation device utilizing a chemical hydride is capable of providing an average of from about 0.1 cubic centimeters/minute/cubic centimeter of fuel volume to about 1.5 cubic centimeter/minute/cubic centimeter of fuel volume, and desirably an average of about 1.0 cubic centimeter/minute/cubic centimeter of fuel volume (over a defined period of time, as detailed elsewhere herein).

In one embodiment of the present disclosure, the on-demand hydrogen gas generation device utilizing a chemical hydride is capable of producing hydrogen having a water content of less than about 1000 ppm. Desirably, the device is capable of producing hydrogen having a water content of less than about 500 ppm, desirably less than about 200 ppm, desirably less than about 100 ppm, still more desirably less than about 50 ppm and still more desirably less than about 10 ppm.

The on-demand hydrogen generation device utilizing a chemical hydride is substantially orientation independent. The device can produce substantially the same amount of hydrogen upon activation regardless of the orientation of the device. This is significant as it enables the device to be used in almost any application regardless of orientation.

D. Gas Management System

The present disclosure is further directed to an on-demand hydrogen gas generation device, such as for example one of the cells detailed above or elsewhere herein, that includes a gas management system for producing hydrogen and efficiently transporting the substantially dry hydrogen gas out of the on-demand hydrogen device. The gas management system is generally desirable when hydrogen is being produced by the on-demand hydrogen gas generation device by galvanic corrosion as described herein. The gas management system facilitates the efficient movement or transport of hydrogen out of the region wherein the hydrogen is produced and into a region wherein it can be used as fuel in a fuel cell. The gas management system also allows the hydrogen being produced in the on-demand hydrogen gas generation device to be produced with relatively low humidity or water content, which keeps the device from prematurely drying out due to water loss. Additionally, this can be advantageous in fuel cell systems that benefit from the use of dry hydrogen. As discussed in more detail herein, the gas management system renders the on-demand hydrogen gas generation device substantially orientation independent; that is, the on-demand hydrogen generation device produces hydrogen at substantially the same rate regardless of its orientation. This is a significant advantage as many of the current means for supplying fuel to fuel cell systems are not orientation independent.

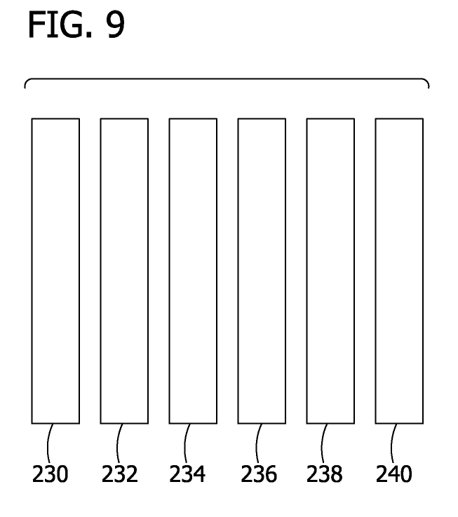

The gas management system may include a number of components and/or layers to facilitate the efficient transporting of hydrogen gas out of the on-demand hydrogen gas generation device upon production. Referring now to FIG. 9, wherein various components or layers are not drawn to scale with respect to other components or layers, there is illustrated an exploded view of one embodiment of a gas management system in accordance with the present disclosure that includes anode 230, optional separator 232 disposed between anode 230 and a gas impermeable and liquid permeable hydrophilic layer 234, a conductive substrate 236 disposed between the gas impermeable and liquid permeable hydrophilic layer 234 and a catalyst layer 238, and a gas permeable liquid impermeable hydrophobic layer 240 disposed adjacent the catalyst layer 238. The conductive substrate, catalyst layer, gas impermeable and liquid permeable hydrophilic layer and gas permeable and liquid impermeable hydrophobic layer may be collectively referred to herein as the “gas management electrode” or “gas management positive electrode.” As used herein, the term “impermeable” means substantially impermeable; that is, the term “impermeable” does not mean 100% impermeable in all situations or conditions. Instead, it is recognized that although there may be some pressure and/or temperature parameters wherein the material becomes permeable to some extent, at standard operating conditions for the device described herein, the material described as “impermeable” is substantially impermeable to either gas or liquid as described.

The gas management electrode may be comprised of multiple layers or components as illustrated in FIG. 9 that are discrete layers in intimate contact with each other; that is, layers that although touching and in intimate contact, can be physically separated into individual layers without substantial damage to neighboring layers. Alternatively, the gas management electrode may be comprised of a single integrated component; that is, the gas management layer may be comprised of a single component that is substantially indistinguishable into individual layers, even though each layer is physically present. In one embodiment, the gas management electrode has each individual layer laminated together to produce a laminated gas management electrode wherein the layers are physically indistinguishable. Additionally, the gas management electrode may be produced as a single integral component utilizing heat, pressure, adhesives, or a combination thereof. Utilizing a single integral component as the gas management electrode may simplify the manufacturing process for the on-demand hydrogen gas generation device, and may improve overall efficiency as a result. In some embodiments the conductive substrate 236 may be embedded in the catalyst layer or may be adhered to one surface of the catalyst layer. In some embodiments some of the layers can be coated or cast or sprayed on an adjacent layer. For example, the gas impermeable and liquid permeable hydrophilic layer 234 may be cast on the current collector/catalyst layer so as to produce a thin conformal layer. In still other embodiments, the catalyst layer with or without a hydrophobic binder, may be sprayed on to the conductive substrate. The gas permeable liquid impermeable hydrophobic layer 240 may be sprayed on to the surface of the catalyst layer in some embodiments. Additionally and alternately, a thin layer of tacky PTFE suspension (e.g., T 30 grade PTFE suspension from DuPont) may be sprayed on to the catalyst layer and a porous PTFE film is then adhered on to the tacky surface using means familiar to one skilled in the art, such as heat, pressure or a combination thereof.

As previously noted, the anode component of the gas management system provides the fuel (anode active agent) for the on-demand hydrogen gas generation device to produce hydrogen. In order to provide the necessary hydrogen production rate capability and discharge efficiency, the anode will generally be capable of sustaining a high discharge current without significant passivation of the anode active agent. As such, the anode is generally optimized for continuous discharge with high discharge currents, or for intermittent discharge with longer than one hour continuous discharge periods. Factors that influence the optimization of the anode for the specific purposes include, for example, anode active agent surface area, particle size, particle size distribution, amount of anode active agent, electrolyte concentration, and the nature and amount of gelling agents and surfactants. Generally, the anode is designed to contain the maximum amount of anode active agent that can be efficiently utilized since this fuel dictates how much hydrogen can be produced by the device.

The anode will generally include an anode active agent such as a metal or metals as the fuel for producing hydrogen. The anode active agent is desirably a metal having low thermodynamic nobility. Such metals include, for example, zinc, aluminum, magnesium, titanium, and combinations thereof. The amount of anode active agent generally included in the anode is less than about 80% by weight of the total weight of the anode components. The total weight of the anode components includes the weight of each component making up the anode such as, for example, anode active agent, gelling agent, surfactant alloying agent, electrolyte, etc. Desirably, the amount of anode active agent is from about 60% by weight to about 75% by weight, and more desirably from about 67% by weight to about 71% by weight. The anode active agent, such as zinc, can be present in the anode in the form of particles, flakes, fines, or dust, for example. Also, combinations of these forms may be utilized.

In some embodiments of the present disclosure, the anode of the on-demand hydrogen gas generation device may be prone to various undesirable corrosion reactions when stored at or above room temperature prior to use. The electrolyte in the anode may corrode the zinc (or other anode active agent) upon contact, forming oxidized zinc products that decrease the availability of active zinc while simultaneously generating unwanted gas. The rate of corrosion increases as the storage temperature rises and can lead to a dramatic decrease in anode active agent capacity. Gas generated in such reactions can increase pressure in the anode, cause electrolyte leakage and disrupt the device integrity. The rate at which the unwanted gas is generated at the anode active surface may accelerate when the anode active is partially utilized thereby decreasing the resistance of the anode to electrolyte leakage. The corrosion reactions that lead to gas evolution involve cathodic and anodic sites on the anode active surface. Such sites can include surface and bulk metal impurities, surface lattice features, grain boundary features, lattice defects, point defects, and inclusions.

To minimize undesirable corrosion and gassing during storage, it is typical to employ corrosion-resistant zinc alloys and to reduce the extent of impurities in the anode. For example, a suitable zinc powder (or other anode active) can be alloyed with one or more metals selected from indium, bismuth, calcium, aluminum, lead and phosphorous. A particularly desired alloying agent for minimizing gassing is bismuth. Typically, alloy powders can include from about 0.01% to about 0.5% by weight alloy agent alone, or in combination with, from about 0.005% to about 0.2% by weight of a second alloying agent such as lithium, calcium, aluminum, and the like.

The anode is typically and preferably a “gelled anode”. Along with the anode active and alloying agent (if any), the anode includes an electrolyte therein to provide water for the galvanic corrosion reaction near the gas management electrode and to facilitate ionic transfer between the anode and the gas management electrode. The electrolyte desirably has high ionic conductivity. Generally, the electrolyte is a potassium hydroxide or sodium hydroxide solution, but can also include other electrolytes known to those of ordinary skill in the art. In some cases, the electrolyte may contain dissolved salts, oxides or hydroxides of bismuth, tin, indium, mercury, lead, cadmium, or thallium. Additionally, the electrolyte may include a dissolved cation or anion of the metal anode (e.g., an aluminum oxide, sodium aluminate, potassium aluminate, a zinc oxide, a zinc hydroxide, or calcium salts.) In some embodiments, the electrolyte may additionally contain a corrosion inhibitor such as a quaternary ammonium salt, or a non-ionic, anionic, or cationic surfactant.

When potassium hydroxide is utilized as the electrolyte, the concentration of potassium hydroxide may be from about 15% by weight to about 45% by weight, and desirably from about 20% by weight to about 35% by weight. Generally, when zinc is the anode active agent, the electrolyte may include a small amount of zinc oxide to retard open circuit oxidation and stabilize the zinc surface and reduce gassing. The amount of zinc oxide may be from about 0.1% by weight of the anode to about 2% by weight of the anode.

The anode as described herein will generally include at least one gelling agent to help suspend the anode active material throughout the electrolyte to allow for the anode active to more fully react. Essentially any gelling agent known in the art, which is suitably or sufficiently compatible with the other components in the anode may be used in accordance with the present disclosure. Examples of suitable gelling agents include polyacrylic acids, grafted starch materials, salts of polyacrylic acids, polyacrylates, carboxymethylcellulose, or combinations thereof. Examples of suitable polyacrylic acids include Carbopol 940 and 934 (available from B.F. Goodrich) and Polygen 4P (available from 3V). An example of a grafted starch material is Waterlock A221 (available from Grain Processing Corporation). An example of a salt of a polyacrylic acid is Alcosorb G1 (available from Ciba Specialties). The gelling agent amount can range from about 0.1% to about 1% of the total mass of the anode.

To further minimize undesirable corrosion and gassing during storage as described above, it is typical to add organic surfactants and inorganic corrosion-inhibiting agents to the anode. Surfactants act at the anode-electrolyte interface by forming a hydrophobic film that protects the anode active surface during storage. The inhibitive efficiency of surfactants to increase the corrosion resistance of the anode active depends on their chemical structure, concentration, and their stability in the electrolyte. Total amount of surfactant can typically range from about 0.1% to about 1% by weight of the anode.

Among the surfactants known to be effective at controlling gassing are organic phosphate esters such as the ethylene oxide-adduct type disclosed by Rossler et al. in U.S. Pat. No. 4,195,120, incorporated herein by reference. In U.S. Pat. No. 4,777,100, Chalilpoyil et al. disclosed an anode containing single crystal zinc particles with a surface-active heteropolar ethylene oxide additive including organic phosphate esters. Specifically, commercially available surfactants such as Rhodafac RM-510, Rhodafac RA-600, Witconate 1840X, and Mafo 13 MOD1 are suitable surfactants for use in the present disclosure, as described in for example U.S. Pat. Nos. 6,872,489 and 7,226,696 (the entire contents of which are incorporated herein by reference for all relevant and consistent purposes).

As noted above, the gas management electrode includes a conductive substrate, which may also be referred to in the art as a current collector. The conductive substrate generally includes thereon or therein a catalyst material for interacting with the anode active agent and electrolyte to produce hydrogen in the on-demand hydrogen gas generation device upon activation. The conductive substrate may be in the form of a metal screen, an expanded metal, a metal foam, carbon cloth, carbon paper, or a non-woven mat material. The conductive substrate may, for example, be a nickel or iron screen, a nickel or iron metal foam, a carbon material such as carbon black or activated carbon, a ceramic material or combinations thereof. The conductive substrate provides integrity and strength to the gas management electrode and, in some embodiments, may act as a catalyst to facilitate the production of hydrogen.

In some embodiments of the present disclosure, the conductive substrate will include a catalyst (which is inert and non-consumable in the hydrogen-producing reactions as it simply provides electrons) therein and/or thereon to further the chemical reactions to produce hydrogen. The catalyst is generally a powder or combination of powders that is dispersed onto the conductive substrate through mixing, coating, spraying, sputtering, and the like. In order to ensure the desired rate of hydrogen production, the catalyst desirably has a hydrogen over-voltage as small as possible and sufficient surface area as discussed below. Additionally, the stability of the catalyst (and gas management electrode generally) towards corrosion/oxidation during periods of open circuit (i.e., no hydrogen being produced) is important and should be contemplated during design.

It is generally preferred that the catalyst be a high surface area material to further the desired reactions. For example, in one embodiment, the catalyst has a BET surface area in the range of between about 0.1 m2/g and about 500 m2/g, and desirably between about 0.1 m2/g and about 100 m2/g. It is to be noted that it is generally desirable to experimentally determine/confirm the activity of a catalyst layer in a flooded galvanic corrosion cell prior to actual use in a generator device. It is to be further noted that the BET surface area of the Raney Nickel catalysts disclosed herein appears to decrease significantly, following the de-activation procedure described elsewhere.

Suitable catalyst materials include, for example, metals or Raney metals of Group VIII of the Periodic Table. Some specific suitable catalysts may include iron, nickel, nickel powder, Raney nickel, platinum, platinum black, palladium, cobalt, mixtures of nickel and cobalt, mixtures of iron and nickel, molybdenum sulfide, and mixtures thereof. In one particularly desirable embodiment, the catalyst is a Raney nickel catalyst. Because Raney nickel is generally highly reactive with air, and can burn spontaneously, it may be desirable to de-activate this (and other highly reactive catalysts as described herein) catalyst temporarily during the manufacturing process to allow for processing in an ambient environment. Such de-activation may be accomplished by methods known to those of ordinary skill in the art and may include, for example, providing an oxide layer on the surface of the catalyst. This protective oxide layer is then consumed by hydrogen produced in the device during use. As such, when a protective layer, such as an oxide, is utilized on the catalyst, the activity of the catalyst, and hence the performance of the device, may generally improve with time over an initial time period as the oxide is being chemically removed by the hydrogen.

As noted above and illustrated in FIG. 9, disposed between the anode and the conductive substrate is the gas impermeable and liquid permeable hydrophilic layer. This layer facilitates ion and water transport between the anode and the conductive substrate including the catalyst and blocks the passage of hydrogen produced at the surface of the conductive substrate and catalyst from passing into the anode and causing unwanted foaming and bubbling in the anode. Such foaming and/or bubbling in the anode are highly undesirable as they can significantly reduce the efficiency of hydrogen generation and ultimately render the device unusable and unstable. Stated another way, this gas impermeable and liquid permeable hydrophilic layer, while allowing for ion and water transport between the anode and the gas management electrode, helps to produce a gradient within the device to transport the produced hydrogen gas in the desired direction (i.e., away from the anode) in the on-demand hydrogen generation device by providing a gas impermeable backstop to block gaseous access to the anode.

The gas impermeable and liquid permeable hydrophilic layer desirably has characteristics that allow for a sustained high rate of discharge of the device, while being somewhat stretchable in order to accommodate changes within the device during hydrogen generation. Additionally, this layer will desirably block soluble impurities that can migrate to the anode and cause spontaneous gassing during periods of non-use of the device.

The gas impermeable and liquid permeable hydrophilic layer can be any suitable material that provides the desired liquid and ion transport and gas blockage. For example, the layer may be comprised of a polyvinyl alcohol (PVA) film such as Monosol 2000 (Monosoll LLC). Cellulosic materials such as cellophane may also be utilized as the material for this layer. The gas impermeable and liquid permeable hydrophilic layer can be made of single layer or can be a multiple layer film.

In this regard it is to be noted that one version of a suitable gas impermeable and liquid permeable hydrophilic layer has a polymer backbone formed from a straight chain, a branched chain, or variants thereof. Examples of materials having such a backbone that have been found to provide a suitable gas impermeable and liquid permeable hydrophilic layer include not only PVA, but also polymers of PVA (e.g., copolymers of PVA), and possibly poly(ethylene-co-vinyl alcohol, or “EVOH”), copolymers of polystyrene, blends or co-extrusions of these and like materials with materials such as polyethylene, polypropylene, polystyrene, and variants of the foregoing.

As further illustrated in FIG. 9, adjacent the catalyst layer is the gas permeable and liquid impermeable hydrophobic layer. This hydrophobic layer is generally a porous hydrophobic structure that allows gas to easily pass therethrough while stopping the flow of liquids. Because the layer is a hydrophobic layer, it retards water passage while allowing gas to pass therethrough. This property provides at least four benefits to the device: (i) it keeps the device from leaking electrolyte, (ii) it helps separate liquid from the hydrogen gas passing therethrough toward the exit, (iii) it keeps the device from “drying out” due to water loss and, as such, makes the device capable of producing a higher level of drier hydrogen for a longer period of time as water is required for the galvanic corrosion to produce hydrogen, and (iv) multiple wraps of it can help provide structural integrity to the cell and to keep the form and shape without electrolyte leakage.

Generally, this layer is produced from a suitable fluorinated polymer. In one specific embodiment, this layer is a porous polyteterfluoroethylene. The thickness may range from about 0.02 mm to about 0.25 mm.

In addition to the layers and components described above, the cell may include an optional conventional separator material disposed between the anode and the gas impermeable and liquid permeable hydrophilic layer. This separator may be utilized to hold electrolyte and further the transfer of water and ions from the anode to the surface of the conductive substrate having the catalyst and assist in the prevention of shorting of the device. Generally, this separator may be a hydrophilic separator made from a non-woven material such that it is both gas and liquid permeable. It is desirable that this separator be capable of swelling and stretching in order to accommodate changes in the device during hydrogen generation.

The on-demand hydrogen gas generation device as described herein may be a compact device that is capable of providing a large stream of hydrogen gas upon activation over a prolonged period of time. In some embodiments of present disclosure, the on-demand hydrogen gas generation device is capable of providing an average of at least about 0.1 cubic centimeters/minute/cubic centimeter of fuel volume. As used herein, the term “fuel volume” means the total anode volume of the device including the anode active, electrolyte, and any other additive in the anode at assembly of the device (excluding the current collector). In some embodiments of the present disclosure, the on-demand hydrogen gas generation device is capable of providing an average of from about 0.1 cubic centimeters/minute/cubic centimeter of fuel volume to about 1.5 cubic centimeter/minute/cubic centimeter of fuel volume, and desirably an average of about 1.0 cubic centimeter/minute/cubic centimeter of fuel volume (for a defined period of time, as detailed elsewhere herein).

As described above, the gas management system is designed such that the produced hydrogen is efficiently transported out of the device through the gas permeable and liquid impermeable hydrophobic layer. Because this layer is designed to be hydrophobic, it repels water contained in the gas management system and keeps the water internal to the system where it can be used in the galvanic corrosion reactions to produce hydrogen. Additionally, by keeping the water from the electrolyte internal of the gas management system, the hydrogen that is produced is substantially dry; that is, the hydrogen exiting from the generator may contain very small amounts of water vapor and may generally be referred to as “dry hydrogen.” As noted herein, this may be important for some fuel cell applications that require substantially dry hydrogen to operate properly.

In one embodiment of the present disclosure, the on-demand hydrogen gas generation device is capable of producing hydrogen having a water content of less than about 50,000 ppm by volume, or less than about 30,000 ppm by volume. Desirably, the device is capable of producing hydrogen having a water content of less than about 20,000 ppm, desirably less than about 10,000 ppm, desirably less than about 5,000 ppm, and still more desirably less than about 1,000 ppm.

As noted above, the on-demand hydrogen generation device including the gas management system is substantially orientation independent. Because of the design characteristics of the gas management system, the device can produce substantially the same amount of hydrogen upon activation regardless of the orientation of the device. This is significant as the device is capable of being used in almost any application regardless of orientation.

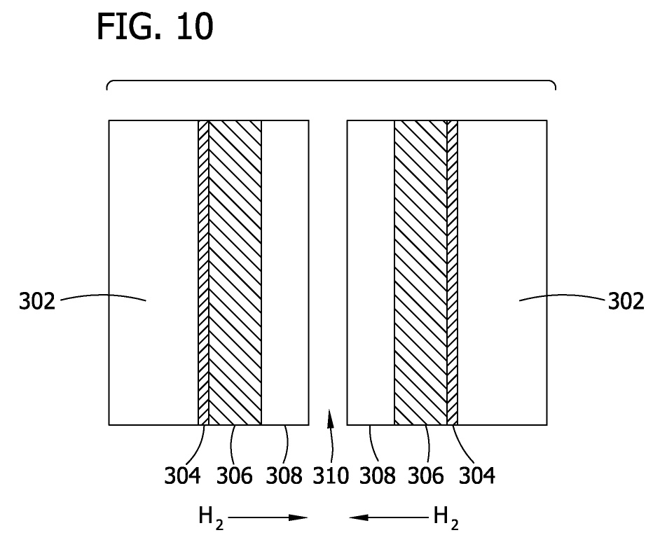

Referring now to FIG. 10, wherein various components or layers are not drawn to scale with respect to other components or layers, there is illustrated one specific embodiment of the gas management system of the present disclosure. This embodiment shows anode 302, gas impermeable and liquid permeable hydrophilic layer 304 disposed between anode 302 and conductive substrate 306 (which contains the catalyst that is not illustrated), gas permeable and liquid impermeable hydrophobic layer 308 disposed adjacent conductive substrate 306, and gas exit region 310 being interior of the gas permeable and liquid impermeable hydrophobic layer 308. This specific embodiment shows the anode being on the outside of the gas management system and surrounding the various components/layers; that is, this embodiment shows a design that is the reverse of a typical alkaline battery where the cathode constitutes an outer ring adjacent an outer can, and the anode fills the middle of the annular ring with a separator between the two). In this embodiment, when hydrogen is produced at the surface of the conductive substrate (which contains or is in contact with the catalyst layer), it is pushed or transported away from the anode and into the center of the system through the gas permeable and liquid impermeable hydrophobic layer and into the gas exit region where it can exit the gas management system.

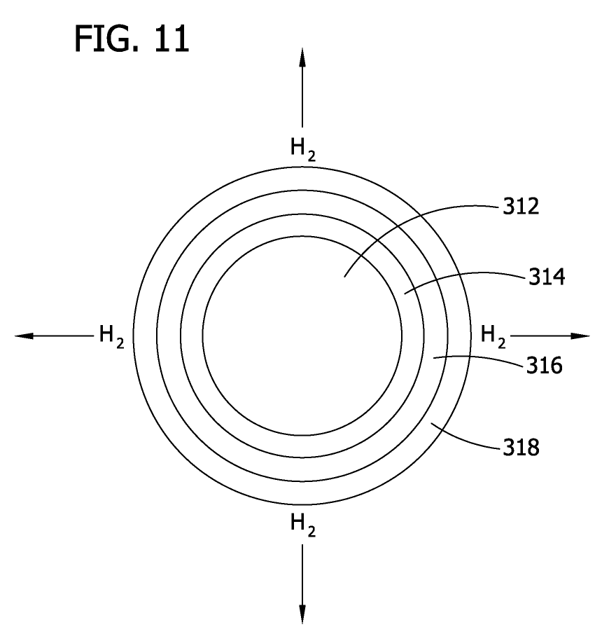

Referring now to FIG. 11, wherein various components or layers are not drawn to scale with respect to other components or layers, there is illustrated another specific embodiment of the gas management system of the present disclosure. FIG. 11 illustrates anode 312 being surrounded by gas impermeable and liquid permeable hydrophilic layer 314 which is surrounded by conductive substrate 316 (which contains the catalyst that is not illustrated) and gas permeable and liquid impermeable hydrophobic layer 318 which surrounds the conductive substrate 316. This Figure illustrates a gas management system design wherein the anode is on the interior of the system and is surrounded by the other layers/components. When hydrogen is produced at the surface of the conductive substrate, it is transported away from the anode and exits the gas management system through the gas permeable and liquid impermeable hydrophobic layer 318.

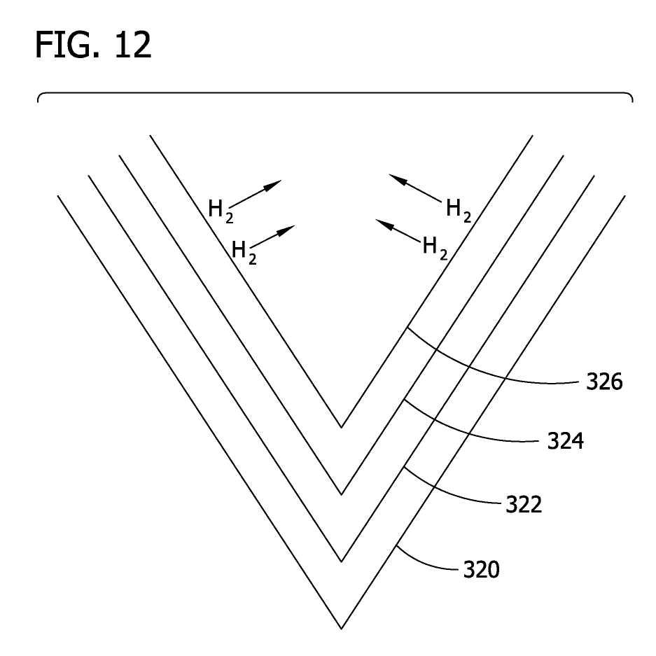

Referring now to FIG. 12, wherein various components or layers are not drawn to scale with respect to other components or layers, there is illustrated another specific embodiment of the gas management system of the present disclosure. FIG. 12 illustrates anode 320, gas impermeable and liquid permeable hydrophilic layer 322 disposed between the anode 320 and the conductive substrate 324 (which contains the catalyst that is not illustrated) and gas permeable and liquid impermeable hydrophobic layer 326 adjacent the conductive substrate 324. This Figure illustrates a gas management system which first is formed into a “V’ by folding upon itself, followed by folding the double layer gas management electrode ribbon into an “s” ribbon (or “z”) folded shape with the hydrogen produced exiting through a gas exit region interior of the gas permeable and liquid impermeable hydrophobic layer 326. In the embodiment illustrated in FIG. 12, as well as in one or more other embodiments described herein, the anode, including the anode active agent, electrolyte, gelling agent (if any), surfactant (if any) etc. may be enclosed in a pouch-type enclosure that acts as the gas impermeable and liquid permeable hydrophilic layer. This embodiment may allow for substantial bending and/or rolling of the anode into a ribbon, z, s, prismatic, or other desired conformation including a spiral wound configuration. In other embodiments, the “s” or “z” shaped cathode ribbon is surrounded by the anode gel.

E. Configurations

It is to be noted that the size or dimensions of the on-demand hydrogen gas generation device may be other than herein described without departing from the intended scope of the present disclosure. In one particular embodiment, however, the on-demand hydrogen gas generation device may be configured to have a cylindrical shape (the device, for example, having dimensions or a shape substantially similar to a standard AA or AAA electrochemical cell), or alternatively a flat prismatic or rounded (i.e., “race-track”) prismatic shape (the device, for example, having dimensions or a shape substantially similar to a standard prismatic or elliptical electrochemical cell used in cellular telephones, for example). In yet another alternative embodiment, the device may have a button-like shape. Such embodiments are particularly advantageous because, when employed with other features conventionally used in electrochemical cells (e.g., standard anode, positive electrode, electrolyte, etc., such as those detailed herein above), the on-demand hydrogen gas generation device may be mass produced using existing manufacturing techniques and equipment.

II. Fuel Cell with On-Demand Hydrogen Gas Generation Device

The on-demand hydrogen gas generation device may be used in combination with a hydrogen gas consumption device (e.g., a fuel cell) in order to generate power or electricity for a number of applications, particularly small-scale applications or uses. The on-demand hydrogen gas generation device may be initially constructed with the switching mechanism in the closed position, but with an open external circuit such that there is no completed circuit between the anode and positive electrode therein and thus no hydrogen gas is generated. In such an embodiment, the hydrogen gas generation device is desirably designed so the act of connecting the device to the fuel cell, or more generally a hydrogen consuming device, such as for example by means of an interface connector (in one embodiment) that connects the hydrogen gas outlet or vent of the on-demand hydrogen gas generation device with the hydrogen gas inlet of the fuel cell, causes the external circuit to close and hydrogen gas generation to commence.

The fuel cell typically includes a hydrogen gas plenum (i.e., a compartment adjacent to or leading to the anode of the fuel cell), which begins to fill as hydrogen gas is generated by and evolved from the hydrogen gas generation device. As the plenum fills, pressure builds in the internal volume of the hydrogen gas generation device and the hydrogen gas plenum. If the consumption rate of hydrogen is greater than the production rate, hydrogen will continue to be produced by the hydrogen gas generation device at the maximum rate possible, which in general is a function of the resistance of the electrical circuit therein (when galvanic cell corrosion is the means by which hydrogen gas is generated for fuel cell consumption). In contrast, if the consumption rate of hydrogen is less than the production rate, the pressure in the hydrogen gas generator will begin to increase until it reaches a threshold or predetermined value (as detailed elsewhere herein). The switching mechanism will then begin to open, increasing the resistance therein to the electrical current passing therethrough. This will slow the rate of hydrogen gas production, and may ultimately terminate it for a period of time (if the pressure is sufficient to fully open the switch). Once this pressure dissipates (i.e., falls below the threshold pressure), by for example further hydrogen gas consumption by the fuel cell, the switching mechanism will close once again (or more fully close), thus resulting in increased hydrogen gas production (or resulting in the re-commencing of hydrogen gas production).

It is to be noted that the on-demand hydrogen gas generation device of the present disclosure is particularly well-suited for use in small-scale applications (optionally being configured to fit within a fuel cell having dimensions or a shape substantially similar to a standard AA or AAA electrochemical cell, for example); that is, the device is well-suited for use in hydrogen gas-consuming devices (e.g., fuel cells) that produce, or have an output of, less than about 30 watts, less than about 25 watts, or even less than about 20 watts, of power (the output, for example, being in the range of about 1 watt to about 5 watts, about 5 watts to about 30 watts, about 7.5 watts to about 25 watts, or about 10 watts to about 20 watts).

The following Examples describe various embodiments of the present invention. Other embodiments within the scope of the appended claims will be apparent to a skilled artisan considering the specification or practice of the invention as described herein. It is intended that the specification, together with the Examples, be considered exemplary only, with the scope and spirit of the invention being indicated by the claims, which follow the Examples.

### EXAMPLES

### Example 1

### Positive Electrode Preparation

This is an example that illustrates the preparation of a suitable positive electrode material, and more specifically illustrates the deactivation of Raney Nickel 3202 and the resulting use thereof to prepare a catalyst layer and ultimately a gas management electrode for use in accordance with the present disclosure:

A. Deactivation of Raney Nickel

Raney Nickel is spontaneously combustible in air when it is dry. While it may be possible to process it safely in a wet form, for the purposes of this example, a procedure to deactivate it was used based on literature information (see, e.g., “Novel Methods of stabilization of Raney-Nickel catalyst for fuel cell electrodes”, M. A. Al-Saleh, et. Al., Journal of Power Sources 72 (1998) pp 159-164). The procedure is described in greater detail below.

Material/Equipment List: Raney 3202 Nickel, slurry in water (Sigma Aldrich product #510068); 5% hydrogen peroxide solution, diluted from 50% solution (Sigma Aldrich product #516813); ice water bath; mixing motor (Arrow Engineering model JR4000) with three blade teflon mix shaft; fume hood; scoop; vacuum filtration apparatus with Whatman 90 mm ashless filter paper (Cat #1440-090); and, vacuum drying oven.

Procedure (the steps were performed in a fume hood to avoid exposure to potentially hazardous gases products): (1) Hydrogen peroxide and Raney Nickel solutions were chilled to a temperature in the range of 0-10° C. before starting the reaction. (2) An ice water bath was prepared, and the batch and the mixing apparatus were set up inside the fume hood. (3) The chilled 15% hydrogen peroxide solution (50 ml) was added to a 250 ml beaker and placed in the ice water bath under the mixer. (4) Wet Raney Nickel (10-14 g) was added to the hydrogen peroxide solution at one time using a small scoop (because the reaction begins immediately upon contact). Accordingly, the wet Raney Nickel solution was dense enough so that the entire weight used could be picked up with one scoop. (5) The mixer was activated (low setting—setting no. 1) within approximately three seconds of adding the Raney Nickel. (6) After agitating for approximately ten seconds, bubbling in the solution stopped, indicating the reaction was essentially complete. (7) The solution was allowed to continue mixing for a total of three minutes (timed from the addition of Raney Nickel), to allow time to cool down before collecting the reaction product. (8) The reaction product was collected by filtration (using a vacuum filtration apparatus), and rinsed using two liters of deionized water. (9) The product was thoroughly dried at 45° C. in a vacuum oven (vacuum pressure of at least 25 in Hg), which took at least 12 hours. (10) The product was then removed from the oven and stored under argon until being subjected to further processing.

1. Positive Electrode Formulation and Construction

Table 1, below, provides a summary of the composition of the positive electrode material prepared using the above-described deactivated Raney nickel, as well as commercially available carbon and PTFE (the positive electrode material being subsequently used in most of the examples described elsewhere herein, except the one using Ni foam).

TABLE 1

| Component | Wt % | Supplier | Grade | Lot # |
|---|---|---|---|---|
| Carbon | 20 | Calgon | PWA | N04B29GB |
| Ni Catalyst, | 75 | Aldrich | Raney Ni 3202 | 10928AD |
| deactivated | | | | |
| PTFE | 5 | DuPont | 6C | 01302 (12-7-05) |

These three dry components were combined in a coffee grinder (Mr. Coffee model IDS77) and mixed for 40 seconds. The grinder was hand-shaken during its operation in order to more effectively disperse and homogenize the dry mixture. This mixture was then compressed into a flexible sheet by a set of pinch rollers, with a gap set to achieve a sheet thickness of between 0.012 and 0.016 inches at a linear speed of 10.5 inches/minute. This sheet was then reground in the coffee grinder for 20 seconds, again using hand agitation during the grinding operation. This powder was then fed back into the same pinch rollers to make another sheet, this time with a gap adjusted to achieve a flexible sheet thickness of approximately 0.0085 inches (0.21 mm). This process helped to fibrillate the PTFE better, and provide a more flexible, continuous sheet.

The positive electrode utilizes a Nickel wire screen as the integrated current collector (although expanded metal may also be used). The screen may be, as in this case, coated with a conductive carbon primer to aide in adhesion of the active flexible sheet thickness, 40 mesh double cold bonded, GDC Corporation) was coated with Electrodag 109 (Acheson Colloids Co, Port Huron, Mich.). Alternate solvent/binder systems can be used to enhance adhesion. The flexible positive electrode sheet and screen were then passed back through a set of pinch rollers to achieve an overall thickness of between 0.009 and 0.010 inches (0.254 mm). This process produced an electrode with an overall coating density of 0.039 g/cm² (0.252 g/in²) and a nickel catalyst loading of 0.0292 g/cm².

The positive electrode was cut into rectangles 1.86 inches in height by 1.65 inches in width, for use in the cylindrical cell configuration.

On the non-coated side (i.e., screen side) of the positive electrode, a thin layer of PVOH (i.e., polyvinyl alcohol) and CMC (i.e., carboxymethyl cellulose) solution was applied, to serve as a glue to laminate a layer of the gas impermeable film of PVOH. The aforementioned solution can be comprised of a variety of grades of similar water soluble polymers. The following table (Table 2) provides an example of one composition used herein.

TABLE 2

| Component | Wt % | Grade | Supplier | Lot # |
|---|---|---|---|---|
| H₂O (DI) | 93.14 | n/a | n/a | n/a |
| PVOH | 5.65 | Celvol 125 | Celanese | 34080042 |
| CMC-Na | 1.21 | CAS 9004-32-4 | Acros | A0166091 |

Within 15 seconds of the solution application, a 0.012 mm thick film of biaxially oriented PVOH film (Bovlon, Nippon Gohsei, Osaka, Japan, lot #6525A2) was applied and pressed onto the solution-coated side of the electrode. The pressure lamination was carried out with a 1 inch diameter stainless steel rod, wherein hand pressure was used to ensure a smooth film coating while removing the excess PVOH/CMC solution from between the electrode and PVOH film. The PVOH was permeable to water and KOH, so adequate electrolyte could be transported to the positive electrode. The PVOH was laminated to ensure that gas generated in the positive electrode does not enter the anode compartment, nor accumulate in any space between the positive electrode surface and the hydrophilic PVOH layer. The path of least resistance is through the cell wall exterior.

Additionally, in the case of a cylindrical cell configuration, the laminated electrode was allowed to dry, at room temperature, for between 10 and 15 minutes, after which time a 2 mm strip of PVOH was removed from the shorter side of the electrode. This material removal was done to expose part of the electrode and enable electrical contact between the current collector (screen) and a bottom cap (that will be introduced later). After the PVOH strip was removed, the electrode was placed in a 45° C. oven for between 30 and 45 minutes to fully dry the laminated positive electrode.

### Cell Configurations:

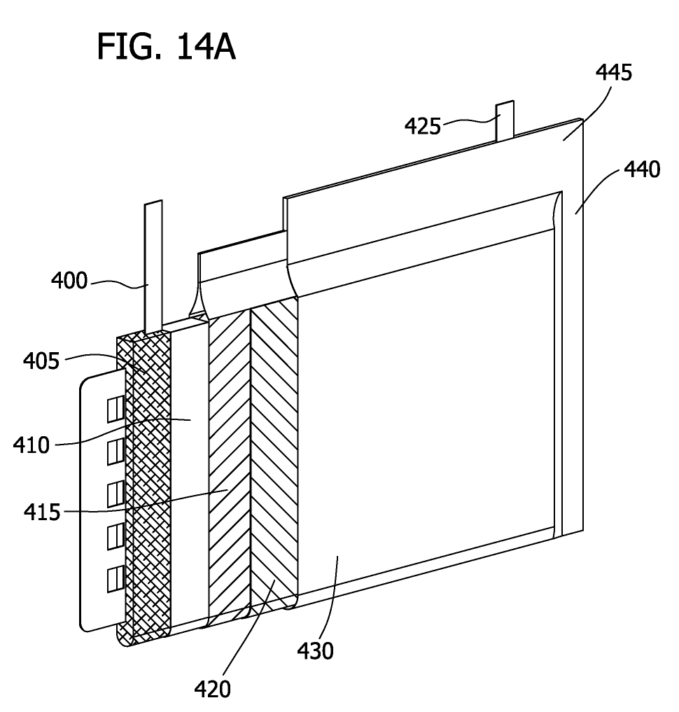

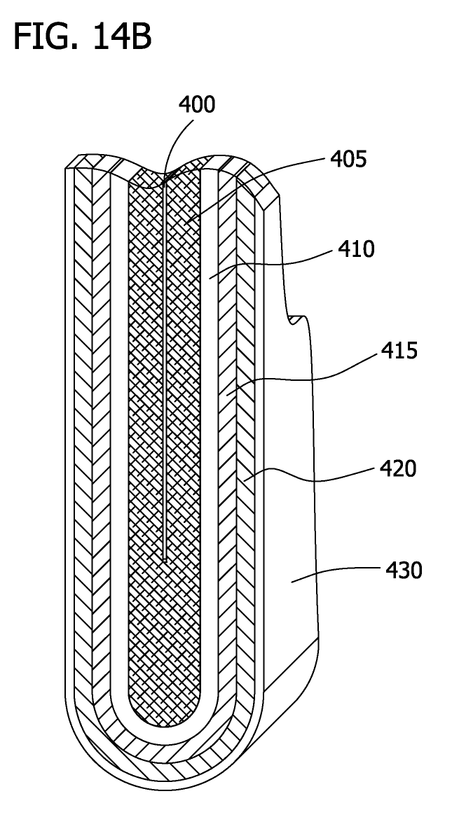

For a galvanic hydrogen generator, four basic embodiments were developed for purposes of illustration and evaluation: (1) a spiral wound design for which an electrode of the configuration illustrated in FIG. 12 was used; (2) anode surrounded by the positive electrode in a cylindrical configuration (such as the design illustrated in FIGS. 1A-1C herein and in the configuration illustrated in FIG. 11); (3) positive electrode “immersed” in an anode mass using an “s” shaped ribbon of electrode and the configuration illustrated in FIG. 12; and, (4) anode surrounded by the positive electrode in flat prismatic configuration as illustrated in FIGS. 14A and 14B. With respect to embodiment (1), plated Nickel foam was used for the positive electrode. For the other embodiments, a Raney nickel catalyst (as detailed above), in combination with the substrate that was part of a gas management electrode system (as detailed elsewhere herein), was used for the positive electrode (with embodiment (3) utilizing such an electrode folded on itself, or having a “pouch” configuration, as detailed elsewhere herein).

It is to be noted that, prior to testing, the generator cells of (2), (3) and (4) were placed in an O-ring sealed Delrin container with electrical feed-throughs and a gas burp valve set to about 2 to 3 psi, to periodically release the hydrogen generated therein. Such a container was necessary to test the cells because the Raney nickel catalyst is reactive with oxygen, and exposure to ambient air is undesirable. Ambient air can penetrate and diffuse into the gas permeable hydrophobic outer layers of the gas management electrode. During each cycle, the generated hydrogen accumulates in the outer container and builds up pressure in the container. At the threshold pressure of about 2 to 3 psig, the burp valve opens instantaneously and releases the pressure, but keeps oxygen (i.e., air) out of the chamber.

### Example 2

### Correlation Between Hydrogen Gas Generation Rate and Current

The hydrogen gas generation rate was observed to correlate well with the current measured during generation of gas. Once this correlation was established for different currents, in the interest of simplicity and speed all the reported results were based on current measurements.

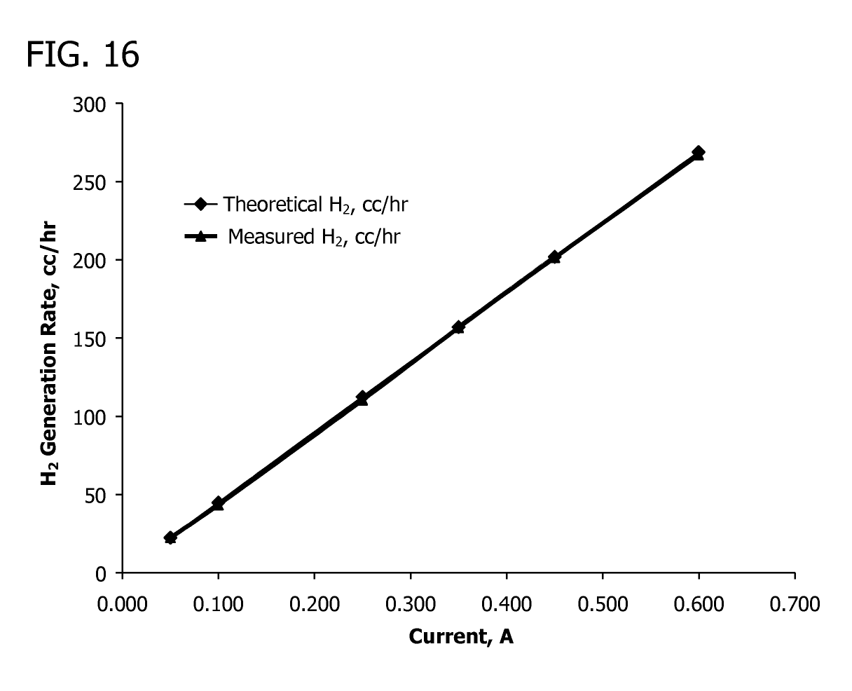

A cylindrical cell design of Example 4 (i.e., the Bobbin-type cell design), further detailed below, was used to make the noted correlation. Individual generator cells were discharged at a fixed current of 350 mA and 650 mA respectively, and the hydrogen generation rates were measured by the displacement of a column of water in a graduated burette. An additional experiment was performed that involved a single cell that was tested at various constant current levels in a stepped manner. A comparison of the theoretical (calculated) vs. the actual measured gas generation rate is shown in the graph presented in FIG. 16, which indicates this correlation is excellent.

### Example 3

### Spiral-Wound Cell Design

For this example, a D-size alkaline cell can was used. A spiral wound design is generally known to one skilled in the art to enable higher discharge rates (i.e., discharge currents, and hence gas generation rates in this application) than a typical bobbin cell design. The positive electrode comprised a compressed nickel foam material which was post-plated with nickel to produce a more active nickel surface than the as-received Ni foam (as further detailed herein below). The spiral wound D cell design consisted of a layered arrangement of two positive electrode sheets and three anode pouches made up of the hydrophilic gas impermeable, liquid permeable layer material. The anode pouches comprised 1.5 wraps of 1 mil M2000 and were filled with a gelled Zn anode. The filled anode pouches were about 2 mm thick, to enable a higher anode rate and efficiency than a “bobbin” design used in typical alkaline batteries.

As noted, the positive electrode for H2 evolution was Ni-plated Ni foam, to one surface of which was laminated a layer of porous PTFE. One challenge of a wound design is to provide a dry path (i.e., a “chimney”) for H2 diffusion. This was achieved by putting a piece of woven Teflon fabric between two layers of PTFE film to provide a three-dimensional diffusion path. The two layers of PTFE were carefully sealed at the bottom and the sides to maintain a dry interface. The dry vent was made taller than the electrodes to avoid electrolyte spill over at the top of the cell. After inserting the wound assembly into the cell can, electrolyte was added until the pores of the positive electrode and interface were completely filled (this involved use of with 16 g of 15% KOH). The anode comprised 61 g of a gelled Zn anode with 66% loading and 28% KOH-2% ZnO anode electrolyte. The initial equilibrium KOH concentration was calculated to be 22.6%. The KOH concentration increased during discharge (due to consumption of water) and was calculated to be 26.3% at 50% and 30.7% at 90% anode discharge. The cell was discharged using a constant resistance intermittent test (1 hr cycles 4×/day). The external resistance was set so that the initial current was about 4 amps.

The procedure used for electrolytic nickel plating of nickel metal foam, for use as a hydrogen generating positive electrode (including equipment and materials), and the subsequent testing method used, was as follows:

Equipment/Material List: (1) A nickel substrate, such as nickel foam sheet (commercially available from INCO Advanced Technology Materials Co, Ltd.), having a density of 420 g/m2, a cell size of 590 um, and a thickness of 1.7 mm; (2) Electrochemical interface, such as Solartron SI1287, computer and Scribner Associates Corrware software; (3) Electrochemical cells (such as glass beakers); (4) Nickel plating solution, such as Buehler Edgemet Nickel Plating Kit 20-8192; (5) Nickel counter electrode, such as 40 mesh nickel wire screen, or GDC/Keystone Wire Cloth (0.005 inch Nickel 200 nominal diameter wire, double cold bonded); (6) Nickel tabbing material, such as Nickel 200, 0.007 by 0.125 inches, with a length as appropriate for its use; (7) Non-woven separator material, such as PA160VS30E (commercially available from Papeteries de Mauduit, France); and, (8) A reference electrode, such as Zinc metal wire, Alfa Aesar (1.0 mm, 99.95% metal basis).

Plating Procedure: (1) The nickel foam sheet was cut into a rectangle, approximately 2.5 inches by 11 inches (approximately 1.0 cm by 27.9 cm or 27.5 cm2). (2) A nickel tab was attached (by spot welding) to the nickel foam sheet to provide electrical contact during the plating process. (3) The nickel foam was placed along the inside wall of a 2000 ml Pyrex beaker with the tab up. (4) A strip of separator material approximately 3.8 inches by 14 inches was cut and placed against the inner wall of the nickel foam. (5) A length of nickel screen counter electrode was cut (approximately 4 inches by 14 inches). A “flag” was cut on the short end of the rectangle by cutting the screen about half an inch from the short edge, cutting from bottom and stopping about a half an inch short of the top (the flag being folded up to form a tab for electrical connection), and then placing the nickel screen against the inner wall of the separator material with the flag up. (6) Equal quantities of the two Edgemet Nickel Plating solutions were mixed and then a sufficient quantity thereof was poured into the beaker to cover the electrodes (a weighted 600 ml beaker may be placed in the center to allow, by displacement, the use of less Edgemet solution), followed by mixing or agitating as needed to remove trapped air around the electrodes. (7) Two electrodes on the electrochemical interface, such that the nickel foam was the working electrode and the nickel screen was the counter electrode, were connected to the electrochemical interface. (8) Plating was conducted at ambient temperature (approximately 22° C.); accordingly, at this temperature an anodic or positive 2 amps was applied to the nickel foam for 5 minutes to clean the surface through electrochemical etching. (9) Following the etching step, a cathodic or negative 2 amps was applied to the nickel foam for 60 minutes to plate fresh nickel onto its surface. (10) Finally, the plated nickel foam was removed from the electrochemical cell and washed several times in flowing deionized water. The plated nickel foam was stored under deionized water until use.

Testing: The resulting plated nickel foam was tested using the following procedure: (1) A 2 cm2 coupon of the sample plated nickel foam material was cut, and then an appropriate length of a nickel tab was attached thereto (to provide an electrical contact) for testing. (2) The counter electrode was a rectangle of a nickel screen, approximately 4 inches in size, folded in half and then in half again to form a rectangle about 1 inch by 4 inches. (3) The reference electrode was a piece of zinc wire. (4) The electrolyte was a 31% solution of potassium hydroxide dissolved in water. (5) The test cell was a 100 ml beaker with the electrode to be tested on one side, the counter electrode on the other side, and the zinc wire reference placed near the test electrode. A sufficient quantity of the electrolyte was added in order to completely immerse the 2-cm2 test coupon. (6) The two electrodes were connected to an electrochemical interface, such that the nickel foam was the working electrode, the nickel screen was the counter electrode, and the zinc wire was the reference electrode. (7) The test electrode was evaluated for rate of hydrogen evolution by applying a voltage range and recording the delivered current (the voltage was decreased from an initial 0.5 volts to 0.1 volts (test electrode verses the zinc reference) at a rate of 1 mV per second). (8) The determined current values were divided by two and reported as amps per square centimeter (A/cm2), wherein hydrogen production at a given voltage was directly proportional to the current delivered at that voltage (the higher the current value, the greater the rate of hydrogen production).

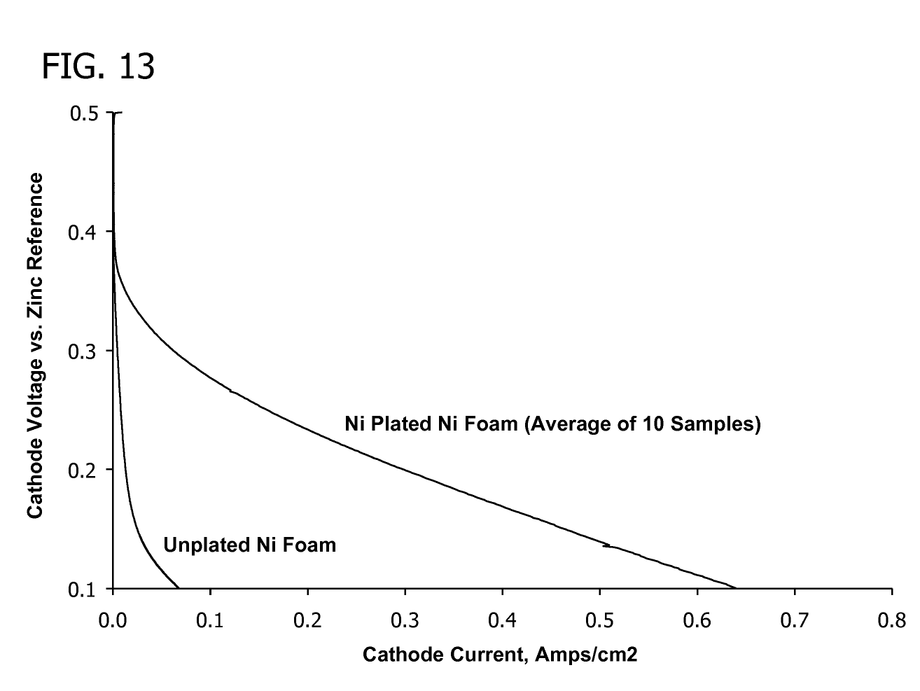

The graph presented in FIG. 13 compares the voltage/current response for the unplated nickel foam with the averaged results of 10 nickel plated, nickel foam samples. These results clearly indicated that plated foam was much more active for hydrogen generation.

Samples of the unplated and plated nickel foam materials were also subjected to Scanning Electron Microscopic (SEM) and Energy Dispersive X-ray (EDAX) analyses. The plating of the nickel foam resulted in a slight observed increase in irregularity of the surface structure. The EDS data are shown in Table 3, below. This analysis also found the additional presence of magnesium (Mg), phosphorous (P) and oxygen (O) on the surface of the plated nickel. It is possible that, in addition to the higher roughness, the incorporation of the Mg and P may have increased the activity of the foam.

TABLE 3
Energy Dispersive Spectroscopy Analysis of the Nickel Surfaces

| | Determined | | | | |
|---|---|---|---|---|---|
| | A/cm² at 0.1V | | | | |
| Ni Foam | vs. Zn | O | Mg | P | Ni |
| Plated 070410A-2 | 2.04 | 2.9 | 0.7 | 0.5 | 95.9 |
| Unplated Foam | 0.06 | — | — | — | 100 |

### Example 4

### Anode Surrounded by Positive Electrode (AA Size Bobbin-Type) Design, with AA Positive Electrode Tube Formation Process

This example utilized the configuration depicted in FIG. 11, where the entire outer wall of the cylindrical cell is a porous surface through which the generated hydrogen can easily pass. This design approach provides a simple means to achieve orientation independence for the generator since the hydrogen escapes out of the walls of the sealed cell with hydrophobic porous walls. Using laminating/winding equipment, a sheet of PTFE (Low density 600A, Plastomer Technologies, Newtown, Pa.) was applied to the coated side of the positive electrode with a lamination pressure of 21 psig (+/−1 psig). The PTFE sheet width is about 1 to 2 mm wider than that of the electrode. The PTFE lamination was performed simultaneously with forming the electrode into a cylinder, where the cylindrical electrode contained an overlap of about 5.0 mm. The PTFE sheet was wound externally around the cylindrical positive electrode a total of 3 times (one wrap covering the coated surface and 2 full additional overwraps).

Once the cylindrical shell was formed by means of the PTFE wrap, the inner electrode seam was sealed to prevent any loss of electrolyte. The PVOH/CMC solution discussed above was applied at the interior axial joint of the electrode overlap, using a syringe with a 22 gage, 1.5 inch needle. This viscous solution was allowed to dry for 30 minutes at room temperature with the axial bead of sealant parallel to the floor to contain the solution in the overlap area while a skin formed. After 30 minutes, the cylinder was placed in a 45° C. oven and dried for an additional 30 to 45 minutes (until the liquid from the solution evaporated).

A grommet and cap were placed on the end of the cylindrical electrode where the PVOH film strip was removed. Once radially crimped, electrical contact exists between this bottom cap and the current collector. A piece of separator paper, in this case PA 160 VS 30E PDM (commercially available from Papeteries de Mauduit, 29393 Quimperlé Cedex, France) was inserted into the interior of the cylindrical electrode in such a way that the entirety inner surface of the positive electrode was covered by the separator. Desirably, an overlap of at least about 10% (by circumference) was used to ensure that zinc particles from the anode did not directly contact the positive electrode surface. Additionally, the separator was used (as is commonly practiced by those skilled in this art) as a means of maintaining a reservoir of electrolyte and a wetted interface between the anode and positive electrode. An insulating bottom disk or cup was used to electrically insulate the metallic bottom cup from the anode. This was inserted after the separator layer was placed within the cylinder and acts as an anchor at the bottom of the cell to ensure maximum interior volume is attained as well as minimizing the gap in the separator overlap to prevent accidental particulate zinc transport to the positive electrode surface that can cause shorting.

This cell was filled using 10.6 g of 66% zinc 25-2 (KOH—ZnO) anode, 0.8 g of a 20-0 gelled KOH, and 0.3 g of 15-0 liquid electrolyte. The liquid electrolyte was used for initial wetting of the separator, and some gelled electrolyte was added to the top of the anode after the anode was filled into the cavity.

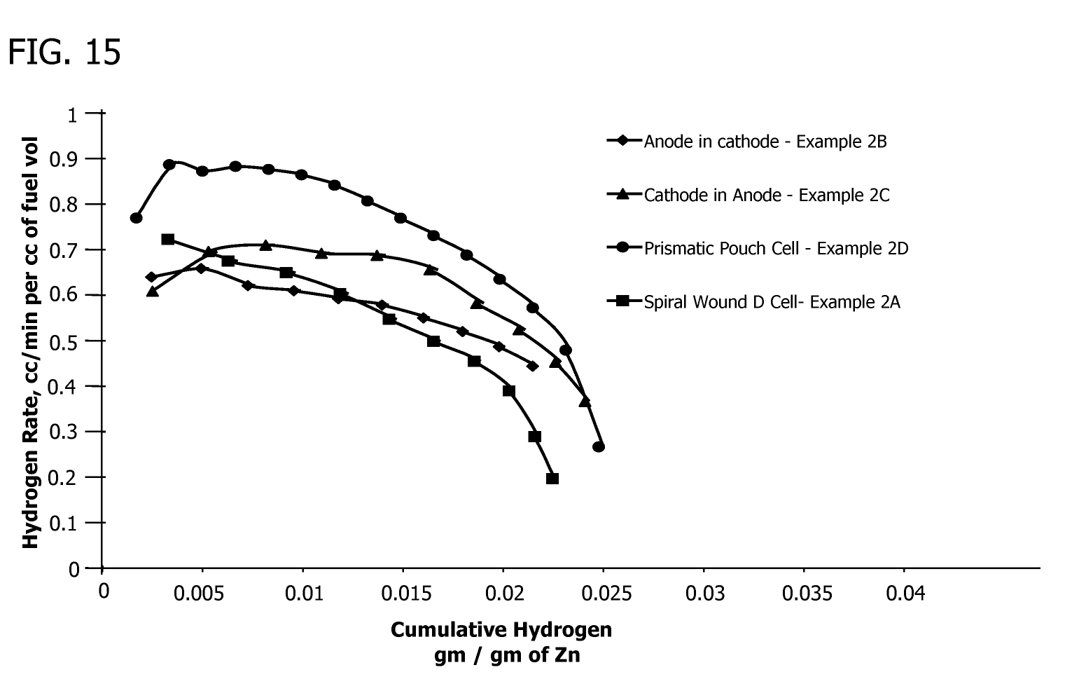

The generator cell was tested at 0.5Ω external load under intermittent conditions to a capacity of 0.35 Ah for each step, with a 3 hour rest period between cycles. The results of the test for this cell are provided in the graph of FIG. 15.

### Example 5

### Positive Electrode-in-Anode Design—AA Size

This cell design is considered an “inside out” cell design (compared to a conventional alkaline battery). The objective was to develop a higher rate design than Example 3 to increase rate of hydrogen production and to increase efficiency of zinc utilization. The inside walls of a AA alkaline cell can were plated with copper (see procedure below) to prevent contact between the zinc anode and the nickel can (which would spontaneously produce hydrogen gas if not protected). A double layer of positive electrode (5 cm by 4 cm) was formed into an approximate “S” shape and inserted into the can. In addition to reducing the thickness of the anode layer, this design allowed two surfaces of the positive electrode to be utilized (since the gas management electrode here was folded on itself as depicted in FIG. 12). The positive electrode used was essentially the same composition as the one used in Example 3 above (i.e., a composite positive electrode comprising deactivated Raney Nickel catalyst). The anode consisted of 10.2 to 10.4 g of 66% 25-2 anode and 2.0 g of 15-2 gelled electrolyte. The gelled zinc anode was filled into all the cavities between the positive electrode and the can. The cells were discharged using a constant resistance intermittent test (i.e., 1 hr cycles 4×/day). The resistance was set so that the initial current was about 500 mA.

Copper plating of the inside of the AA can was performed using electroless plating, via the reduction of copper sulfate solution (CuSO4.5H2O) with formaldehyde (HCHO). The electroless plating solution consisted of 0.1M CuSO4.5H2O, 0.05 M ethylenediamine tetraacetic acid (EDTA) and formaldehyde (35%). The pH of the plating solution was adjusted to between 11 and 12 by potassium hydroxide, and the plating temperature was 50±5° C. Prior to electroless plating, the inside of positive electrode can was first thoroughly washed with water and then dried at room temperature. Finally, the dried can was filled with the plating solution and held at 50±5° C. in a water bath for about 1 hour. The copper plated can was thoroughly washed with distilled water and then dried at room temperature.

### Example 6

### Prismatic Design (Pouch Cell)

The prismatic cell design (or pouch cell design), as further illustrated in FIGS. 14A and 14B, has the advantage of not only having a thin anode layer (optimized for high rate), but also a uniform anode thickness, so as the discharge progresses, the interfacial anode area remains essentially constant. In a cylindrical bobbin type design, the interfacial anode area shrinks as discharge progresses, making it more difficult for high rate discharge as more of the anode is consumed. This cell design builds on the orientation-independent approach disclosed in Example 3 but is a significant improvement over Example 4 due to the higher rate capability achieved by the thinner and substantially even thickness of the anode layer. The cell design comprises an anode current collector 400 and anode 405, around which is wrapped or folded (in a generally “U” shape) a gas management electrode (i.e., an optional separator (e.g., nonwoven material) 410, a gas impermeable, hydrophilic layer 415, a positive electrode and support (collectively 420), which is in electrical communication with a current collector (425), and a gas permeable, hydrophobic layer (430), the outer edges 440 and 445 thereof being sealingly connected to each other and around the anode current collector post and the positive electrode post (i.e., the outer edges of one or more of, for example, the gas impermeable, hydrophilic layer and/or the gas permeable, hydrophobic layer being sealed to substantially prevent leakage).

The cell structure is provided by the positive electrode, which is 75% Raney nickel, 20% carbon and 5% PTFE coated onto a carbon coated nickel screen or support. The positive electrode is cut to dimensions of about 100 mm by 50 mm and then a nickel tab is welded to the positive electrode current collector. The positive electrode is then laminated to 2 layers of Plastomer Technologies A600 Low Density PTFE (polytetrafluoroethylene) at a gap of 22 mils. The PTFE is trimmed so that approximately 8 mm of overhang remains. The positive electrode and PTFE are then laminated to 1.5 mil M2000 PVA (polyvinyl alcohol), obtained from Monosol LLC (Portage, Ind.). An adhesive gel comprising PVA/CMC (carboxymethyl cellulose) is used for the lamination, at a pressure of about 60 psi. The PVA layer overhangs the positive electrode on each side by about 4 mm. With the positive electrode, PTFE and PVA layer as a single unit, it is folded in half the long way and the side seams are heat sealed. These side seams include both the overhanging PVA and PTFE layers to prevent leakage between the anode and positive electrode compartments as well as to the outside of the cell. As an extra precaution, each seam has two heat seals. The first heat seal bonds the PVA and PTFE layers, while the second heat seal is on the outer edge where the PTFE extends beyond the PVA layers and bonds just the PTFE layers. An optional separator layer of nonwoven F3T23 (from Kuraray Corporation, Japan) is inserted into the cell pouch to hold additional electrolyte near the PVA layer interface and as an extra shorting protection. The anode compartment contains 17 g of 28-2 66% anode and 2 g of 26-2 electrolyte. The anode current collector is a 36.9 mm by 31.3 mm by 0.076 mm perforated brass foil. The base of the anode current collector tab is wrapped in a hydrophilic F3T23 grade nonwoven material (Kuraray Corporation, Japan) that is first soaked in a 7% PVA/water solution, to improve the bonding with PVA in the top seam area. Once this was dry, the top seam was then heat sealed in the same manner as the sides, with the two tabs extending outward. With the top seam completed, the tabs were then further sealed to the top of the cell by heat sealing them between two layers of an aluminum polymer composite (GLAM-085SL, Pliant) to prevent KOH electrolyte leakage.

### Example 7

### Performance Evaluation

The cells prepared above were placed in a O-ring sealed Delrin container with electrical feed-throughs and a gas burp valve set to between about 2 and 3 psi to periodically release the generated hydrogen. Such a container was used to test the cells because the Raney nickel catalyst is reactive with oxygen, and exposure to ambient air is undesirable. Since there is no hydrogen consuming device connected to the outer container, the hydrogen generated during each cycle accumulates in the outer container and builds up pressure in the container. At the threshold pressure of between about 2 and 3 psi, the burp valve opens instantaneously and releases the pressure but keeps oxygen (air) out of the chamber.

The generator cells were tested at 0.3Ω under intermittent conditions to a capacity of 0.35 Ah for each step, with a 3 hour rest period between cycles. The results of the test are presented in the graph of FIG. 15. The results indicate that the cell design and configuration can be modified to obtain the desired generation rate and fuel utilization efficiency. For high gas generation rates, it is desirable to utilize a flat prismatic type of design.

Table 4 shows some of the key design parameters, including the interfacial area-to-anode volume ratio.

TABLE 4
Cell Design Parameters

| | Interfacial | Anode | Interfacial Area/Zinc |
|---|---|---|---|
| Cell Design | Area, cm² | Volume, cc | Volume Ratio |
| Cath Surrounding | 16.86 | 0.92 | 18.3 |
| Anode - Example 4 | | | |
| Cathode in Anode - | 24 | 0.98 | 24.5 |
| Example 5 | | | |
| Prismatic Pouch | 43.68 | 1.42 | 30.8 |
| Cell - Example 6 | | | |

### Example 8

### Determination of Water Content in Hydrogen from Galvanic Cell

The anode of a fuel cell produces water which is transported through the membrane to the positive electrode, from where it is expelled out of the cell as vapor. The water content in the incoming hydrogen stream is desirably controlled to avoid a flooding situation in the cell. Hence, the water content of the hydrogen stream is important for optimum functioning. To analyze this parameter, a gas chromatograph fitted with on column gas injection and thermal conductivity detector was used. (Instrument Details: Thermo Finnigan Trace GC 2000 equipped with TCD detector and on column gas injection loop; Supelco 100/120 10′×⅛″ Hayesep D column; 120° C. oven temperature; 5 minute run time; 0.25 mL sample loop size; 25 mL/min Helium carrier gas. Desiccant Materials: Anhydrous Calcium Sulfate from Drierite (Stock #26930); 30/40 mesh Molecular Sieve 5A from Supelco.)

The procedure used in this example was as follows: A 30 mL hydrogen sample was collected from a hydrogen gas generator with a gas tight syringe. The sample was injected into the instrument within five minutes of its collection to preserve the integrity of the sample. For concentrations of water vapor above 2 g/m³, the result was obtained by comparing the water peak area against a standard curve that was generated. For concentrations below 1000 ppm, the result was compared against results obtained from samples taken from a dry room environment, which has less than 35 ppm water concentration, and then an approximate concentration was determined. Using this method, the moisture content of the hydrogen gas from cells of example 4 and example 6 are in the range of 8-12 g/m³, or about 1% to about 1.5%.

When introducing elements of the present invention or the various versions, embodiment(s) or aspects thereof, the articles “a”, “an”, “the” and “said” are intended to mean that there are one or more of the elements. The terms “comprising”, “including” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

In view of the above, it will be seen that the several advantages of the invention are achieved and other advantageous results attained. As various changes could be made in the above processes and composites without departing from the scope of the invention, it is intended that all matter contained in the above description and shown in the accompanying drawings shall be interpreted as illustrative and not in a limiting sense.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An on-demand hydrogen gas generation device comprising:
a cell comprising a means for generating an average flow of hydrogen gas of at least about 0.1 cubic centimeter/minute/cubic centimeter of fuel volume for a period of time of at least about 1 hour;
a switching mechanism in communication with the cell, the switching mechanism regulating the generation of hydrogen gas therein, the switching mechanism comprising a moveable member that is operable to repeatedly move between a first position and a second position in response to a pressure differential created by said cell of less than 30 psig, wherein (1) in the first position an electrical current passes through the switching mechanism which enables the generation of hydrogen gas from said cell, and (2) in the second position resistance in the switching mechanism to the electrical current passing therethrough increases to reduce the rate of hydrogen gas generation from said cell; and,
a gas management system for transporting hydrogen gas out of the cell, the gas management system comprising an anode, an electrolyte, a gas management electrode having a first face and a second face and comprising a conductive substrate and a catalyst and having a first face and a second face, a gas impermeable and liquid permeable hydrophilic layer, a gas permeable and liquid impermeable hydrophobic layer and a gas exit region, wherein (1) the anode and the gas management electrode are in serial, electrical communication with and through the switching mechanism, and (2) the gas impermeable and liquid permeable hydrophilic layer is disposed between the anode and the first face of the gas management electrode, the gas permeable and liquid impermeable hydrophobic layer is disposed on the second face of the gas management electrode and the gas exit region is interior of the gas permeable and liquid impermeable hydrophobic layer.

2. The on-demand hydrogen gas generation device as set forth in claim 1, wherein the anode and the gas management electrode are in serial, electrical communication with and through the switching mechanism and an external circuit.

3. The on-demand hydrogen gas generation device as set forth in claim 1, wherein the moveable member moves from between a first position and a second position in response to a pressure differential created by the cell comprising the hydrogen gas generation means of greater than about 1 psig.

4. The on-demand hydrogen gas generation device as set forth in claim 1, wherein the moveable member moves from a first position to a second position in response to a pressure differential created by the cell comprising the hydrogen gas generation means that exceeds a predetermined value between about 1 psig and less than 30 psig, and returns to the first position when the pressure differential falls below the predetermined value.

5. The on-demand hydrogen gas generation device as set forth in claim 1, wherein the moveable member moves from the first position to the second position in response to a pressure differential created by the cell comprising the hydrogen gas generation means that exceeds about 20 psig, and returns to the first position when the pressure differential falls below about 20 psig.

6. The on-demand hydrogen gas generation device as set forth in claim 1, wherein the device is orientation independent.

7. The on-demand hydrogen gas generation device as set forth in claim 1, wherein the device has dimensions about equal to the dimensions of a size AAA electrochemical cell.

8. The on-demand hydrogen gas generation device as set forth in claim 1, wherein the device has dimensions about equal to the dimensions of a size AA electrochemical cell.

9. The on-demand hydrogen gas generation device as set forth in claim 1, wherein the device has dimensions that can be contained within a fuel cell having the dimensions of a size AA electrochemical cell.

10. The on-demand hydrogen gas generation device as set forth in claim 1, wherein the device has dimensions that can be contained within a fuel cell having the dimensions of a size C electrochemical cell.

11. The on-demand hydrogen gas generation device as set forth in claim 1, wherein the device has dimensions that can be contained within a fuel cell having the dimensions of a size D electrochemical cell.

12. The on-demand hydrogen gas generation device as set forth in claim 1, wherein the device has dimensions about equal to the dimensions of a prismatic electrochemical cell.

13. The on-demand hydrogen gas generation device as set forth in claim 1, wherein the device has dimensions about equal to the dimensions of an elliptically-shaped electrochemical cell.

14. The on-demand hydrogen gas generation device as set forth in claim 1, wherein the hydrogen gas generation means comprises galvanic cell corrosion.

15. The on-demand hydrogen gas generation device as set forth in claim 1, wherein the hydrogen gas generation means comprises a chemical hydride reaction.

16. The on-demand hydrogen gas generation device as set forth in claim 1, wherein the cell comprising the hydrogen gas generation means generates an average flow of hydrogen gas of at least about 0.4 cubic centimeter/minute/cubic centimeter of fuel volume for a period of time of at least about 1 hour.

17. The on-demand hydrogen gas generation device as set forth in claim 1, wherein:
the cell comprising the means for generating hydrogen gas comprises an outer can defining an internal cavity having disposed therein a positive electrode, a negative electrode in electrical communication with the positive electrode, and an electrolyte in contact with the positive and negative electrodes, said electrolyte being capable of reacting at the positive electrode to produce hydrogen gas when an electrical current passes through the anode and positive electrode; and,
the switching mechanism is in communication with the internal cavity for regulating the generation of hydrogen gas therein.

18. The on-demand hydrogen gas generation device as set forth in claim 17, wherein the moveable member of the switching mechanism is in communication with the internal cavity.

19. The on-demand hydrogen gas generation device as set forth in claim 18, wherein the switching mechanism comprises a first conductive element and a second conductive element, wherein:
the first conductive element is in mechanical communication with the moveable member, electrical communication with the negative electrode, and in removable electrical communication with the second conductive element;
the second conductive element is in removable electrical communication with the first conductive element and the negative electrode; and,
the positive and negative electrodes are in removable, serial relationship through the first and second conductive elements.

20. The on-demand hydrogen gas generation device as set forth in claim 19 wherein (i) when the moveable member is in the first position the first conductive element is in electrical communication with the second conductive element and an electrical current between the anode and positive electrode passes through the switching mechanism, enabling the generation of hydrogen gas in the internal cavity, and (ii) when the moveable member is in the second position the electrical communication between the first conductive element and the second conductive element is at least partially reduced, which increases resistance in the switching mechanism to the electrical current passing therethrough and which reduces the rate of hydrogen gas generation in the internal cavity.

21. The on-demand hydrogen gas generation device as set forth in claim 20, wherein the moveable member comprises the first conductive element.

22. The on-demand hydrogen gas generation device as set forth in claim 20, wherein the moveable member comprises the second conductive element.

23. The on-demand hydrogen gas generation device as set forth in claim 20, wherein the first conductive element or the second conductive element has a resistive coating on a surface thereof.

24. The on-demand hydrogen gas generation device as set forth in claim 20, wherein the moveable member comprises a conductive material.

25. The on-demand hydrogen gas generation device as set forth in claim 20, wherein the moveable member has a conductive coating on a surface thereof.

26. The on-demand hydrogen gas generation device as set forth in claim 20, wherein the moveable member has a resistive coating on a surface thereof.

27. The on-demand hydrogen gas generation device as set forth in claim 20, therein said switching mechanism is a first switching mechanism and is in electrical communication with a second switching mechanism, and further wherein generation of hydrogen gas by said hydrogen gas generation means is initiated by passing an electrical current through the second switching mechanism and then the first switching mechanism.

28. The on-demand hydrogen gas generation device of claim 27, wherein said device is activated to initiate hydrogen gas generation by electrically shorting the device through an external circuit comprising said second switching mechanism.

29. The on-demand hydrogen gas generation device as set forth in claim 20, wherein the first conductive element or the second conductive element of the first switching mechanism are also a part of the second switching mechanism.

30. The on-demand hydrogen gas generation device as set forth in claim 20, further comprising:
a chamber containing an aqueous solution;
a chamber containing a chemical hydride; and,
a conduit comprising a means for allowing a unidirectional flow of the aqueous solution into the chamber containing the chemical hydride, the aqueous solution reacting with the chemical hydride to form hydrogen gas;
wherein the cell comprising the hydrogen gas generation means is in communication with the chamber containing the aqueous solution to allow the hydrogen gas formed in the cell to exert pressure on the aqueous solution and force the aqueous solution into the conduit.
